(19) United States
(12) Patent Application Publication
(10) Pub. No.: US 2007/0048513 A1
(43) Pub. Date: Mar. 1, 2007

(54) Antireflective film and polarizing plate and image display using same

(75) Inventors: Yasuhiro Okamoto, Minami-ashigara-shi (JP); Masaki Noro, Minami-ashigara-shi (JP); Hiroyuki Yoneyama, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-ashigara-shi (JP)

(21) Appl. No.: 11/509,721

(22) Filed: Aug. 25, 2006

(30) Foreign Application Priority Data
Aug. 25, 2005 (JP) 2005-244065

(51) Int. Cl. B32B 27/18; B32B 33/00; B32B 5/16

(52) U.S. Cl. 428/313.3; 428/323; 428/447; 428/421

(57) ABSTRACT

An antireflective film is provided and including: a support; and a layer formed from a composition containing inorganic particles and at least one salt. The at least one salt contains an acid and an organic base, the conjugate acid of the organic base having pKa of 5.0 to 11.0.

### BACKGROUND OF THE INVENTION

1. Field of the Invention

The present invention relates to an antireflective film, a polarizing plate using the antireflective film, and an image display using the antireflective film or the polarizing plate, on the outermost surface of the display.

2. Description of the Background Art

Antireflective films generally prevent contract reduction or reflection of an image due to reflection of outside light in image displays such as cathode ray tube display (CRT), plasma display (PDP) and electroluminescence display (ELD), and are therefore provided on the outermost surface of the display so as to reduce reflectivity using the principle of optical interference.

Such an antireflective film can generally be prepared by forming a lower refractive index layer having an appropriate thickness and having a refractive index lower than that of a substrate, on the substrate. To achieve lower refractive index, it is desired to use a material having a refractive index as low as possible, in the lower refractive index layer.

The antireflective film is used on the outermost surface of the display, and therefore is further required to have higher mar resistance. To achieve higher mar resistance in a thin film having a thickness of about 100 nm, strength of a coating itself and adhesion to a lower layer are necessary.

To decrease a refractive index of a material, there are means of (1) introducing fluorine atoms, (2) decreasing density (introducing pores), and the like. However, those have the tendency to decrease coating strength or interfacial adhesion, and therefore, to decrease mar resistance. Thus, it was difficult to establish lower refractive index and higher mar resistance in combination.

To realize higher mar resistance, it is important that a curing reaction sufficiently proceeds. It is advantageous from the standpoint of productivity to apply a fluorine-containing polymer to a support, and then cure a resulting coating with any method. A method of reacting hydroxyl group in the fluorine-containing polymer with a curing agent in the presence of an acid catalyst and curing a lower refractive index layer in an antireflective film is proposed in JP-A-11-228631.

On the other hand, JP-A-62-174276 and JP-A-2-173172 propose a curable composition or coating composition, using an amine salt of sulfonic acid as a catalyst.

In the technologies of JP-A-11-228631, JP-A-62-174276 and JP-A-2-173172, curing activity is high, but curing reaction partially proceeds during storage. Therefore, stability of a coating liquid is insufficient, and there is restriction in the coating conditions. Thus, it has been desired to establish curing activity and stability of a coating liquid in combination.

### SUMMARY OF THE INVENTION

An object of an illustrative, non-limiting embodiment of the present invention is to provide an antireflective film having excellent mar resistance while maintaining storage stability of a coating liquid and curing activity in combination. Another object of an illustrative, non-limiting embodiment of the present invention is to provide a polarizing plate and an image display, using such an antireflective film.

The present invention can achieve the above objects by the following constitutions.

1. An antireflective film comprising: a support; and a layer formed from a composition comprising inorganic particles and at least one salt, the at least one salt comprising an acid and an organic base, the conjugate acid of the organic base having pKa of 5.0 to 11.0.

2. The antireflective film as described in the above 1, wherein the inorganic particles are silica fine particles.

3. The antireflective film as described in the above 1 or 2, wherein the inorganic particles have a hollow structure and have a refractive index of 1.15 to 1.40.

4. The antireflective film as described in any one of the above 1 to 3, which has a haze value attributable to surface scattering of 5 to less than 15%.

5. The antireflective film as described in any one of the above 1 to 4, wherein at least one layer constituting the antireflective film contains an organosilane compound.

6. The antireflective film as described in any one of the above 1 to 5, wherein

the composition comprises:
a fluorine-containing polymer comprising (a) a fluorine-containing vinyl monomer polymeric unit and (b) a hydroxyl group-containing vinyl monomer polymeric unit; and
a crosslinking agent capable of reacting with a hydroxyl group, and the layer formed from the composition is a lower refractive index layer.
   7. The antireflective film as described in the above 6, wherein the fluorine-containing polymer further comprises (c) a polymeric unit having a graft site containing a polysiloxane repeating unit represented by formula (1) on a side chain of the fluorine-containing polymer, the main chain of the fluorine-containing polymer consisting of a carbon atom. 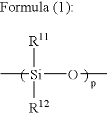
   wherein R¹¹ and R¹², which are the same or different, each independently represents an alkyl group or an aryl group, and p is an integer of 2 to 500.
   8. The antireflective film as described in the above 6, wherein the fluorine-containing polymer further comprises (d) a polysiloxane repeating unit represented by formula (1), on the main chain of the fluorine-containing polymer. 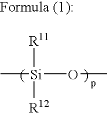
   wherein R¹¹ and R¹², which are the same or different, each independently represents an alkyl group or an aryl group, and p is an integer of 2 to 500.
   9. The antireflective film as described in any one of the above 6 to 8, wherein the crosslinking agent is a compound containing a nitrogen atom and at least two carbon atoms adjacent to the nitrogen atom, each of the at least two carbon atoms being substituted with an alkoxy group.
   10. A polarizing plate comprising: a polarizer; and two protective films, at least one of the two protective films comprising an antireflective film as described in any one of the above 1 to 9.
   11. An image display comprising an antireflective film as described in any one of the above 1 to 9 or a polarizing plate as described in the above 10 on an outermost surface of the image display.

### BRIEF DESCRIPTION OF THE DRAWINGS

The features of the invention will appear more fully upon consideration of the exemplary embodiments of the invention, which are schematically set forth in the drawings, in which:

FIG. 1 is a schematic sectional view schematically showing an exemplary embodiment of the antireflective film of the present invention;

FIG. 2 is a schematic sectional view schematically showing another exemplary embodiment of the antireflective film of the present invention;

FIG. 3 is a schematic sectional view schematically showing still another exemplary embodiment of the antireflective film of the present invention;

FIG. 4 is a schematic sectional view schematically showing further exemplary embodiment of the antireflective film of the present invention; and

FIG. 5 is a schematic sectional view schematically showing still further exemplary embodiment of the antireflective film of the present invention.

Reference numerals in the figures are set forth below: (1) Support; (2) Hard coat layer; (3) Medium refractive index layer; (4) Higher refractive index layer; and (5) Lower refractive index layer.

### DETAILED DESCRIPTION OF THE EXEMPLARY EMBODIMENTS

Although the invention will be described below with reference to the exemplary embodiments thereof, the following exemplary embodiments and modifications do not restrict the invention.

According to an exemplary embodiment, an antireflective film is produced using a coating liquid having liquid coating stability and curing activity in combination, and therefore has high production adaptability and also has excellent mar resistance. Further, an image display provided with the antireflective film of an exemplary embodiment of the present invention, and an image display provided with a polarizing plate using the antireflective film of an exemplary embodiment of the present invention have less reflection of outside light and reflection of background, and thus have extremely high visibility.

In the specification, the term “(meth)acrylate” used herein means “at least one of acrylate and methacrylate”, and the terms “(meth)acrylic acid” and “(meth)acryloyl” used herein have the same definition as above.

An aspect of the present invention provides an antireflective film comprising: a support; and a layer formed from a composition comprising inorganic particles and at least one salt, the at least one salt comprising an acid and an organic base, the conjugate acid of the organic base having pKa of 5.0 to 11.0.

The inorganic particles are described in detail in the item of “1-5. Inorganic particle”, and the salt is described in detail at the paragraph of “Curing catalyst” in the item of “1-3. Crosslinkable compound (crosslinking agent)”.

1. Constituents of the Present Invention

Various compounds that can be used in an antireflective film of an exemplary embodiment of the present invention are described below.

1-1. Binder

(Ionizing Radiation Curable Compound)

An antireflective film of the present invention can be constituted by containing at least one layer formed by a crosslinking reaction or a polymerization reaction of an ionizing radiation curable compound. Specifically, a coating liquid containing an ionizing radiation curable polyfunctional monomer or polyfunctional oligomer as a binder (hereinafter sometimes referred to as a “curable composition”) is applied to a transparent support, and the polyfunctional monomer or polyfunctional oligomer is subjected to a crosslinking reaction or a polymerization reaction, thereby at least one functional layer that contributes to reflection prevention function can be formed on the support.

Functional groups of the ionizing radiation curable polyfunctional monomer or polyfunctional oligomer are preferably light, electron beam and radiation polymerizable groups, and of those, photopolymerizable functional groups are more preferable. Examples of the photopolymerizable functional group include unsaturated polymerizable functional groups such as a (meth)acryloyl group, a vinyl group, a styryl group and an allyl group. Of those, the (meth)acryloyl group is preferable.

(Photopolymerizable Polyfunctional Monomer)

Specific examples of the photopolymerizable polyfunctional monomer having a photopolymerizable functional group include (meth)acrylic acid diesters of alkylene glycol, such as neopentyl glycol acrylate, 1,6-hexanediol (meth)acrylate and propylene glycol di(meth)acrylate; (meth)acrylic acid diesters of polyoxyalkylene glycol, such as triethylene glycol di(meth)acrylate, dipropylene glycol di(meth)acrylate, polyethylene glycol di(meth)acrylate and polypropylene glycol di(meth)acrylate; (meth)acrylic acid diesters of polyhydric alcohol, such as pentaerythritol di(meth)acrylate; and (meth)acrylic acid diesters of ethylene oxide or propylene oxide adduct, such as 2,2-bis {4-(acryloxy-diethoxy)phenyl}propane and 2,2-bis{4-(acryloxy-polypropoxy)phenyl}propane.

Epoxy (meth)acrylates, urethane (meth)acrylates and polyester (meth)acrylates are also preferably used as the photopolymerizable polyfunctional monomer.

Above all, esters of a polyhydric alcohol and (meth)acrylic acid are preferable, and polyfunctional monomers having at lest three (meth)acryloyl groups in the molecule are more preferable. Specific examples of the monomer include trimethylopropane tri(meth)acrylate, trimethylolethane tri(meth)acrylate, 1,2,4-cycloheane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)pentaerythritol hexa(meth)acrylate, tripentaerythritol triacrylate and treipentaerythritol hexatriacrylate.

The monomer binder can use a monomer having different refractive index in order to control the refractive index of each layer. Examples of the higher refractive index monomer include bis(4-methacryloyl thiophenyl)sulfide, vinyl naphthalene, vinylphenyl sulfide and 4-methacryloxyphenyl-4′-methoxyphenyl thioether. Further, dendrimers as described in, for example, JP-A-2005-76005 and JP-A-2005-36105, and norbornene ring-containing monomers as described in, for example, JP-A-2005-60425 can also be used.

The polyfunctional monomers can be used alone or as mixtures thereof.

Polymerization of those monomers having an ethylenically unsaturated group can be conducted by irradiation with ionizing radiation or heating in the presence of a photoradical initiator or a heat radical initiator.

Polymerization reaction of the photopolymerizable polyfunctional monomer preferably uses a photopolymerization initiator. The photopolymerization initiator preferably is a photoradical polymerization initiator and a photocationic polymerization initiator, and more preferably is a photoradical polymerization initiator.

(Polymer Binder)

A non-crosslinked polymer or a crosslinked polymer can be used as the binder. The crosslinked polymer preferably has an anionic group. The crosslinked polymer having an anionic group has a structure that a main chain of the polymer having an anionic group is crosslinked.

Examples of the main chain of the polymer include a polyolefin (saturated hydrocarbon), a polyether, a polyurea, a polyurethane, a polyester, a polyamine, a polyamide and a melamine resin. Of those, the polyolefin main chain, the polyether main chain and the polyurea main chain are preferable, the polyolefin main chain and the polyether main chain are more preferable, and the polyolefin main chain is most preferable.

The polyolefin main chain comprises a saturated hydrocarbon. The polyolefin main chain is obtained by, for example, addition polymerization reaction of an unsaturated polymerizable group. The polyether main chain comprises repeating units bonded through an ether bond (—O—). The polyether main chain is obtained by, for example, ring-opening polymerization reaction of an epoxy group. The polyurea main chain comprises repeating units bonded through a urea bond (—NH—CO—NH—). The polyurea main chain is obtained by, for example, polycondensation reaction between an isocyanate group and an amino group. The polyurethane main chain comprises repeating units bonded through an urethane bond (—NH—CO—O—). The polyurethane main chain is obtained by, for example, polycondensation reaction between an isocyanate group and a hydroxyl group (including N-methylol group). The polyester main chain comprises repeating units bonded through an ester bond (—CO—O—). The polyester main chain is obtained by, for example, polycondensation reaction between a carboxyl group (including acid halide group) and a hydroxyl group (including N-methylol group). The polyamine main chain comprises repeating units bonded through an imino bond (—NH—). The polyamine main chain is obtained by, for example, ring-opening polymerization reaction of an ethyleneimine group. The polyamide main chain comprises repeating units bonded through an amide bond (—NH—CO—). The polyamide main chain is obtained by, for example, reaction between an isocyanate group and a carboxyl group (including acid halide group). The melamine resin main chain is obtained by, polycondensation reaction between a triazine group (for example, melamine) and an aldehyde (for example, formaldehyde). The melamine resin is that the main chain itself has a crosslinking structure.

The anionic group is directly bonded to the main chain of the polymer, or is bonded to the main chain through a linking group. The anionic group is preferably bonded to the main chain as a side chain through the linking group. Examples of the anionic group include a carboxylic acid group (carboxyl group), a sulfonic acid group (sulfo group) and a phosphoric acid group (phosphono group). A sulfonic acid group and a phosphoric acid group are preferable. The anionic group may be in a form of a salt. A cation that forms a salt together with the anionic group is preferably an alkali metal ion. Further, a proton of the anionic group may be dissociated.

The linking group that connects the anionic group and the main chain of a polymer is preferably a divalent group selected from —CO—, —O—, an alkylene group, an arylene group, and their combinations.

The crosslinking structure acts to chemically bond (preferably covalent bond) at least two main chains, and preferably acts to bond at least three main chains. The crosslinking structure preferably comprises a divalent or more group selected from —CO—, —O—, —S—, a nitrogen atom, a phosphorus atom, an aliphatic residue, an aromatic residue and their combinations.

The crosslinked polymer having the anionic group is preferably a copolymer having a repeating unit having the anionic group and a repeating unit having the crosslinked structure. The proportion of the repeating unit having the anionic group in the copolymer is preferably from 2 to 96 mass % (weight %), more preferably from 4 to 94 mass %, and most preferably from 6 to 92 mass %. The repeating unit may have two or more anionic groups. The proportion of the repeating unit having the crosslinking structure in the copolymer is preferably from 4 to 98 mass %, more preferably from 6 to 96 mass %, and most preferably from 8 to 94 mass %.

The repeating unit in the crosslinked polymer having the anionic group may have both the anionic group and the crosslinking structure. Further, the repeating unit may contain other repeating unit (repeating unit having no anionic group and no crosslinking structure).

The other repeating unit is preferably a repeating unit having an amino group or a quaternary ammonium group, and a repeating unit having a benzene ring. The amino group or quaternary ammonium group has a function to maintain a dispersing state of the inorganic particles as same as the anionic group. Even when the amino group, quaternary ammonium group and benzene ring are contained in the repeating unit having the anionic group, or a repeating unit having the crosslinking structure, the same effect is obtained.

In the repeating unit having the amino group or the quaternary ammonium group, the amino group or the quaternary ammonium group is directly bonded to the main chain of the polymer, or is bonded to the main chain through a linking group. The amino group or the quaternary ammonium group is preferably bonded to the main chain as a side chain through a linking group. The amino group or the quaternary ammonium group is preferably a secondary amino group, a tertiary amino group or a quaternary ammonium group, and more preferably a tertiary amino group or a quaternary ammonium group. A group bonding to a nitrogen atom of the secondary amino group, tertiary amino group or quaternary ammonium group is preferably an alkyl group. The alkyl group preferably has from 1 to 12 carbon atoms, and more preferably from 1 to 6.

A counter ion of the quaternary ammonium group is preferably a halide ion.

The linking group that bonds the amino group or the quaternary ammonium group and the main chain of the polymer is preferably a divalent group selected from —CO—, —NH—, —O—, an alkylene group, an arylene group, and their combinations. When the crosslinked polymer having the anionic group contains the repeating unit having the amino group or the quaternary ammonium group, its proportion is preferably from 0.06 to 32 mass %, more preferably from 0.08 to 30 mass %, and most preferably 0.1 to 28 mass %.

(Fluorine-Containing Polymer Binder)

(a) (Fluorine-Containing Vinyl Monomer Unit)

In the present invention, the structure of the fluorine-containing vinyl monomer polymeric unit contained in the fluorine-containing polymer for use in the formation of the lower refractive index layer is not particularly limited, and examples thereof include polymeric units based on a fluorine-containing olefin, a perfluoroalkyl vinyl ether, a vinyl ether having a fluorine-containing alkyl group and a (meth)acrylate. From production adaptability and properties required for a lower refractive index, such as refractive index and film strength, a copolymer of a fluorine-containing olefin and a vinyl ether is preferable, and a copolymer of a perfluoroolefin and a vinyl ether is more preferable. A perfluoroalkyl vinyl ether, a vinyl ether having a fluorine-containing alkyl group, a (meth)acrylate and the like may be contained as a copolymerizing component for the purpose of decreasing a refractive index.

The perfluoroolefin preferably has from 3 to 7 carbon atoms. Perfluoropropylene or perfluorobutylene is preferable from the standpoint of polymerization reactivity, and perfluoropropylene is more preferable from the standpoint of availability.

The content of the perfluoroolefin in the polymer is preferably from 25 to 75 mol %. For achieving a lower refractive index of a material, it is desirable to increase the proportion of the perfluoroolefin introduced. However, from the point of polymerization reactivity, introduction in an amount of from about 50 to 70 mol % is the limits in the general solution radical polymerization reaction, and it is difficult to introduce in an amount more than the range. In the present invention, the content of the perfluoroolefin is preferably from 30 to 70 mol %, more preferably from 30 to 60 mol %, further more preferably from 35 to 60 mol %, and most preferably from 40 to 60 mol %.

A perfluorovinyl ether represented by the following formula M2 may be copolymerized with the fluorine-containing polymer preferably used in the present invention to achieve a lower refractive index. The copolymerizing component may be introduced into the polymer in an amount in a range of from 0 to 40 mol %, preferably from 0 to 30 mol %, and more preferably from 0 to 20 mol %.

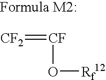

In the formula M2, Rf¹² represents a fluorine-containing alkyl group having from 1 to 30 carbon atoms, preferably a fluorine-containing alkyl group having from 1 to 20 carbon atoms, and more preferably a perfluoroalkyl group having from 1 to 10 carbon atoms. The fluorinated alkyl group may have a substituent. Examples of Rf¹² include —CF₃{M2-(1)}, —CF₂CF₃{M2-(2)}, —CF₂CF₂CF₃ {M2-(3)} and —CF₂CF(OCF₂CF₂CF₃)CF₃ {M2-(4))}.

Further, in the present invention, a fluorine-containing vinyl ether represented by the following formula M1 may be copolymerized to achieve a lower refractive index. The copolymerizing component may be introduced into the polymer in an amount in a range of from 0 to 40 mol %, preferably from 0 to 30 mol %, and more preferably from 0 to 20 mol %.

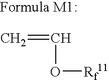

In the formula M1, Rf¹¹ represents a fluorine-containing alkyl group having from 1 to 30, preferably from 1 to 20, and more preferably from 1 to 15, carbon atoms. The fluorine-containing alkyl group may have a linear structure such as —CF₂CF₃, —CH₂(CF₂)_{q1}H, or —CH₂CH₂(CF₂)_{q1}F (q1 is an integer of from 2 to 12), or a branched structure such as —CH(CF₃)₂, —CH₂CF(CF₃)₂, —CH(CH₃)CF₂CF₃, or —CH(CH₃)(CF₂)₅CF₂H. Further, the fluorine-containing alkyl group may have an alicyclic structure, preferably a five-membered ring or a six-membered ring, for example, a perfluorocyclohexyl group, a perfluorocyclopentyl group or an alkyl group substituted with those, or an ether bond such as —CH₂OCH₂CF₂CF₃, —CH₂CH₂OCH₂(CF₂)_{q2}H, —CH₂CH₂OCH₂(CF₂)_{q2}F (q2 is an integer of from 2 to 12) or —CH₂CH₂OCF₂CF₂OCF₂CF₂H. The substituent represented by R_{f}¹¹ is not limited to the substituents described herein.

The monomer represented by the formula M1 can be prepared by, for example, a method of acting a fluorine-containing alcohol to elimination group-substituted alkyl vinyl ethers such as vinyloxyalkyl sulfonate or vinyloxyalkyl chloride in the presence of a basic catalyst as described in Macromolecules, vol. 32 (21), p7122 (1999) or JP-A-2-721; a method of exchanging a vinyl group by mixing a fluorine-containing alcohol and vinyl ethers such as butyl vinyl ether in the presence of a palladium catalyst as described in the pamphlet of PCT 92/05135; or a method of reacting a fluorine-containing ketone and dibromoethane in the presence of a potassium fluoride, and conducting HBr-elimination reaction by an alkali catalyst as described in U.S. Pat. No. 3,420,793.

(Hydroxyl Group-Containing Vinyl Monomer Polymeric Unit)

The fluorine-containing polymer preferably used in the present invention preferably contains a hydroxyl group-containing vinyl monomer polymeric unit, but its content is not particularly limited. The hydroxyl group has the function to cure by reacting with a crosslinking agent. Therefore, a hard film can preferably be formed as the content of a hydroxyl group is high. The content is preferably from 10 to 70 mol %, more preferably from more than 20 to 60 mol %, and more preferably from 25 to 55 mol %.

The hydroxyl group-containing vinyl monomer can use, for example, vinyl ethers, (meth)acrylates and styrens, without particular limitation so long as it is copolymerizable with the fluorine-containing vinyl monomer polymeric unit. For example, when a perfluoroolefin (hexafluoropropylene and the like) is used as the fluorine-containing vinyl monomer, a hydroxyl group-containing vinyl ester having good copolymerizability is preferably used. Examples of the hydroxyl group-containing vinyl ester include 2-hydroxyethyl vinyl ether, 4-hydroxybutyl vinyl ether, 6-hydroxyhexyl vinyl ether, 8-hydroxyoctyl vinyl ether, diethylene glycol vinyl ether, triethylene glycol vinyl ether and 4-(hydroxymethyl)cyclohexylmethyl vinyl ether. However, the hydroxyl group-containing vinyl ester is not limited those.

(Structural Unit Having Polysiloxane Structure)

The fluorine-containing polymer preferably used in the present invention preferably has a structural unit having a polysiloxane structure for the purpose of imparting antifouling properties.

(Polysiloxane Repeating Unit Contained in Side Chain)

The fluorine-containing polymer having a polysiloxane structure useful in the present invention is, for example, a fluorine-containing polymer comprises (a) at least one fluorine-containing vinyl monomer polymeric unit, (b) at least one hydroxyl group-containing vinyl monomer polymeric unit and (c) at least one polymeric unit having a graft site containing a polysiloxane repeating unit represented by the following formula (1) on a side chain, the main chain being only carbon atom.

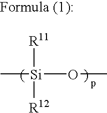

In the formula (1), R¹¹ and R¹² which may be the same or different each represents an alkyl group or an aryl group. The alkyl group preferably has from 1 to 4 carbon atoms, and examples thereof include a methyl group, a trifluoromethyl group and an ethyl group. The aryl group preferably has from 6 to 20 carbon atoms, and examples thereof include a phenyl group and a naphthyl group. Of those, a methyl group and a phenyl group are preferable, and a methyl group is more preferable. p is an integer of from 2 to 500, preferably from 5 to 350, and more preferably from 8 to 250.

The polymer having a polysiloxane structure represented by the formula (1) at a side chain can be prepared by, for example, a method of introducing into a polymer having a reactive group such as an epoxy group, a hydroxyl group, a carboxyl group or an acid anhydride group, a polysiloxane having a corresponding reactive group (an amino group, a mercapto group, a hydroxyl group and the like to an epoxy group or an acid anhydride group) at one terminal thereof (for example, Silaplane Series, products of Chisso Corporation) by a polmer reaction as described in, for example, J. Appl. Polym. Sci., Vol. 2000, p. 78 (1955) or JP-56-28219; and a method of polymerizing a polysiloxane-containing silicone macromer. Either of those methods can preferably be used. In the present invention, a method of introducing by polymerization of a silicone macromer is more preferably used.

The silicone macromer can be any silicone macromer so long as it has a polymerizable group copolymerizable with the fluorine-containing olefin, and preferably has a structure represented by each of the following formulae (2-1) to (2-4).

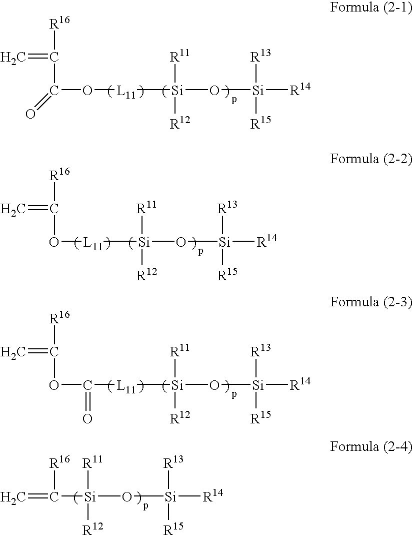

In the formulae (2-1) to (2-4), R¹¹, R¹² and p are the same as defined in the formula (1), and the preferable ranges are also the same as defined therein. R¹³ to R¹⁵ each independently represent a substituted or unsubstituted monovalent organic group or a hydrogen atom. An alkyl group having from 1 to 10 carbon atoms (for example, a methyl group, an ethyl group and an octyl group), an alkoxy group having from 1 to 10 carbon atoms (for example, a methoxy group, an ethoxy group and a propyloxy group) and an aryl group having from 6 to 20 carbon atoms (for example, a phenyl group and a naphthyl group) are preferable, and an alkyl group having from 1 to 5 carbon atoms is more preferable. R¹⁶ represents a hydrogen atom or a methyl group. L₁₁ represents an optional linking group having from 1 to 20 carbon atoms. Examples of the linking group include a substituted or unsubstituted, linear, branched or alicyclic alkylene group or a substituted or unsubstituted arylene group. An unsubstituted linear alkylene group having from 1 to 20 carbon atoms is preferable, and an ethylene group or a propylene group is more preferable. Those compounds can be prepared by the method as described in, for example, JP-A-6-322053.

The compounds represented by the formulae (2-1) to (2-4) each can preferably be used in the present invention. Of those, the compounds having the structure represented by the formula (2-1), (2-2) and (2-3) are preferably used from the standpoint of copolymerizability with the fluorine-containing olefin. The polysiloxane site preferably occupies from 0.01 to 20 mass %, preferably from 0.05 to 15 mass %, and more preferably from 0.5 to 10 mass %, in the graft copolymer.

Preferable examples of the polymeric unit in the polymer graft side containing a polysiloxane site at the side chain, useful in the present invention are described below, but the invention is not limited to those. 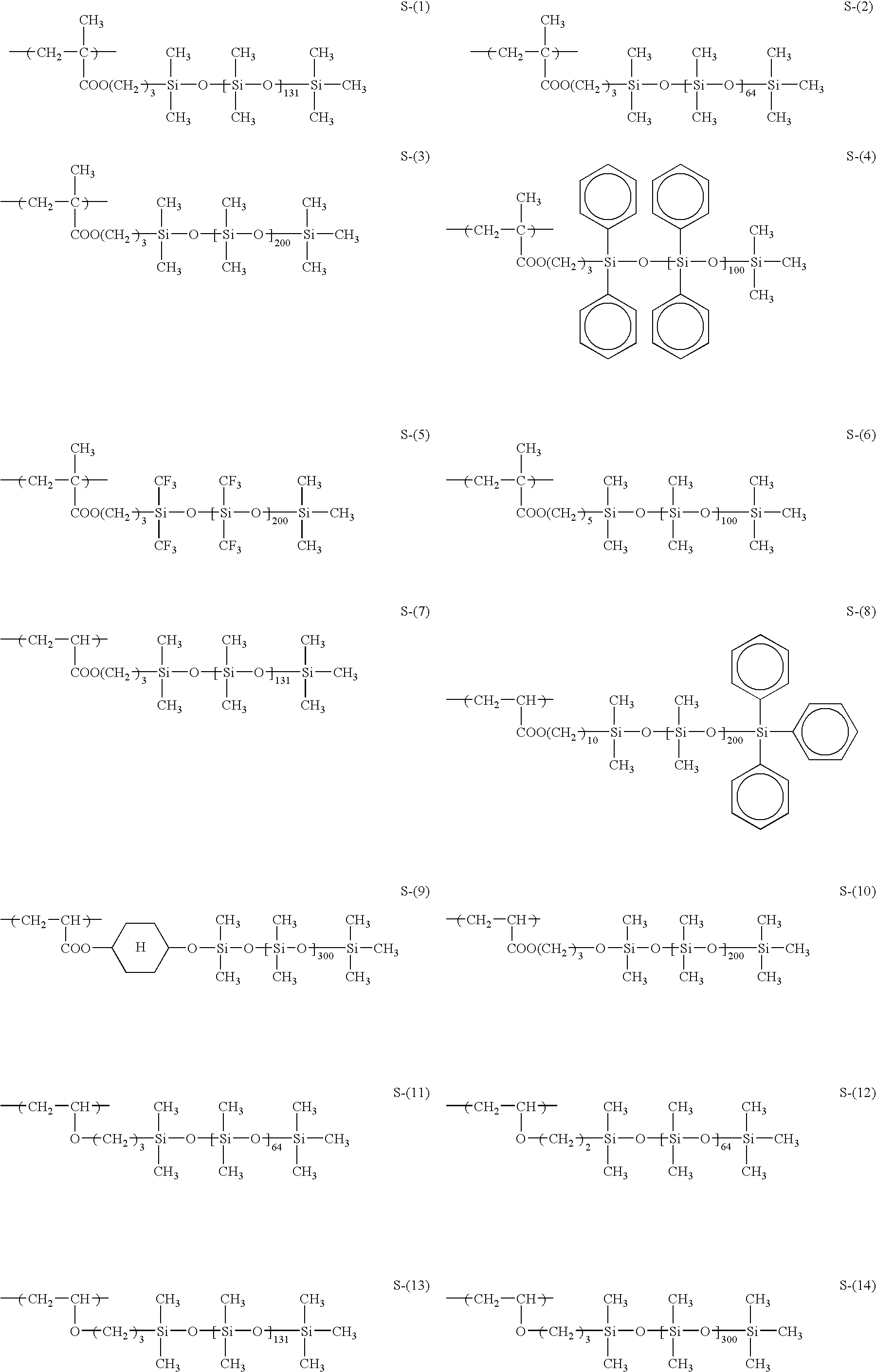 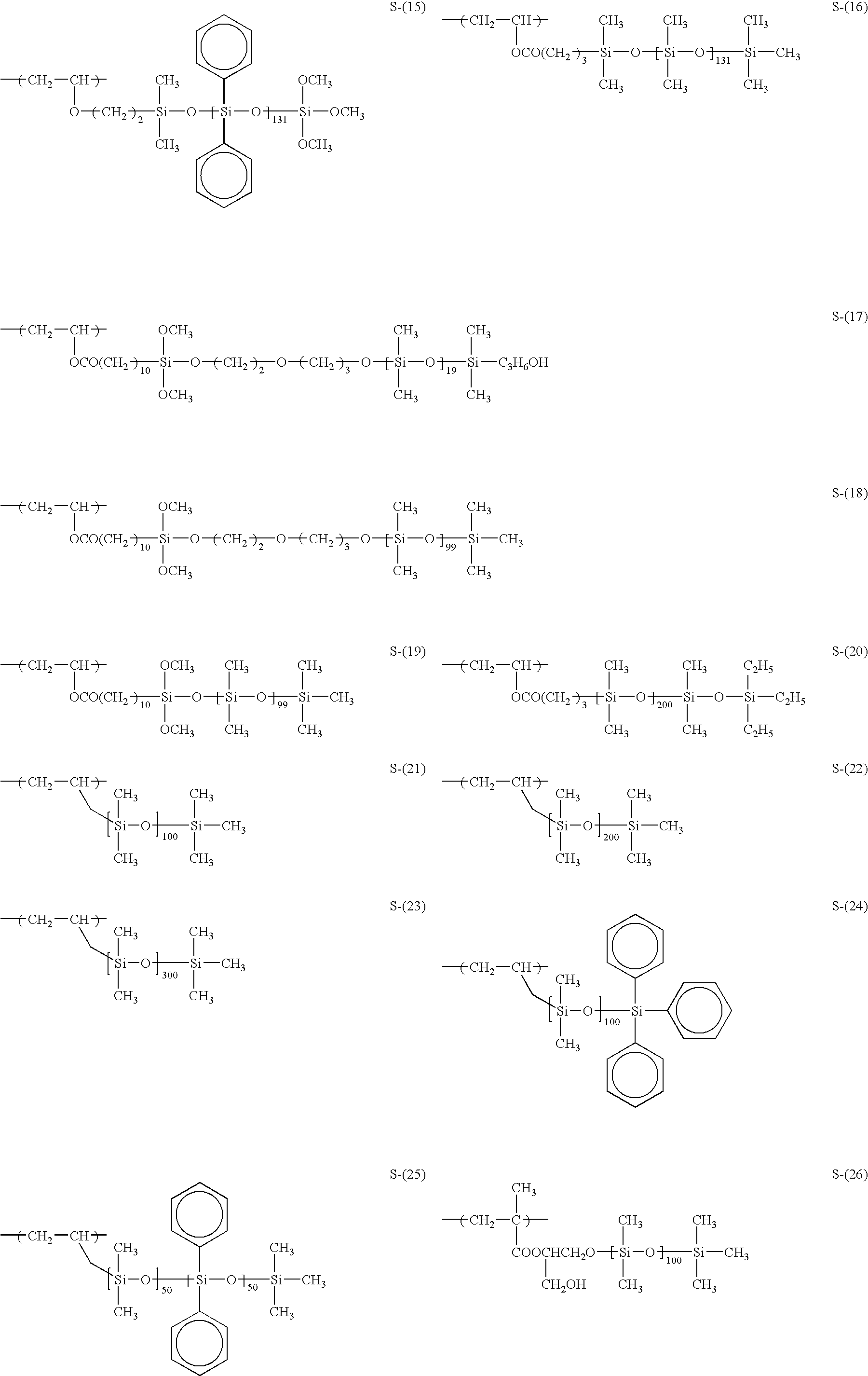 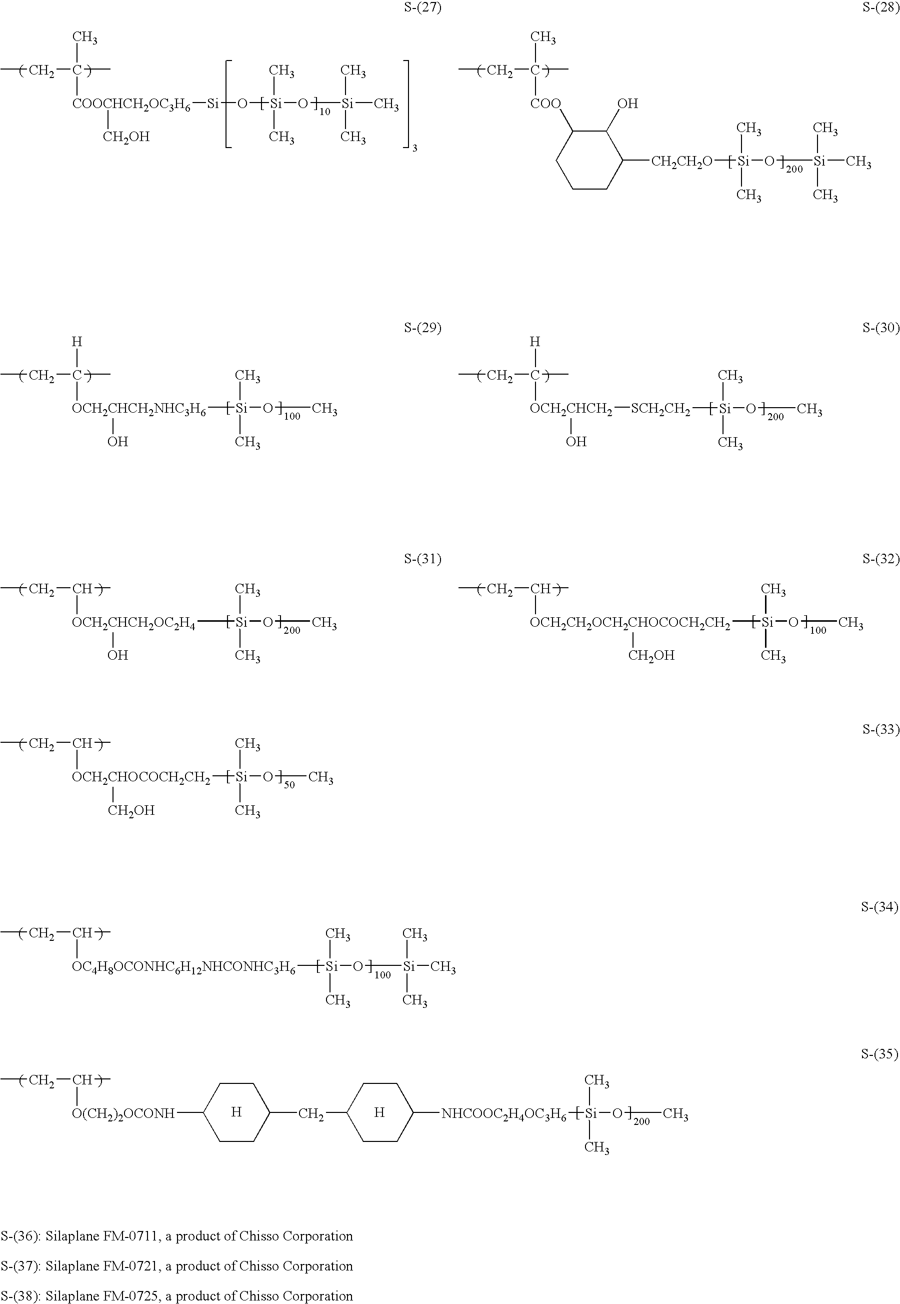
(Polysiloxane Repeating Unit Contained in Main Chain)

In the present invention, other than the fluorine-containing polymer containing a polysiloxane repeating unit at a side chain, a fluorine-containing polymer containing (a) at least one fluorine-containing vinyl monomer polymeric unit and (b) at least one hydroxyl group-containing vinyl monomer polymeric unit, and containing (d) a polysiloxane repeating unit represented by the following formula (1) on the main chain can also preferably be used.

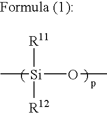

R¹¹ and R¹² in the above formula (1) are the same as defined in R¹¹ and R¹² in the formula (1) for the fluorine-containing polymer having a polysiloxane unit at the side chain, and the preferable range is also the same as defined therein.

The introduction method of the polysiloxane structure into the main chain is not particularly limited. Examples of the introduction method include a method of using a polymer type initiator such as an azo group-containing polysiloxane amide as described in JP-A-6-93100, a method of introducing a reactive group (for example, a mercapto group, a carboxyl group and a hydroxyl group) derived from a polymerization initiator and a chain transfer agent into a polymer terminal, and reacting with one end-capped or both ends-capped reactive group (for example, an epoxy group and an isocyanate group), and a method of copolymerizing a cyclic siloxane oligomer such as hexamethylcyclotrisiloxane by anion ring-opening polymerization. Of those, the method of utilizing an initiator having a polysiloxane structure is easy and preferable.

A structure represented by the following formula (3) is particularly preferable as the polysiloxane structure introduced into the main chain of the copolymer used in the present invention.

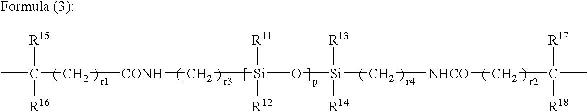

In the formula (3), R¹¹ to R¹⁴ each independently represent a hydrogen atom, an alkyl group (an alkyl group having from 1 to 5 carbon atoms is preferable, and examples thereof include a methyl group and an ethyl group), a haloalkyl group (a fluorinated alkyl group having from 1 to 5 carbon atoms is preferable, and examples thereof include a trifluoromethyl group and a pentafluoroethyl group) or an aryl group (an aryl group having from 6 to 20 carbon atoms is preferable, and examples thereof include a phenyl group and a naphthyl group). A methyl group and a phenyl group are preferable, and a methyl group is more preferable.

R¹⁵ to R¹⁸ each independently represent a hydrogen atom, an alkyl group (an alkyl group having from 1 to 5 carbon atoms is preferable, and examples thereof include a methyl group and an ethyl group), an aryl group (an aryl group having from 6 to 10 carbon atoms is preferable, and examples thereof include a phenyl group and a naphthyl group), an alkoxycarbonyl group (an alkoxycarbonyl group having from 2 to 5 is preferable, and examples thereof include a methoxycarbonyl group and an ethoxycarbonyl group) or a cyano group. An alkyl group and a cyano group are preferable, and a methyl group and a cyano group are more preferable.

r1 and r2 each independently are an integer of from 1 to 10, preferably an integer of from 1 to 6, and more preferably an integer of from 2 to 4. r1 and r2 each independently are an integer of from 0 to 10, preferably an integer of from 1 to 6, and more preferably an integer of from 2 to 4. p is an integer of from 2 to 500, preferably an integer of from 10 to 500, and more preferably an integer of from 20 to 500.

“VSP-0501” and “VSP-1001” (trade name, products of Wako Pure Chemical Industries, Ltd.) that are the commercially available macroazo initiators are compounds in which plural units within the scope of the formula (3) are linked through azo groups. When polymerization is conducted using the compound as an initiator, the unit can be introduced into the polymer obtained, which is preferable.

The polysiloxane structure is introduced into the copolymer used in the present invention in an amount of preferably from 0.01 to 20 mass %, more preferably from 0.05 to 15 mass %, and most preferably from 0.5 to 10 mass %.

Introduction of the polysiloxane structure imparts antifouling properties and dust resistance to a coating film, and also imparts slip properties to a coating film surface, which is advantageous to scratch resistance.

(Other Polymeric Unit)

A copolymerizing component for forming a polymeric unit other the above can appropriately be selected from the standpoints of hardness, adhesion to a substrate, solubility in a solvent, transparency and the like. Examples of the copolymerizing component include vinyl ethers such as methyl vinyl ether, ethyl vinyl ether, t-butyl vinyl ether, n-butyl vinyl ether, cyclohexyl vinyl ether and isopropyl vinyl ether; and vinyl esters such as vinyl acetate, vinyl propionate, vinyl butyrate and vinyl cyclohexanecarbonate. The amount of those copolymerizing components is in a range of from 0 to 40 mol %, preferably from 0 to 30 mol %, and more preferably from 0 to 20 mol %.

(Exemplary Embodiment of Fluorine-Containing Polymer)

Exemplary embodiments of the polymer in the present invention include an embodiment represented by the following formula (4).

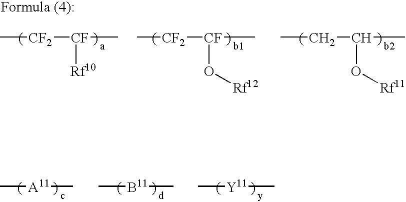

In the formula (4), Rf¹⁰ represents a perfluoroalkyl group having from 1 to 5 carbon atoms. The explanation described as the example of the perfluoroolefin is applied to a monomer constituting a site represented by —CF₂CF(Rf¹⁰)—. Rf¹² are the same as defined in the fluorine-containing vinyl ether (Rf¹² in the compound represented by the formula M2 described before), and the preferable range is the same as defined before. Rf¹¹′ are also the same as defined in another fluorine-containing vinyl ether (Rf¹¹ in the compound represented by the formula M1 described before), and the preferable range is the same as defined before.

A¹¹ and B¹¹ represent a hydroxyl group-containing vinyl monomer polymeric unit and an optional structural unit, respectively. A¹¹ is the same as defined in the hydroxyl group-containing vinyl monomer polymeric unit as described before, and B¹¹ is not particularly limited. However, vinyl ethers and vinyl esters are more preferable from the standpoint of copolymerizability. Specific examples include the monomers as exemplified before (other polymeric unit).

Y¹¹ represents a structural unit having a polysiloxane structure. Its form may be a polymeric unit having a graft site containing a polysiloxane repeating unit represented by the formula (1) described before at the side chain, or may contain a polysiloxane repeating unit represented by the formula (1) described before in the main chain. Those definitions and preferable ranges are the same as defined before (the structural unit having a polysiloxane structure).

a to d each represent a molar fraction (%) of each structural component, and a+b1+b2+c+d is 100. a to d are satisfied with the relationship of 30≦a≦70 (preferably 30≦a≦60, and more preferably 35≦a≦60), 0≦b1≦40 (preferably 0≦b1≦30, and more preferably 0≦b1≦20), 0≦b2≦40 (preferably 0≦b2≦30, and more preferably 0≦b2≦20), 10≦c≦70 (preferably 20≦c≦60, and more preferably 25≦c≦55) and 0≦d≦40 (preferably 0≦c≦30).

y represents a mass fraction (%) of a structural unit constituting a polysiloxane structure to the entire fluorine-containing polymers, and is satisfied with the relationship of 0.01≦y≦20 (preferably 0.05≦y≦15, and more preferably 0.5≦y≦10).

The fluorine-containing polymer used for the formation of a functional layer, particularly a lower refractive index layer, in the antireflective film of the present invention has a number average molecular weight of preferably from 5,000 to 1,000,000, more preferably from 8,000 to 500,000, and most preferably from 10,000 to 100,000.

The number average molecular weight used herein means a molecular weight in terms of a styrene conversion by detection of a differential refractometer, a solvent: tetrahydrofuran (THF), with a GPC analyzer using columns “TSKgel GMxL”, “TSKgel G4000HxL” and “TSKgel G2000HxL” (trade names, products of Tosoh Corporation).

Specific examples of the polymers useful in the present invention are shown in Tables 1 and 2 below, but the invention is not limited to those. Tables 1 and 2 show the combination of polymeric units.

TABLE 1

| | | Fluorine-containing polymer | | | | | | | | | | | |
|---|---|---|---|---|---|---|---|---|---|---|---|---|---|
| | | P1 | P2 | P3 | P4 | P5 | P6 | P7 | P8 | P9 | P10 | P11 | P12 |
| Fluorine- | HFP | 50 | 50 | 50 | 50 | 50 | 50 | 50 | 45 | 40 | 50 | 50 | 40 |
| containing | M1-(1) | | | | | | | | | | 15 | | |
| polymer | M1-(5) | | | | | | | | | | | 15 | |
| structural | M2-(3) | | | | | | | | 5 | 10 | | | 10 |
| component | HEVE | 50 | 50 | 50 | 40 | 40 | 40 | 45 | 35 | 50 | | | |
| (molar fraction) | HBVE | | | | | | | | | | 35 | 35 | 15 |
| (%) | HOVE | | | | | | | | | | | | |
| | DEGVE | | | | | | | | | | | | |
| | HMcHVE | | | | | | | | | | | | |
| | EVE | | | | 10 | 10 | 10 | | | | | | 35 |
| | cHVE | | | | | | | 5 | | | | | |
| | tBuVE | | | | | | | | 15 | | | | |
| | VAc | | | | | | | | | | | | |
| Polysiloxane- | FM-0721 | | | | | | 6 | | | | | | |
| containing | FM-0725 | | 2 | | 4.7 | | | | 5.1 | | | | |
| structural | VPS-0501 | | | | | 3.4 | | | | | 1.7 | | 2.5 |
| component | VPS-1001 | | | 2.5 | | | | | | 1 | | | |
| (mass %) | | | | | | | | | | | | | |

| | | | | | | | | | | | | |
|---|---|---|---|---|---|---|---|---|---|---|---|---|
| Number average | 1.5 | 1.7 | 2.1 | 4.5 | 2.8 | 2.5 | 1.8 | 3.5 | 4.1 | 2.5 | 1.4 | 3.2 |
| molecular weight (×10,000) | | | | | | | | | | | | |

TABLE 2

| | | Fluorine-containing polymer | | | | | | | | | | | |
|---|---|---|---|---|---|---|---|---|---|---|---|---|---|
| | | P13 | P14 | P15 | P16 | P17 | P18 | P19 | P20 | P21 | P22 | P23 | P24 |
| Fluorine- | HFP | 50 | 50 | 50 | 50 | 40 | 50 | 45 | 50 | 50 | 50 | 50 | 40 |
| containing | M1-(1) | | | 5 | | | 10 | | | | | | |
| polymer | M1-(5) | | | | | | | | | | | | 10 |
| structural | M2-(3) | | | | | 10 | | 5 | | | | | |
| component | HEVE | | | | | | | | | | | | |
| (molar fraction) | HBVE | | | | | | | | | | | | |
| (%) | HOVE | 15 | 35 | 40 | 35 | | | | | | | | |
| | DEGVE | | | | | 40 | 25 | 15 | 30 | | | | |
| | HMcHVE | | | | | | | | | 40 | 25 | 25 | 35 |
| | EVE | | | | 15 | 10 | | | | 10 | | | |
| | cHVE | 35 | | | | | | | 20 | | 25 | | |
| | tBuVE | | | 5 | | | 15 | | | | | 15 | 15 |
| | VAc | | 15 | | | | | 35 | | | | 10 | |
| Polysiloxane- | FM-0721 | | | | 5 | | | | | | | | |
| containing | FM-0725 | | | 4.1 | | 3.6 | | | | 2.9 | 7.3 | | 4.8 |
| structural | VPS-0501 | 5 | | | | | | 8 | | | | | |
| component | VPS-1001 | | 4.9 | | | | 0.9 | | 9.7 | | | | |
| (mass %) | | | | | | | | | | | | | |

| | | | | | | | | | | | | |
|---|---|---|---|---|---|---|---|---|---|---|---|---|
| Number average | 2.6 | 3.4 | 3.9 | 2.9 | 3.5 | 2.8 | 3.1 | 4.5 | 3.6 | 4.2 | 1.8 | 4.5 |
| molecular weight (×10,000) | | | | | | | | | | | | |

In the Tables, the flourine-containing polymer structural components show a molar ratio of each component. The abbreviations are as follows.
HFP: Hexafluoropropylene
M1-(1): Perfluoromethyl vinyl ether
M1-(5): Perfluorpentyl vinyl ether
M2-(3): Heptafluoropropyl trifluorovinyl ether
HEVE: 2-Hydoxyethyl vinyl ether
HBVE: 4-Hydroxybutyl vinyl ether
HOVE: 8-Hydroxyoctyl vinyl ether
DEGVE: Diethylene glycol vinyl ether
HMcHVE: 4-(Hydroxymethyl)cyclohexyl vinyl ether
EVE: Ethyl vinyl ether
cHVE: Cyclohexyl vinyl ether
tBuVE: t-Butyl vinyl ether
VAc: Vinyl acetate

Regarding the structural components containing a polysiloxane structure, the name of the polysiloxane-containing component used in the synthesis reaction, and mass % of the polysiloxane structure-containing structural unit occupied to the entire polymers are shown. The abbreviations are as follows.

FM-0721: Silaplane FM-0721, a product of Chisso Corpotation

FM-0725: Silaplane FM-0725, a product of Chisso Corpotation

VPS-1001: Macroazo initiator VPS-1001, a product of Wako Pure Chemical Industries, Ltd.

VPS-0501: Macroazo initiator VPS-0501, a product of Wako Pure Chemical Industries, Ltd.

(Synthesis of Fluorine-Containing Polymer)

Synthesis of the fluorine-containing polymer used in the present invention can be synthesized by various polymerization methods such as a solution polymerization, a precipitation polymerization, a suspension polymerization, a bulk polymerization and an emulsion polymerization. Further, the polymer can be synthesized by the conventional operations such as a batchwise operation, a semicontinuous operation or a continuous operation.

The initiation method of polymerization is a method of using a radical initiator, a method of irradiating with light or radiations, or the like. Those polymerization methods and polymerization initiation method are described in, for example, Shoji Tsuruta, Polymer Synthesis Method, Revised Edition (The Nikkan Kogyo Shimbun, Ltd., 1971) and Takayuki Ohtsu and Masanobu Kinoshita, Experimental Method of Polymer Synthesis, p124-154, (1972), Kagaku-dojin Publishing Company, Inc.

Of the above polymerization methods, a solution polymerization method using a radical initiator is preferable. Examples of a solvent used in the solution polymerization method include various organic solvents such as ethyl acetate, butyl acetate, acetone, methyl ethyl ketone, methyl isobutyl ketone, cyclohexane, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol and 1-butanol. Those solvents may be used alone, as mixtures of two or more thereof or as a mixed solvent with water.

The polymerization temperature is required to set in connection with the kind of an initiator used, and the like, and can be from 0 to 100° C. The polymerization is preferably conducted at a temperature in a range of from 40 to 100° C.

The reaction pressure can appropriately be selected, and is generally from 0.01 to 10 MPa, preferably from 0.05 to 5 MPa, and more preferably from 0.1 to 2 MPa. The reaction time is from about 5 to 30 hours.

The polymer obtained can directly be used in the form of a reaction liquid to the use purpose in the present invention, or can be used after purification through reprecipitation or separating operation.

(Organosilane Compound)

It is preferable from the point of further high mar resistance for the functional layer in the antireflective film of the present invention to contain a hydrolyzate and/or its partial condensate (hereinafter, a reaction solution obtained is referred to as a “sol component”).

This sol component functions as a binder by applying the curable composition, drying and condensing through a heating step to form a cured product. When a polyfunctional acrylate polymer is contained, a binder having a three-dimensional structure is formed by irradiation with active light.

The organosilane compound is preferably represented by the following formula (5).
(R³⁰)ₘ₁—Si(X³¹)₄₋ₘ₁ Formula (5):

In the formula (5), R³⁰ represents a substituted or unsubstituted alkyl group or a substituted or unsubstituted aryl group. Examples of the alkyl group include methyl, ethyl, propyl, isopropyl, hexyl, decyl and hexadecyl. The alkyl group has preferably from 1 to 30 carbon atoms, more preferably from 1 to 16 carbon atoms, and most preferably from 1 to 6. Examples of the aryl group include phenyl and naphthyl, and phenyl is preferable.

X³¹ represents a hydroxyl group or a hydrolyzable group, and examples thereof include an alkoxy group (an alkoxy group having from 1 to 6 carbon atoms is preferable, and examples thereof include a methoxy group and an ethoxy group), a halogen atom (for example, Cl, Br and I), and a group represented by R³¹COO (R³¹ is preferably a hydrogen atom or an alkyl group having from 1 to 5 carbon atoms, and examples thereof include CH₃COO and C₂H₅COO). Of those, an alkoxy group is preferable, and a methoxy group and an ethoxy group are more preferable.

m1 is an integer of from 1 to 3, preferably 1 or 2, and more preferably 1.

When plural R³⁰ or R³¹ are present, the plural R³⁰ or R³¹ may be the same or different.

The substituent contained in R³⁰ is not particularly limited. Examples of the substituent include a halogen atom (fluorine, chlorine, bromine and the like), a hydroxyl group, a mercapto group, carboxyl group, an epoxy group, an alkyl group (methyl, ethyl, i-propyl, propyl, t-butyl and the like), an aryl group (phenyl, naphthyl and the like), an aromatic heterocyclic group (furyl, pyrazolyl, pyridyl and the like), an alkoxy group (methoxy, ethoxy, i-propoxy, hexyloxy and the like), an aryloxy group (phenoxy and the like), an alkylthio group (methylthio, ethylthio and the like), an arylthio (phenylthio and the like), an alkenyl group (vinyl, 1-propenyl and the like), an acyloxy group (acetoxy, acryloyloxy, methacryloyloxy and the like), an alkoxycarbonyl group (methoxycarbonyl, ethoxycarbonyl and the like), an aryloxycarbonyl group (phenoxycarbonyl and the like), a carbamoyl group (carbomoyl, N-methylcarbamoyl, N,N-dimethylcarbamoyl, N-methyl-N-octylcarbamoyl and the like), and an acylamino group (acetylamino, benzoylamino, acrylamino, methacrylamino and the like). Those substituents may further be substituted.

When plural R³⁰ are present, it is preferable that at least one R³⁰ is a substituted alkyl group or a substituted aryl group.

Of the organosilane compounds represented by the formula (5), an organosilane compound having a vinyl-polymerizable substituent represented by the following formula (5-1) is preferable.

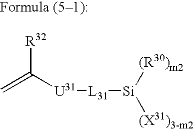

In the formula (5-1), R³² represents a hydrogen atom, a methyl group, a methoxy group, an alkoxycabonyl group, a cyano group, a fluorine atom or a chlorine atom. Examples of the alkoxycarbonyl group include a methoxycarbonyl group and an ethoxycarbonyl group. Of those, a hydrogen atom, a methyl group, a methoxy group, a methoxycarbonyl group, a cyano group, a fluorine atom and chlorine atom are preferable, a hydrogen atom, a methyl group, a methoxycarbonyl group, a fluorine atom and chlorine atom are more preferable, and a hydrogen atom and a methyl group is most preferable.

U³¹ represents a single bond, *—COO—**, *—CONH—** or *—O—**. A single bond, *—COO—** and *—CONH—** are preferable, a single bond and *—COO—** are more preferable, and *—COO—** is most preferable. * shows a position bonding to ═C(R³²), and ** shows a position bonding to L₃₁.

L₃₁ represents a divalent linking chain. Specific examples of L₃₁ include a substituted or unsubstituted alkylene group, a substituted or unsubstituted arylene group, a substituted or unsubstituted alkylene group having a linking group (for example, ether, ester, amide and the like) therein, and a substituted or unsubstituted arylene group having a linking group therein. A substituted or unsubstituted alkylene group, a substituted or unsubstituted arylene group, and an alkylene group having a linking group therein are preferable. An unsubstituted alkylene group, an unsubstituted arylene group and an alkylene group having an ether or ester linking group therein are more preferable. An unsubstituted alkylene group and an alkylene group having an ether or ester linking group therein are most preferable. Examples of the substituent include a halogen atom, a hydroxyl group, a mercapto group, a carboxyl group, an epoxy group, an alkyl group and an aryl group. Those substituents may further be substituted.

m2 is 0 or 1, and is preferably 0.

R³⁰ is the same as defined in R³⁰ in the formula (1). A substituted or unsubstituted alkyl group and an unsubstituted aryl group are preferable, and an unsubstituted alkyl group and an unsubstituted aryl group are more preferable.

X³¹ is the same as defined in X³¹ in the formula (5). A halogen atom, a hydroxyl group and an unsubstituted alkoxy group are preferable, a chlorine atom, a hydroxyl group and an unsubstituted alkoxy group having from 1 to 6 carbon atoms are more preferable, a hydroxyl group and an alkoxy group having from 1 to 3 are further more preferable, and a methoxy group is most preferable. When plural X³¹ are present, the plural X³¹ may be the same or different.

The compounds of the formula (5) and the formula (5-1) may be used as mixtures of two or more thereof.

Specific examples of the compounds represented by the formula (5) and the formula (5-1) are shown below, but the present invention is not limited to those.

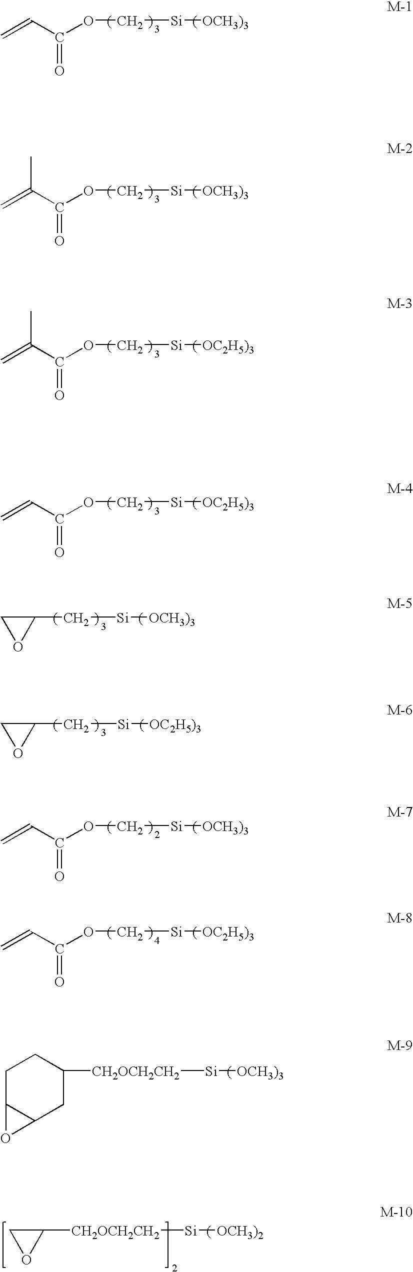

Of those, (M-1), (M-2) and (M-5) are preferable.

(Catalyst Used in Organosilane Compound)

The hydrolyzate and/or the partial condensate of the organosilane compound are generally produced by treating the organosilane compound in the presence of a catalyst.

Examples of the catalyst used include inorganic acids such as hydrochloric acid, sulfuric acid and nitric acid; organic acids such as oxalic acid, acetic acid, formic acid, methanesulfonic acid and toluenesulfonic acid; inorganic bases such as sodium hydroxide, potassium hydroxide and ammonia: organic bases such as triethylamine and pyridine; metal alkoxides such as triisopropoxyaluminum and tetrabutoxyzirconium; and metal chelate compounds comprising a metal such as Zr, Ti or Al, as a central metal. Acid catalysts such as metal chelate compounds, inorganic acids and organic acids are preferably used in the present invention. Of the inorganic acids, hydrochloric acid and sulfuric acid are preferable. Of the organic acids, organic acids having an acid dissolution constant in water (pKa value (25° C.)) of 4.5 or lower are preferable, hydrochloric acid, sulfuric acid and organic acids having an acid dissolution constant in water of 3.0 or lower are more preferable, hydrochloric acid, sulfuric acid and organic acids having an acid dissolution constant in water of 2.5 or lower are further more preferable, and organic acids having an acid dissolution constant in water of 2.5 or lower are most preferable. Specifically, methanesulfonic acid, oxalic acid, phthalic acid and malonic acid are preferable, and oxalic acid is more preferable.

(Metal Chelate Compound)

The metal chelate compound can suitably be used without particular limitation so long as it comprises a metal selected from Zr, Ti and Al as a central metal, and an alcohol represented by the formula R⁴¹OH (wherein R⁴¹ represents an alkyl group having from 1 to 10 carbon atoms) and a compound represented by R⁴²COCH₂COR⁴³ (wherein R⁴² represents an alkyl group having from 1 to 10 carbon atoms, and R⁴³ represents an alkyl group having from 1 to 10 carbon atoms or an alkoxy group having from 1 to 10 carbon atoms), as ligands. Within this scope, at least two metal chelate compounds may be used in combination.

The metal chelate compound used in the present invention is preferably selected from the group of the compounds represented by Zr(OR⁴¹)ₛ₁(R⁴²COCHCOR⁴³)ₛ₂, Ti(OR⁴¹)ₜ₁(R⁴²COCHCOR⁴³)ₜ₂ and Al(OR⁴¹)ᵤ₁(R⁴²COCHCOR⁴³)ᵤ₂, and acts to promote condensation reaction of the hydrolyzate and/or partial condensate of the organosilane compound.

R⁴¹ and R⁴² in the chelate compound may be the same or different, and is an alkyl group having from 1 to 10 carbon atoms (specifically, ethyl group, n-propyl group, i-propyl group, n-butyl group, s-butyl group, t-butyl group and n-pentyl group), a phenyl group or the like. R⁴³ is the same alkyl group having from 1 to 10 carbon atoms as above, and further is an alkoxy group having from 1 to 10 carbon atoms such as a methoxy group, an ethoxy group, n-propoxy group, i-propoxy group, n-butoxy group, s-butoxy group and t-butoxy group. s1, s2, t1, t2, u1 and u2 in the metal chelate compound each are an integer that is determined so as to achieve s1+s2=4, t1+t2=4, and u1+u2=3.

Examples of those metal chelate compounds include zirconium chelate compounds such as zirconium tri-n-butoxyethyl acetoacetate, zirconium di-n-butoxybis(ethylacetoacetate), zirconium n-butoxytris(ethylacetoacetate), zirconium tetrakis(n-propylacetoacetate), zirconium tetrakis(acetylacetoacetate) and zirconium tetrakis(ethylacetoacetate); titanium chelate compounds such as titanium diisopropoxy-bis(ethylacetoacetate), titanium diisopropoxy-bis(acetylacetate) and titanium diisopropoxy-bis(acetylacettonate); and aluminum chelate compounds such as aluminum diisopropoxyethylacetoacetate, aluminum diisopropoxyacetonate, aluminum isopropoxybis(ethylacetoacetate), aluminum isopropoxybis(acetylacetonate), aluminum tri(ethylacetoacetate), aluminum tris(acetylacetonate) and aluminum monoacetylacetonate-bis(ethylacetoacetate).

Of those metal chelate compounds, zirconium tri-n-butoxyethylacetoacetate, titanium diisopropoxy-bis(acetylacetonate), aluminum diisopropoxyethylacetiacetate and aluminum tris(ethylacetoacetate) are preferable. Those metal chelate compounds can be used alone or as mixtures of two or more thereof. Partial hydrolyzates of those metal chelate compounds can also be used.

(β-Diketone Compound and β-Ketoester Compound)

It is preferable in the present invention that β-diketone compound and/or β-ketoester compound are further added to the curable composition. This is further described below.

The present invention uses β-diketone compound and/or β-ketoester compound, represented by the formula R⁴²COCH₂COR⁴³. Those compounds act as a stability improving agent of the curable composition used in the present invention. R⁴² represents an alkyl group having from 1 to 10 carbon atoms, and R⁴³ represents an alkyl group having from 1 to 10 carbon atoms or an alkoxy group having from 1 to 10 carbon atoms. It is considered that by coordinating to a metal atom in the metal chelate compound (zirconium, titanium and aluminum compounds), it suppresses an action of condensation reaction of the hydrolyzate and/or partial condensate of the organosilane compound by those metal chelate compounds, thereby exhibiting an action of improving storage stability of the composition obtained. R⁴² and R⁴³ constituting the β-diketone compound and/or β-ketoester compound are the same as defined in R⁴² and R⁴³ constituting the metal chelate compound.

Examples of the β-diketone compound and/or β-ketoester compound include acetyl acetone, methyl acetoacetate, ethyl acetoacetate, n-propyl acetoacetate, i-propyl acetoacetate, n-butyl acetoacetate, s-butyl acetoacetate, t-butyl acetoacetate, 2,4-hexane-dione, 2,4-heptane-dione, 3,5-heptane-dione, 2,4-octane-dione, 2,4-nonane-dione and 5-methylhexane-dione. Of those, ethyl acetoacetate and acetyl acetone are preferable. Those β-diketone compound and/or β-ketoester compound can be used alone or as mixtures of two or more thereof. The β-diketone compound and/or β-ketoester compound are used in an amount of preferably 2 moles or more, and more preferably from 3 to 20 moles, per mole of the metal chelate compound. When used in an amount of 2 moles or more, those compounds can preferably prevent storage stability of the compound obtained from lowering.

The blending amount of the organosilane compound is preferably from 0.1 to 50 mass %, more preferably from 0.5 to 20 mass %, and most preferably from 1 to 10 mass %, based on the total solid content of a layer, for example, a lower refractive index layer, formed by applying the curable composition.

The organosilane compound may directly be added to the curable composition (a coating liquid for forming a layer formed on a support, for example, an antiglare layer or a lower refractive index layer), but it is preferable that the organosilane compound is previously treated in the presence of a catalyst to prepare a hydrolyzate and/or a partial condensate of the organosilane compound, and the curable composition is prepared using the reaction solution (sol liquid) obtained. In the present invention, it is preferable that a composition containing a hydrolyzate and/or a partial condensate of the organosilane compound, and the metal chelate compound is prepared, a liquid obtained by adding the β-diketone compound and/or β-ketoester compound to the composition is contained in a coating liquid for forming at least one layer of the antiglare layer and the lower refractive index layer, and the resulting liquid is applied.

(Other Binder Compound)

The following reactive organosilicon compounds described in, for example, JP-A-2003-39586 can be used in the binder that forms the functional layer in the antireflective layer of the present invention. The reactive organosilicon compound is used in a range of from 10 to 100 mass % to the sum of the ionizing radiation curable compound and the reactive organosilicon compound. In particular, when the following ionizing radiation curable organosilicon compounds are used, the compound itself can form a conductive layer as a resin component.

(Reactive Organosilicon Compound)

(Silicon Alkoxide)

The silicon alkoxide corresponds to the compound represented by the formula (5), wherein X³¹ represents an alkoxy group (OR³²), and R³⁰ and R³² represent an alkyl group having from 1 to 10 carbon atoms. Examples of the compound include tetramethoxysilane, tetraethoxysilane, tetra-i-propoxysilane, tetra-n-propoxysilane, tetra-n-butoxysilane, tetra-s-butoxysilane, tetra-t-butoxysilane, tetrapentaethoxysilane, tetrapenta-i-propoxysilane, tetrapenta-n-propoxysilane, tetrapenta-n-butoxysilane, tetrapenta-s-butoxysilane, tetrapenta-t-butoxysilane, methyltrimethoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, methyldimethoxysilane, methyldiethoxysilane and hexyltrimethoxysi lane.

(Silane-Coupling Agent)

Examples of the silane-coupling agent include γ-(2-aminoethyl)aminopropyltrimethoxysilane, γ-(2-aminoethyl)aminopropylmethyldimethoxysilane, β-(3,4-epoxychlorohexyl)ethyltrimethoxysilane, γ-aminopropyltriethoxysilane, γ-methacryloxypropyltrimethoxysilane, N-β-(N-vinylbenzylaminoethyl)-γ-aminopropylmethoxysi lane hydrochloric acid salt, aminosilane, methyltrimethoxysilane, vinyltriacetoxysilane, γ-mercaptopropyltrimethoxysilane, γ-chloropropyltrimethoxysilane, hexamethyldisilazane, vinyltris(β-methoxyethoxy)silane, octadecyidimethyl[3-(trimethoxysilyl)propyl]ammonium chloride, methyl trichlorosilane and dimethyl dichlorosilane.

(Ionizing Radiation Curable Silicon Compound)

The ionizing radiation curable silicon compound is an organosilicon compound having plural groups which crosslink by ionizing radiation, such as polymerizable double bond groups, and having a molecular weight of 5,000 or less. Examples of the organosilicon compound include a one end vinyl functional polysilane, a both end vinyl functional polysilane, a one end vinyl functional polysiloxane, a both end vinyl functional polysiloxane, and a vinyl functional polysilane or a vinyl functional polysiloxane, having those compounds reacted therewith.

(Other Compound)

Examples of the other compound include (meth)acryloxysilane compounds such as 3-(meth)acryloxypropyltrimethoxysi lane and 3-(meth)acryloxypropylmethyldimethoxysilane.

1-2. Radical Polymerization Initiator

Polymerization of various monomers having an ethylenically unsaturated group used in the present invention can be conducted by irradiation with ionizing radiation or by heating in the presence of a photoradical polymerization initiator or a heat radical polymerization initiator. In preparing the antireflective film of the present invention, the photoradical polymerization initiator and the heat radical polymerization initiator can be used in combination.

(Photoradical Polymerization Initiator)

Examples of the photoradical polymerization initiator include acetophenones, benzoins, benzophenones, phosphine oxides, ketals, anthraquinones, thioxanthones, azo compounds, peroxides (as described in, for example, JP-A-2001-139663), 2,3-dialkyldione compounds, disulfide compounds, fluoroamine compounds, aromatic sulfoniums, rofin dimers, onium salts, borates, active esters, active halogens, inorganic complexes and coumarins.

Examples of the acetophenones include 2,2-dimethoxyacetophenone, 2,2-diethoxyacetophenone, p-dimethylacetophenone, 1-hydroxy-dimethylphenylketone, 1-hydroxydimethyl-p-isopropylphenylketone, 1-hydroxycyclohexylphenylketone, 2-methyl-4-methylthio-2-morpholinopropiophenone, 2-benzyl-2-dimethylamino-1-(4-morpholinophenyl)-butanone, 4-phenoxydichloroacetophenone, and 4-t-butyl-dichloroacetophenone.

Examples of the benzoins include benzoin, benzoin methyl ether, benzoin ethyl ether, benzoin isopropyl ether, benzoin dimethyl ketal, benzoin benzenesulfonic acid ester, benzoin toluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4′-dimethylaminobenzophenone (Michler's ketone) and 3,3′,4,4′-tetra(t-butylperoxycarbonyl)benzophenone.

Examples of the phosphine oxides include 2,4,6-trimethylbenzoylphenyl phosphine oxide.

Examples of the onium salts include an aromatic diazonium salt, an aromatic iodonium salt and an aromatic sulfonium salt.

Examples of the borates include organic borates described in, for example, Japanese Patent No. 2764769, JP-A-2002-116539 and Kunz, Martin “Rad Tech' 98. Proceeding April, p19022, 1998, Chicago”. Specific examples of the borates are the compounds described at paragraphs (0022) to (0027) of JP-A-2002-116539. Examples of other organosilicon compound include organosilicon transition metal coordinating complexes as described in, for example, JP-A-6-348011, JP-A-7-128785, JP-A-7-140589, JP-A-7-306527 and JP-A-7-292014. Specific examples include ion complexes with a cationic dye.

Examples of the active esters include IRGACURE OXE01 (1,2-octanedione, 1-[4-(phenylthio)-2-(O-benzoyloxime)]) produced by Chiba Specialty Chemicals, sulfonic acid esters and cyclic active ester compounds. Specifically, the compounds 1 to 21 described in the Examples of JP-A-2000-80068 are preferable.

Examples of the active halogens include compounds described in, for example, Wakabayashi et al., “Bull. Chem. Soc. Japan”, vol. 42, p2924 (1969), U.S. Pat. No. 3,905,815, JP-A-5-27830, and M. P. Hutt, “Journal of Heterocyclic Chemistry”, vol. 1(3), (1970). In particular, the example includes an oxazole compound in which a trihalomethyl group is substituted: s-triazine compound. More preferable example is s-triazine derivative in which at least one mono-, di- or tri-halogen substituted methyl group is bonded to s-triazine ring.

Specific examples include s-triazine and an oxathiazole compound, such as 2-(p-methoxyphenyl)-4,6-bis(trichloromethyl-s-triazine, 2-(p-methoxyphenyl)-4,6-bis(trichloromethyl-s-triazine, 2-(p-styrylphenyl)-4,6-bis(trichloromethyl-s-triazine, 2-(3-Br-4-di(ethyl acetic acid ester)amino)phenyl)-4,6-bis(trichloromethyl)-s-triazine, and 2-trihalomethyl-5-(p-methoxyphenyl)-1,3,4-oxadiazol. Specifically, the compounds described on pages 14 to 30 of JP-A-58-15503, the compounds described on pages 6 to 10 of JP-A-55-77742, the compound Nos. 1 to 8 described on page 287 of JP-B-60-27673, the compound Nos. 1 to 17 on pages 443 to 444 of JP-A-60-239736, and the compound Nos. 1 to 19 described in U.S. Pat. No. 4,701,339 are particularly preferable.

Example of the inorganic complexes includes bis(η⁵-2,4-cyclopentadien-1-yl)-bis[2,6-difluoro-3-(1H-pyrrol-1-yl)-phenyl]titanium. Example of the coumarins in includes 3-ketocoumarin.

Those initiators may be used alone or as mixtures of two or more thereof.

Other than the above, various examples of the photoradical polymerization initiator are described in, for example, “Most Recent UV Curing Technology”, page 159, (1991) Technical Information Institute Co., Ltd., and Kiyoshi Kato, “Ultraviolet Curing Technology”, pages 65-148 (1968), Sogo Gijyutsu Center. Those are useful in the present invention.

Preferable examples of the commercially available photoradical polymerization initiator include KAYACURE DETX-S, KAYACURE BP-100, KAYACURE BDMK, KAYACURE CTX, KAYACURE BMS, KAYACURE 2-EAQ, KAYACURE ABQ, KAYACURE CPTX, KAYACURE EPD, KAYACURE ITX, KAYACURE QTX, KAYACURE BTC and KAYACURE MCA, products of Nippon Kayaku Co., Ltd.; IRGACURE 651, IRGACURE 184, IRGACURE 500, IRGACURE 819, IRGACURE 907, IRGACURE 369, IRGACURE 1173, IRGACURE 870, IRGACURE 2959, IRGACURE 4265 and IRGACURE 4263, products of Ciba Specialty Chemicals; Esacure (KIPI100F, KB1, EB3, BP, X33, KT046, KT37, KIP50 and TZT), products of Sartomer Company; and their combinations.

The photopolymerization initiator is used in a range of preferably from 0.1 to 15 parts by mass, and more preferably from 1 to 10 parts by mass, per 100 parts by mass of the polyfunctional monomer.

(Photosensitizer)

A photosensitizer may be used in place of the photoplymerization initiator. Examples of the photosensitizer include n-butylamine, triethylamine, tri-n-butylphosphine, Michler's ketone and thioxanthone.

Further, auxiliaries such as an azide compound, a thiourea compound and a mercapto compound may be used alone or as mixtures of two or more thereof.

The commercially available photosensitizer is, for example, KAYACURE (DMBI and EPA), a product of Nippon Kayaku Co., Ltd.

(Heat Radical Polymerization Initiator)

The heat radical polymerization initiator can use organic or inorganic peroxides, organic azo or diazo compounds, and the like.

Specifically, examples of the organic peroxide include benzoyl peroxide, halogen benzoyl peroxide, lauroyl peroxide, acetyl peroxide, dibutyl peroxide, cumene hydroperoxide and butyl hydroperoxide. Examples of the inorganic peroxide include hydrogen peroxide, ammonium peroxide and potassium peroxide. Examples of the azo compound include 2,2′-azobis(isobutyronitrile), 2,2′-azobis(propionitrile) and 1,1′-azobis(cyclohexanecarbonitrile). Examples of the diazo compound include diazoaminobenzene and p-nitrobenzene diazonium.

1-3. Crosslinkable Compound (Crosslinking Agent)

(Curing Agent)

The lower refractive index layer that is one of the functional layer in the present invention is preferably formed by using the fluorine-containing polymer having a hydroxyl group, and the curable composition containing a compound (curing agent) capable of reacting with a hydroxyl group in the fluorine-containing polymer, that is, a curable resin composition. The curing agent has preferably at least two, and more preferably at least four, sites reacting with the hydroxyl group.

The structure of the curing agent is not particularly limited so long as it has the above-described number of functional groups capable of reacting with the hydroxyl group. Examples of the curing agent include polyisocyanates, partial condensates of an isocyanate compound, multimers, polyhydric alcohols, adducts with a low molecular weight polyester coating, block polyisocyanate compounds in which isocyanate group are blocked with a blocking agent such as phenol, aminoplasts, and polybasic acids or their anhydrides.

(Aminoplasts)

Of various aminoplasts, aminoplasts crosslinking with a hydroxyl group-containing compound in an acidic condition are preferable in the present invention from the standpoints of establishing storage stability and activity of crosslinking reaction in combination, and from strength of the film formed. The aminoplasts are compounds having an amino group capable of reacting with the hydroxyl group present in the fluorine-containing polymer, that is, a hydroxyalkylamino group or an alkoxyalkylamino group, or a carbon atom adjacent to a nitrogen atom and substituted with an alkoxy group. Specific examples of the compound include a melamine compound, a urea compound and a benzoguanamine compound.

The melamine compound is generally known as a compound having a skeleton in which a nitrogen atom is bonded to a triazine ring, and examples thereof include melamine, an alkylated melamine, methylol melamine and an alkoxylated methyl melamine. A methylolated melamine obtained by reacting melaine and formaldehyde in a basic condition, alkoxylated melamine and their derivatives are preferable, and from the storage stability, an alkoxylated methyl melamine is more preferable. The methylolated melamine and alkoxylated methyl melamine are not particularly limited, and various resins obtained by the method as described in, for example, “Plastic Material Lecture [8] Urea-Melamine Resin”, The Nikkan Kogyo Shimbun, Ltd., can be used.

Preferable urea compounds are urea, a polymethylolated urea, an alkoxylated methyl urea as its derivative, and a compound having a glycol uryl skeleton or a 2-imidazolidinone skeleton, as a cyclic urea structure. Various resins as described in, for example, the above-described “Urea-Melamine Resin” can also be used for the amino compound such as the urea derivatives.

The compound suitably used as the crosslinking agent in the present invention is preferably a melamine compound and a glycol uryl compound from the point of compatibility with the fluorine-containing polymer. Of those, the preferable crosslinking agent is a compound containing a nitrogen atom in the molecule, and further containing at least two carbon atoms substituted with alkoxy groups adjacent to the nitrogen atom. More preferable compounds are compounds having a structure represented by the following (H-1) and (H-2), and their partial condensates. In the formulae, R represents an alkyl group having from 1 to 6 carbon atoms, or a hydroxyl group.

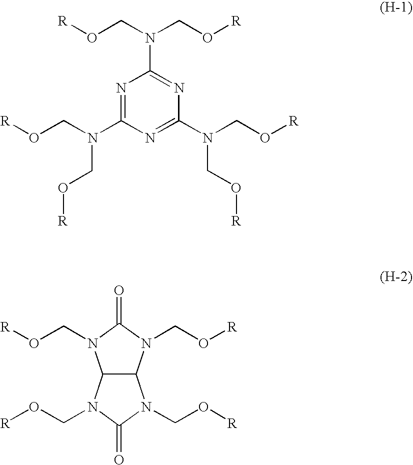

The addition amount of the aminoplast to the fluorine-containing polymer is from 1 to 50 parts by mass (parts by weight), preferably from 3 to 40 parts by mass, and more preferably from 5 to 30 parts by mass, per 100 parts by mass of the copolymer. When the amount is I part by mass or more, it can sufficiently exhibit durability as a thin film. When the amount is 50 parts by mass or less, it can maintain a lower refractive index when utilizing to optical uses, and this is preferable. From the standpoint that refractive index is maintained low when a curing agent added, a curing agent that maintains refractive index low when added is preferable. From this standpoint, of the above compounds, a compound having the structure represented by (H-2) is more preferable.

(Curing Catalyst)

The antireflective film of the present invention is obtained by applying a composition for forming a lower refractive index layer, and conducting a crosslinking reaction between a hydroxyl group in the fluorine-containing polymer and the curing agent to cure the resulting coating. In this system, curing is accelerated by an acid. Therefore, it is desirable to add an acidic substance to the curable composition. However, when a general acid is added, crosslinking reaction proceeds even in the coating liquid, resulting in troubles (irregular coating or run-away). Therefore, in order to establish storage stability and curing activity in combination in a thermosetting system, a compound that generates an acid by heating is (hereinafter referred to as “thermal acid generator”) added as a curing catalyst.

(Salt Comprising Acid and Organic Base)

The curing catalyst used in the present invention is a salt comprising an acid and a base. Examples of the acid include an organic acid such as sulfonic acid, phosphonic acid or carboxylic acid, and an inorganic acid such as phosphoric acid. From the standpoint of compatibility with the polymer, the organic acid is preferable, sulfonic acid and phosphonic acid are more preferable, and sulfonic acid is most preferable. Examples of the preferable sulfonic acid include p-toluenesulfonic acid (PTS), benzenesulfonic acid (BS), p-dodecylbenzenesulfonic acid (DBS), p-chlorobenzenesulfonic acid (CBS), 1,4-nephthalenedisulfonic acid (NDS), methanesulfonic acid (MsOH) and nonafluorobutane-1-sulfonic acid (NFBS). Any of those can preferably be used. The parenthesis means its abbreviation.

The curing agent greatly changes depending on basicity of the organic base to be combined with the acid. It is necessary in the present invention that the basicity is within a specific range. Due to this requirement, storage stability and curing activity can be established in combination in the above heat curing system. The curing catalyst used in the present invention is described below.

(Thermal Acid Generator)

The present invention is required to use a salt comprising: an organic base, the conjugate acid of the organic base having pKa of from 5.0 to 11.0; and an acid.

The organic base having lower basicity has higher acid generation efficiency when heating, and therefore is preferable from the standpoint of curing activity. However, where the basicity is too low, storage stability is insufficient. For this reason, an organic base having an appropriate basicity is used in the present invention. When the measure of basicity is expressed using pKa of a conjugated acid, the organic base used in the present invention must have pKa of from 5.0 to 11.0, preferably from 6.0 to 10.5, and more preferably from 6.5 to 10.0. Regarding the value of pKa of the organic base, the value in an aqueous solution is described in “Handbooks of Chemistry, Basic Edition”, (5^{th} edition, The Chemical Society of Japan, Maruzen Co., Ltd., 2004), Vol. 2, II-334 to 340, and an organic base having an appropriate pKa can be selected from those. Further, compounds that are not described in Handbooks of Chemistry, but are estimated to have appropriate pKa on the structure can also preferably be used in the present invention. Table 3 shows compounds b-1 to b-19 having appropriate pKa described in Handbooks of Chemistry, but the compounds that can be used in the present invention are not limited to those compounds. For reference, Table 3 shows a compound b-20 having a pKa not included in the range of 5.0 to 11.0.

TABLE 3
Organic base

| | Chemical name | pKa |
|---|---|---|
| b-1 | N,N-Dimethylaniline | 5.1 |
| b-2 | Benzimidazole | 5.5 |
| b-3 | Pyridine | 5.7 |
| b-4 | 3-Methylpyridine | 5.8 |
| b-5 | 2,9-Dimethyl-1,10-phenanthroline | 5.9 |
| b-6 | 4,7-Dimethyl-1,10-phenanthroline | 5.9 |
| b-7 | 2-Methylpyridine | 6.1 |
| b-8 | 4-Methylpyridine | 6.1 |
| b-9 | 3-(N,N-dimethylamino)pyridine | 6.5 |
| b-10 | 2,6-Dimethylpyridine | 7.0 |
| b-11 | Imidazole | 7.0 |
| b-12 | 2-Methylimidzole | 7.6 |
| b-13 | N-Ethylmorpholine | 7.7 |
| b-14 | N-Methylmorpholine | 7.8 |
| b-15 | Bis(2-methoxyethyl)amine | 8.9 |
| b-16 | 2,2-Iminodiethanol | 9.1 |
| b-17 | N,N-Dimethyl-2-aminoethanol | 9.5 |
| b-18 | Trimethylamine | 9.9 |
| b-19 | Triethylamine | 10.7 |
| b-20 | Diisopropylamine | 11.9 |

The organic base having lower boiling point has higher acid generation efficiency when heating, and therefore is preferable from the standpoint of curing activity. Consequently, it is more preferable to use an organic base having an appropriate boiling point. The base has a boiling point of preferably 120° C. or lower, more preferably 80° C. or lower, and most preferably 70° C. or lower.

Examples of the organic base that can be used in the present invention include the following compounds, but the invention is not limited to those. The parenthesis means a boiling point.

b-3: Pyridine (115° C.)

b-14: 4-Methylmorpholine (115° C.)

b-20: Diisopropylamine (84° C.)

b-19: Triethylamine (88.8° C.)

b-21: t-Butylmethylamine (67 to 69° C.)

b-22: Dimethylisopropylamine (66° C.)

b-23: Diethylmethylamine (63 to 65° C.)

b-24: Dimethylethylamine (36 to 38° C.)

b-18: Trimethylamine (3 to 5° C.)

b-25: Diallylmethylamine (111° C.)

When used as an acid catalyst in the present invention, a slat comprising the acid and the organic base may be isolated and used, or the acid and the organic base are mixed to form a salt in the solution, and the solution may be used. The acid and the organic base may be used alone or as mixtures of two or more thereof, respectively. When the acid and the organic base are used as a mixture, those are mixed such that the equivalent ratio of the acid to the organic base is preferably from 1:0.9 to 1:1.5, more preferably from 1:0.95 to 1:1.3, and most preferably from 1:1.0 to 1:1.1.

The proportion of the acid catalyst used is preferably from 0.01 to 10 parts by mass, more preferably from 0.1 to 5 parts by mass, and most preferably from 0.2 to 3 parts by mass, per 100 parts by mass of the fluorine-containing polymer in the curable resin composition.

(Photosensitive Acid Generator)

In the present invention, other than the above-described thermal acid generator, a compound that generates an acid by light irradiation, that is, a photosensitive acid generator, may further be added. The photosensitive acid generator imparts a photosensitivity to a coating film of the curable resin composition, and is, for example, a substance that can photocure the coating film by irradiation with a radiation such as light.

Examples of the photosensitive acid generator include the conventional compounds such as a light cationic polymerization initiator, a light decoloring agent such as dyestuffs, a light discoloring agent, and conventional acid generators used in, for example, a microresist, and their mixtures.

Representative examples of the photosensitive acid generator include (1) various onium slats such as an iodonium salt, a sulfonium salt, a phosphonium salt, a diazonium salt, an ammonium salt, an iminium salt, a pyridinium salt, an arsonium salt and a selenonium salt (preferably a diazonium salt, an iodonium salt, a sulfonium salt and an iminium salt); (2) sulfone compounds such as a β-ketoester, a β-sulfonium sulfone and their α-diazo compounds; (3) sulfonic acid esters such as an alkyl sulfonic acid ester, a haloalkylsulfonic acid ester, an arylsulfonic acid ester and an iminosulfonate; (4) sulfoneimide compounds; and (5) diazomethane compounds.

Of those, a diazonium salt, an iodonium salt, a sulfonium salt and an iminium salt are preferable from the points of photosensitivity of a photopolmerization initiation, a material stability of a compound, and the like. The compounds described in, for example, paragraphs [0058] to [0059] of JP-A-2002-29162 are used.

The photosensitive acid generator can be used alone or as mixture of two or more thereof. The proportion of the photosensitive acid generator used is preferably from 0 to 20 parts by mass, and more preferably from 0.1 to 10 parts by mass, per 100 parts by mass of the fluorine-containing polymer in the curable resin composition. When the proportion of the photosensitive acid generator is the above upper limit or less, the cured film obtained has excellent strength, and also has good transparency, which is preferable.

As other specific compounds and use methods, the contents described in, for example, JP-A-2005-4376 can be employed.

1-4. Light-Transmitting Particle

Various light-transmitting particles (called matte particles) can be used in the functional layer, particularly an antiglare layer or a hard coat layer, of the antireflective film of the present invention in order to impart antiglare properties or internal scattering properties.

The light-transmitting particles may be organic particles or inorganic particles. The form of the matte particles can be any of a spherical form and an amorphous form. Variation in scatter characteristics is less with decreasing variation in the particle diameter, making it easy to design Haze value. Plastic beads are suitable as the light-transmitting particles, and particles having difference in refractive index to the binder in the numerical range described hereinafter are preferable.

Examples of the organic particles used include polymethyl methacrylate particles (refractive index: 1.49), crosslinked poly(acryl-styrene) copolymer particles (refractive index: 1.54), melamine resin particles (refractive index: 1.57), polycarbonate particles (refractive index: 1.57), polystyrene particles (refractive index: 1.60), crosslinked polystyrene particles (refractive index: 1.61), polyvinyl chloride particles (refractive index: 1.60), and benzoguanamine-melamine formaldehyde particles (refractive index: 1.68). Examples of the inorganic particles used include silica particles (refractive index: 1.44), alumina particles (refractive index: 1.63), zirconia particles, titania particles, hollow inorganic particles and inorganic particles having pores.

Of those, crosslinked polystyrene particles, crosslinked polystyrene particles, crosslinked poly(meth)acrylate particles and crosslinked poly(acryl-styrene) particles are preferably used. Refractive index of the binder is adjusted according to the refractive index of each light-transmitting particle selected from the above particles, and as a result, preferable internal haze, surface haze and center line average roughness can be achieved in the present invention.

A combination of the binder (refractive index after curing is from 1.50 to 1.53) comprising a trifunctional or more (meth)acrylate monomer as a main component and the light-transmitting particles comprising a crosslinked poly(meth)acrylate polymer having an acryl content of from 50 to 100 mass % is preferable, and particularly, a combination of the binder and the light-transmitting particles (refractive index: 1.48 to 1.54) comprising a crosslinked poly(styrene-acryl) copolymer is preferable.

The refractive index of the binder (light-transmitting resin) and the light-transmitting particles is preferably from 1.45 to 1.70, and more preferably from 1.48 to 1.65. To achieve the refractive index to the above range, the kind and the proportion of the binder and the light-transmitting particles are appropriately selected. How to select those can easily be previously determined experimentally.

In the present invention, the difference in refractive index between the binder and the light-transmitting particles (refractive index of light-transmitting particles—refractive index of binder) is preferably from 0.001 to 0.030, more preferably from 0.001 to 0.020, and most preferably from 0.001 to 0.015, as the absolute value. Where the difference exceeds 0.030, film character blurring, reduction of contrast in dark room or white turbidity on surface occurs.

The refractive index of the binder can be quantified and evaluated by, for example, directly measuring with Abbe refractometer or measuring with spectral reflection spectrum or spectral ellipsometry. The refractive index of the light-transmitting particles is measured by dispersing an equivalent amount of the light-transmitting particles in solvents having different refractive indexes by changing a mixing ratio of two kinds of solvents having different refractive index, measuring the turbidity, and measuring the refractive index of the respective solvent when the turbidity is minimum, with Abbe refractometer.

In the case of the light-transmitting particles, the light-transmitting particles are liable to precipitate in the binder. Therefore, an inorganic filler such as silica may be added to prevent precipitation. The inorganic filler is effective to prevent precipitation of the light-transmitting particles with increasing its addition amount, but adversely affect the transparency of the binder. Therefore, preferably the inorganic filler having a particle diameter of 0.5 μm or less are added to the binder in an amount of about less than 0.1 mass % in an extent that the transparency of the coating film is not impaired.

The light-transmitting particles have an average particle diameter of preferably from 0.5 to 10 μm, and more preferably from 2.0 to 6.0 μm. When the average particle diameter is 0.5 μm or more, character blurring on a display does not occur, which is preferable. On the other hand, when the average particle diameter is 10 μm or less, it is not necessary to increase the film thickness of a layer to which the light-transmitting particles are added, and this avoids the problems such as curling and cost increase, which is preferable.

The light-transmitting particles may be used two or more kinds of particles having different particle diameter in combination. The use in combination can impart the antiglare properties by the light-transmitting particles having larger particle diameter, and can reduce rough feeling on the surface by the light-transmitting particles having smaller particle diameter.

The light-transmitting particles are contained in the solid content of a layer to which the particles are added, in an amount of preferably from 3 to 30 mass %, and more preferably from 5 to 20 mass %. When the amount is 3 mass % or more, a sufficient addition effect can be exhibited, and when the amount is 30 mass % or less, the problems such as image blurring, and white turbidity or glaring on the surface do not occur.

The light-transmitting particles have a density of preferably from 10 to 1,000 mg/m², and more preferably from 100 to 700 mg/m².

Particle size distribution of the matte particles is measured with Coulter counter, and the distribution measured is converted to a particle number distribution.

(Preparation of Light-Transmitting Particles, and Classification)

The production method of the light-transmitting particles according to the present invention includes a suspension polymerization method, an emulsion polymerization method, a soap-free emulsion polymerization method, a dispersion polymerization method and a seed polymerization method. Any of those methods can be used for the production. Those production methods can be referred to the methods described in, for example, “Experimental Method of Polymer Synthesis” (Takayuki Ohtsu and Masanobu Kinoshita, Kagaku-dojin Publishing Company, Inc.), pages 130 and 146 to 147, “Synthetic Polymer”, Vol. 1, pages 246 to 290, “Synthetic Polymer”, Vol. 3, pages 1 to 108, Japanese Patents 2543503, 3508304, 2746275, 3521560 and 3580320, JP-A-10-1561, JP-A-7-2908, JP-A-5-297506 and JP-A-2002-145919.

The particle size distribution of the light-transmitting particles is preferably a monodisperse particle from haze value, control of diffusion properties, and homogeneity of coated surface form. For example, where particles having a particle diameter 20% or more larger than the average particle diameter are defined as course particles, the proportion of the course particles are 1% or less, more preferably 0.1% or less, and most preferably 0.01% or less, of the total particle number. It is an effective means that the particles having such a particle size distribution are classified after preparation or synthesis reaction. By increasing the number of classification or increasing its degree, particles having the desired distribution can be obtained.

1-5. Inorganic Particle

The composition used in the present invention contains inorganic particles in addition to the salt. This enables the antireflective film having excellent mar resistance to prepare while establishing storage stability of the coating liquid and the curing activity. Further, the inorganic particles can improve other properties, for example, physical properties such as hardness, and optical properties such as reflectivity and scattering property.

The inorganic particles are at least one metal selected from silicon, zirconium, titanium, aluminum, indium, zinc, tin and antimony, and specific examples thereof include ZrO₂, TiO₂, Al₂O₃, In₂O₃, ZnO, SnO₂, Sb₂O₃ and ITO. Other examples include BaSO₄, CaCO₃, talc and kaolin.

Regarding the particle diameter of the inorganic particles used in the present invention, the particles are preferably finely divided in the dispersion medium, and therefore, have a mass average particle diameter of from 1 to 200 nm, preferably from 5 to 150 nm, more preferably from 10 to 100 nm, and most preferably from 10 to 80 nm. By finely dividing the inorganic particles to the mass average particle diameter of 100 nm, a film that does not impair transparency can be formed. The particle diameter of the inorganic particles can be measured with a light scattering method or by an electron micrograph.

The inorganic particles have a specific surface area of preferably from 10 to 400 m²/g, more preferably from 20 to 200 m²/g, and most preferably from 30 to 150 m²/g.

The inorganic particles used in the present invention are preferably added to the coating liquid of the layer, in which those are used as dispersed materials in a dispersion medium.

The dispersion medium used for the inorganic particles is preferably a liquid having a boiling point of from 60 to 170° C. Examples of the dispersion medium include water, alcohols (for example, methanol, ethanol, isopropanol, butanol and benzyl alcohol), ketones (for example, acetone, methyl ethyl ketone, methyl isobutyl ketone and cyclohexanone), esters (for examples, methyl acetate, ethyl acetate, propyl acetate, butyl acetate, methyl formate, ethyl formate, propyl formate and butyl formate), aliphatic hydrocarbons (for example, hexane and cyclohexane), halogenated hydrocarbons (for example, methylene chloride, chloroform and carbon tetrachloride), aromatic hydrocarbons (for example, benzene, toluene and xylene), amides (for example, dimethylformaldehyde, dimethylacetamide and N-methylpyrrolidone), ethers (for example, diethyl ether, dioxane and tetrahydrofuran), and ether alcohols (for example, 1-methoxy-2-propanol). Of those, toluene, xylene, methyl ethyl ketone, methyl isobutyl ketone, cyclohexanone and butanol are preferable, and methyl ethyl ketone, methyl isobutyl ketone and cyclohexanone are more preferable.

The inorganic particles are dispersed using a dispersing machine. Examples of the dispersing machine include a sand grinder mill (for example, a bead mill with pin), a high-speed impeller mill, Pebble Mill, a roller mill, an attriter and a colloid mill. Of those, a sand grinder mill and a high-speed impeller mill are preferable. A pre-dispersion treatment may be conducted. Examples of the dispersing machine used in the pre-dispersion treatment include a ball mill, a three-roll mill, a kneader and an extruder.

(Higher Refractive Index Particles)

For the purpose of achieving higher refractive index of the layer used in the present invention, a cured product of a composition comprising a monomer, an initiator and an organically substituted silicon compound, having inorganic particles having higher refractive index dispersed therein is preferably used.

In this case, ZrO₂ and TiO₂ are particularly preferably used as the inorganic particles from the standpoint of refractive index. To achieve higher refractive index of the hard coat layer, ZrO₂ is most preferably used, and as the particles for a medium refractive index layer, fine particles of TiO₂ are most preferably used.

The TiO₂ particles are particularly preferably inorganic particles comprising TiO₂ as a main component and at least one element selected from cobalt, aluminum and zirconium. The term “main component” used here means a component having the largest content (mass %) in the components constituting the particles.

The particles comprising TiO₂ as the main component in the present invention have refractive index of preferably from 1.90 to 2.80, more preferably from 2.10 to 2.80, and most preferably from 2.20 to 2.80.

The primary particles of the particles comprising TiO₂ as the main component have a mass average particle diameter of preferably from 1 to 200 nm, more preferably from 1 to 150 nm, further more preferably from 1 to 100 nm, and most preferably from 1 to 80 nm.

The particles comprising TiO₂ as the main component have preferably a crystal structure such that a rutile structure, a rutile/anatase mixed crystal structure, an anatase structure or an amorphous structure is a main component. Of those, the particles in which the rutile structure is the main component are particularly preferable. The term “main component” used here means a component having the largest content (mass %) in the components constituting the particles.

When the particles comprising TiO₂ as the main component contains at least one element selected from Co (cobalt), Al (aluminum) and Zr (zirconium), photocatalyst activity possessed by TiO₂ can be suppressed, and weather resistance of the antireflective film of the present invention can be improved. The preferable element is Co (cobalt). Further, use of at least two elements in combination is also preferable.

The particles comprising TiO₂ as the main component used in the present invention may have a core/shell structure by a surface treatment as described in, for example, JP-A-2001-166104.

The addition amount of the inorganic particles in the layer is preferably from 10 to 90 mass %, and more preferably from 20 to 80 mass %, based on the total mass of the binder. The inorganic particles may be used in the layer as mixtures of two kinds or more thereof.

(Lower Refractive Index Particles)

The inorganic particles contained in the lower refractive index layer preferably have a lower refractive index, and examples of such inorganic particles include particles of magnesium fluoride fine particle and silica fine particles. In particular, the silica fine particles are preferable from the points of refractive index, dispersion stability and cost.

The silica fine particles have an average particle diameter of preferably from 30 to 150%, more preferably from 35 to 80%, and most preferably from 40 to 60%, the thickness of the lower refractive index layer. Specifically, when the thickness of the lower refractive index is 100 nm, the particle diameter of the silica fine particles is preferably from 30 to 150 nm, more preferably from 35 to 80 nm, and most preferably from 40 to 60 nm.

The average particle of the silica fine particles is measured with a Coulter counter.

Where the particle diameter of the silica fine particles is larger than the above lower limit, improvement effect in mar resistance increases, and where lower than the above upper limit, the disadvantages do not occur such that fine unevenness generates on the surface of the lower refractive index layer, and appearance such as black depth, and integral reflectivity deteriorate. The silica fine particles may be crystalline or amorphous. Further, the silica fine particles may be monodisperse particles, or agglomerated particles if satisfying a predetermined particle diameter. The shape is most preferably spherical, but may be amorphous.

(Silica Fine Particle of Small Particle Diameter)

It is preferable to use at least one of silica fine particles having an average particle diameter of less than 25% the thickness of the lower refractive index layer (hereinafter referred to as “silica fine particles of small particle diameter”) in combination with the silica fine particles having the above particle diameter (hereinafter referred to as “silica fine particles of large particle diameter”). The silica fine particles of small particle diameter” can be present in spaces between the silica fine particles of large particle diameter, and therefore can contribute as a holding agent of the silica fine particles of large particle diameter.

The silica fine particles of small particle diameter have an average particle diameter of preferably from 1 to 20 nm, more preferably from 5 to 15 nm, and most preferably from 10 to 15 nm, when the lower refractive index layer has a thickness of 100 nm. Use of such silica fine particles is preferable in the points of raw material cost and effect of a holding agent.

The application amount of the silica fine particles having a lower refractive index is preferably from 1 to 100 mg/m², more preferably from 5 to 80 mg/m², and most preferably from 10 to 60 mg/m². When the amount is the lower limit or more, good improvement effect in mar resistance can be exhibited, and when the amount is the upper limit or less, the disadvantages do not occur such that fine unevenness generates on the surface of the lower refractive index layer, and appearance such as black depth, and integral reflectivity deteriorate.

Hollow silica fine particles are preferably used for the purpose of further decreasing refractive index.

The follow silica fine particles have its refractive index of preferably from 1.15 to 1.40, more preferably from 1.17 to 1.35, and most preferably from 1.17 to 1.30. The term “refractive index” used here means refractive index as the whole particles, and does not show refractive index of only silica of an outer shell forming the hollow silica particles. When a radius of a pore in the particle is represented by rᵢ, and a radium of an outer shell of a particle is represented by rₒ, the porosity x (%) is represented by the following equation (1). The porosity x of the hollow silica fine particles is preferably from 10 to 60%, more preferably from 20 to 60%, and most preferably from 30 to 60%.
x={(4πrᵢ³/3)/4πrₒ³/3}}×100 Equation (1):

Where it is attempted to make the hollow silica particles have lower refractive index and larger porosity, the thickness of the outer shell decreases, thereby decreasing strength of the particle. Therefore, the refractive index of the hollow silica particles is generally 1.15 or more from the standpoint of mar resistance.

The production method of the hollow silica particles is described in, for example, JP-A-2001-233611 and JP-A-2002-79616. The hollow silica particles preferably used in the present invention are particles having a cavity inside the outer shell, and particles in which pores in the outer shell are clogged are particularly preferable. The refractive index of those hollow silica particles can be calculated by the method described in JP-A-2002-79616.

The application amount of the hollow silica particles is preferably from 1 to 100 mg/m², more preferably from 5 to 80 mg/m², and most preferably from 10 to 60 mg/m². When the amount is the lower limit or more, effect for achieving a lower refractive index and good improvement effect in mar resistance can be exhibited, and when the amount is the upper limit or less, the disadvantages do not occur such that fine unevenness generates on the surface of the lower refractive index layer, and appearance such as black depth, and integral reflectivity deteriorate.

The hollow silica particles have an average particle diameter of preferably from 30 to 150%, more preferably from 35 to 80%, and most preferably from 40 to 60%, the thickness of the lower refractive index layer. Specifically, when the thickness of the lower refractive index layer is 100 nm, the particle diameter of the hollow silica particles is preferably from 30 to 150 nm, more preferably from 35 to 100 nm, and most preferably from 40 to 65 nm. When the particle diameter of the hollow silica fine particles is the lower limit or more, the proportion of the cavity portion is sufficient, and decrease in refractive index is expected. When the particle diameter is the upper limit or less, the disadvantages do not occur such that fine unevenness generates on the surface of the lower refractive index layer, and appearance such as black depth, and integral reflectivity deteriorate. The hollow silica particles may be crystalline or amorphous. Monodisperse particles are preferable. The shape is most preferably spherical, but may be amorphous.

Two kinds or more of the hollow silica particles having different average particle diameter can be used in combination. The average particle diameter of the hollow silica particles can be determined from an electron micrograph.

The hollow silica particles have a specific surface area of preferably from 20 to 300 m²/g, more preferably from 30 to 120 m²/g, and most preferably from 40 to 90 m²/g. The specific surface area can be determined by BET method using nitrogen.

In the present invention, silica particles having no cavity can be used in combination with the hollow silica particles. The silica particles having no cavity used have a particle diameter of preferably from 30 to 150 nm, more preferably from 35 to 100 nm, and most preferably from 40 to 80 nm.

1-6. Conductive Particle

Various conductive particles can be used in the antireflective film of the present invention to impart conductivity thereto. The conductive particles are preferably formed from an oxide or a nitride of a metal. Examples of the oxide or nitride of a metal include tin oxide, indium oxide, zinc oxide and titanium nitride. Tin oxide and indium oxide are particularly preferable.

The conductive inorganic particles comprise oxides or nitrides of those metals as a main component, and can further contain other elements. The term “main component” used here means a component having largest content (mass %) in the components constituting the particles. Examples of the other component include Ti, Zr, Sn Sb, Cu, Fe, Mn, Pb, Cd, As, Cr, Hg, Zn, Al, Mg, Si, P, S, B, Nb, In, V and a halogen atom. To increase conductivity of tin oxide and indium oxide, Sb, P, B, Nb, In, V and a halogen atom are preferably added. Tin oxide containing Sb (ATO) and Indium oxide containing Sn (ITO) are particularly preferable. The proportion of Sb in ATO is preferably from 3 to 20 mass %. The proportion of Sn in ITO is preferably from 5 to 20 mass %.

The primary particle of the conductive inorganic particles used in the antistatic layer has an average particle diameter of preferably from 1 to 150 nm, more preferably from 5 to 100 nm, and most preferably from 5 to 70 nm. The conductive inorganic particles in the antistatic layer formed have an average particle diameter of from 1 to 200 nm, preferably from 5 to 150 nm, more preferably from 10 to 100 nm, and most preferably from 10 to 80 nm. The average particle diameter of the conductive inorganic particles is an average diameter based on the mass of particles as being weight, and can be measured with a light scattering method or an electron micrograph.

The conductive inorganic particles have a specific surface area of preferably from 10 to 400 m²/g, more preferably from 20 to 200 m²/g, and most preferably from 30 to 150 m²/g.

The conductive inorganic particles may be surface treated. The surface treatment is conducted using an inorganic compound or an organic compound. Examples of the inorganic compound used in the surface treatment include alumina and silica. Silica treatment is particularly preferable. Examples of the organic compound used in the surface treatment include a polyol, an alkanol amine, stearic acid, a silane coupling agent and a titanate coupling agent. A silane coupling agent is most preferable. At least two surface treatments may be combined and conducted.

Shape of the conductive inorganic particles is preferably rice-granular, spherical, cubic, bell or amorphous.

At least two kinds of the conductive inorganic particles can be used in combination in the specific layer or as the layer itself.

The proportion of the conductive inorganic particles in the antistatic layer is preferably from 20 to 90 mass %, more preferably from 25 to 85 mass % and most preferably from 30 to 80 mass %.

The conductive inorganic particles can be used in the form of a dispersed material for the formation of the antistatic layer.

1-7. Surface-Treating Agent

The inorganic particles used in the present invention may be subjected to a physical surface treatment such as a plasma discharge treatment or a corona treatment, or a chemical surface treatment by a surfactant, a coupling agent or the like, in order to attempt dispersion stabilization, or increase affinity or bondability with the binder component.

The surface treatment can be conducted using a surface treating agent such as an inorganic compound or an organic compound. Examples of the inorganic compound used in the surface treatment include an inorganic compound containing cobalt (CoO₂, CO₂O₃, CO₃O₄ and the like), an inorganic compound containing aluminum (Al₂O₃, Al(OH)₃ and the like), an inorganic compound containing zirconium (ZrO₂, Zr(OH)₄ and the like), an inorganic compound containing silicon (SiO₂ and the like), and an inorganic compound containing iron (Fe₂O₃ and the like).

An inorganic compound containing cobalt, an inorganic compound containing aluminum and an inorganic compound containing zirconium are particularly preferable, and an inorganic compound containing cobalt, Al(OH)₃ and Zr(OH)₄ are most preferable.

Examples of the organic compound used in the surface treatment include a polyol, an alkanol amine, an organic compound having an anionic group (preferably an organic compound having a carboxylic group, a sulfonic group or a phosphoric group, and stearic acid, lauric acid, oleic acid, linoleic acid, linolenic acid and the like are particularly preferable), a silane coupling agent and a titanate coupling agent. Of those, a silane coupling agent is most preferable. In particular, it is preferable to be surface treated with at least one of the silane coupling agent (organosilane compound), its partial hydrolyzate and its condensate.

Examples of the titanate coupling agent include metal akoxides such as tetramethoxytitanium, tetraethoxytitanium and tetraisopropoxytitanium, and PLANEACT (KR-TTS, KR-46B, KR-55, KR-41B and the like), products of Ajinomoto Co., Inc.

The organic compound used in the surface treatment preferably further has a crosslinkable or polymerizable functional group. Examples of the crosslinkable or polymerizable functional group include an ethylenically unsaturated group capable of undergoing addition reaction/polymerization reaction by radical species (for example, a (meth)acrylic group, an allyl group, a styryl group and an vinyloxy group), a cationically polymerizable group (for example, an epoxy group, an oxatanyl group and a vinyloxy group), and a polycondensation reactive group (for example, a hydrolyzable silyl group and an N-methylol group). A group having an ethylenically unsaturated group is preferable.

Those compounds used in the surface treatment can be used as mixtures of two or more thereof. A mixture of the inorganic compound containing aluminum and the inorganic compound containing zirconium is particularly preferably used.

When the inorganic particles are silica, use of a silane coupling agent is particularly preferable. The silane coupling agent preferably used is an alkoxymetal compound (for example, a titanium coupling agent and a silane coupling agent). Of those, a silane coupling treatment is particularly effective.

The coupling agent is used to previously apply a surface treatment as, for example, a surface treating agent of the inorganic filler in the lower refractive index layer before the preparation of a coating liquid for the layer. However, the coupling agent is preferably further added as an additive when preparing the coating liquid for the layer to contain the same in the layer. In particular, preferably the silica fine particles are previously dispersed in a medium before the surface treatment to reduce load of the surface treatment.

Specific compounds of the surface treating agent and the catalyst for surface treatment, that can preferably be used in the present invention are organosilane compounds and catalysts described in, for example, WO 2004/017105.

1-8. Dispersing Agent

Various dispersing agents can be used for dispersion of the particles used in the present invention.

The dispersing agent preferably contains a crosslinkable or polymerizable functional group. Examples of the crosslinkable or polymerizable functional group include an ethylenically unsaturated group capable of undergoing addition reaction/polymerization reaction by radical species (for example, a (meth)acryloyl group, an allyl group, a styryl group and a vinyloxy group), a cationically polymerizable group (an epoxy group, an oxatanyl group and a vinyloxy group), and a polycondensation reactive group (for example, a hydrolyzable silyl group and an N-methylol group). A functional group having an ethylenically unsaturated group is preferable.

A dispersing agent having an anionic group is preferably used for dispersion of the inorganic particles, particularly dispersion of the inorganic particles comprising TiO₂ as the main component. It is more preferable for the dispersing agent to have an anionic group and a crosslinkable or polymerizable functional group, and particularly preferable for the dispersing agent to have the crosslinkable or polymerizable functional group at the side chain.

The effective anionic group is a group having an acidic proton such as a carboxyl group, a sulfonic acid group (sulfo group), a phosphoric acid group (phosphono group) or a sulfonamide group, or its salt. A carboxyl group, a sulfonic acid group, a phosphoric acid group, or its salt is preferable, and a carboxyl group and a phosphoric acid group are particularly preferable. The number of the anionic group contained in the dispersing agent per one molecule may be plural in plural kinds, but is preferably 2 or more, more preferably 5 or more, and most preferably 10 or more, on the average. The dispersing agent may contain plural number and plural kinds of the anionic groups in one molecule thereof.

In the dispersing agent having the anionic group at the side chain, the proportion of the repeating unit containing an anionic group is in a range of from 10⁻⁴ to 100 mol %, preferably from 1 to 50 mol %, and more preferably from 5 to 20 mol %, to the total repeating units.

The dispersing agent preferably further has a crosslinkable or polymerizable functional group. Examples of the crosslinkable or polymerizable functional group include an ethylenically unsaturated group capable of undergoing addition reaction/polymerization reaction by radical species (for example, a (meth)acryloyl group, an allyl group, a styryl group and an vinyloxy group), a cationically polymerizable group (for example, an epoxy group, an oxatanyl group and a vinyloxy group), and a polycondensation reactive group (for example, a hydrolyzable silyl group and an N-methylol group). A functional group having an ethylenically unsaturated group is preferable.

The number of the crosslinkable or polymerizable functional group contained in the dispersing agent per one molecule is preferably 2 or more, more preferably 5 or more, and most preferably 10 or more, on the average. The dispersing agent may contain plural number and plural kinds of the crosslinkable or polymerizable groups in one molecule thereof.

In the dispersing agent preferably used in the present invention, examples of the repeating unit having an ethylenically unsaturated group at the side chain include a poly-1,2-butadien structure, a poly-1,2-isoprene structure and a repeating unit of an ester or an amide of (meth)acrylic acid. The repeating unit having a specific residue (—CCCR⁵⁰ or R⁵⁰ group of CONHR⁵⁰) bonded thereto can also be used.

Examples of the specific residue (R⁵⁰ group) include —(CH₂)ₙ—CR⁵¹═CR⁵²R⁵³, —(CH₂O)ₙ—CH₂CR⁵¹═CR⁵²R⁵³, —(CH₂CH₂O)ₙ—CH₂CR⁵¹═CR⁵²R⁵³, —(CH₂)ₙ—NH—CO—O—CH₂CR⁵¹═CR⁵²R⁵³, —(CH₂)ₙ—O—CO—CR⁵¹═CR⁵²R⁵³, and (CH₂CH₂O)₂—X⁵¹. R⁵¹ to R⁵³ each represent a hydrogen atom, a halogen atom, an alkyl group having from 1 to 20 carbon atoms, an aryl group, an alkoxy group and an aryloxy group. R⁵¹ to R⁵³ may be combined to form a ring. n is an integer of from 1 to 10. X⁵¹ represents a dicyclopentadienyl residue.

Specific examples R⁵⁰ in the ester residue include —CH₂CH═CH₂ (a polymer of allyl (meth)acrylate described in JP-A-64-17047), —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂, and CH₂CH₂O—X⁵¹ (X⁵¹ is a cyclopentadienyl group). Specific examples of R⁵⁰ in the amide residue include —CH₂CH═CH₂, —CH₂CH₂—X⁵² (X⁵² is a 1-cyclohexenyl residue), —CH₂CH₂—OCO—CH═CH₂, and —CH₂CH₂—OCO—C(CH₃)═CH₂.

In the dispersing agent having the ethylenically unsaturated group, free radical (polymerization initiation radical or growth radical in the course of polymerization of the polymerizable monomer) is added to the unsaturated bonding group to conduct addition polymerization directly between the molecules or through a polymerization chain of the polymerizable compound, and crosslinking is formed between the molecules to cure. Alternatively, An atoms (for example, a hydrogen atom on a carbon atom adjacent the unsaturated bonding group) is pulled out of a free radical to form a polymer radical, and the polymer radicals are bonded with each other, thereby crosslinking is formed between the molecules to cure.

The mass average molecular weight (Mw) of the dispersing agent having an anionic group, and a crosslinkable or polymerizable functional group, and also having the crosslinkable or polymerizable functional group at the side chain is not particularly limited, but is preferably 1,000 or more, more preferably from 2,000 to 1,000,000, further more preferably from 5,000 to 200,000, and most preferably from 10,000 to 100,000.

The unit containing the crosslinkable or polymerizable functional group may constitute all repeating units other than the anionic group-containing repeating unit, but is preferably from 5 to 50 mol %, and more preferably from 5 to 30 mol %, per mole of the whole crosslinking or repeating units.

The dispersing agent may be a copolymer with an appropriate monomer other than the monomer having a crosslinkable or polymerizable functional group or an anionic group. The copolymerizable component is not particularly limited, but is selected from the various standpoints of dispersion stability, compatibility with other monomer component, strength of a coating film formed. Preferable examples of the component include methyl (meth)acrylate, n-butyl (meth)acrylate, t-butyl (meth)acrylate, cyclohexyl (meth)acrylate and styrene.

Form the dispersing agent is not particularly limited, but a block copolymer and a random copolymer are preferable, and a random copolymer is more preferable from cost and easy synthesis.

The amount of the dispersing agent used is in a range of preferably from 1 to 50 mass %, more preferably from 5 to 30 mass %, and most preferably from 5 to 20 mass %, based on the mass of the inorganic particles. The dispersing agent may be used as mixtures of two or more thereof.

1-9. Antifouling Agent

Preferably, the conventional silicone or fluorine antifouling agents, slip agents and the like are appropriately added to the antireflective film, particularly its outermost layer, of the present invention for the purpose of imparting properties of antifouling property, water resistance, chemical resistance, slipperiness and the like thereto.

Where those additives are added, those additives are added in an amount of preferably from 0.01 to 20 mass %, more preferably from 0.05 to 10 mass %, and most preferably from 0.1 to 5 mass %, based on the mass of the total solid content of the low reflective index layer.

Preferable examples of the silicone compound include compounds containing plural dimethylsilyloxy units as the repeating unit, and having substituents at the terminal and/or side chain of the compound chain. The compound chain containing dimethylsilyloxy as the repeating unit may contain a repeating unit other than dimethylsilyloxy.

The substituents may be the same or different, and the presence of plural substituents is preferable. Examples of the preferable substituent include groups containing an acryloyl group, a methacryloyl group, a vinyl group, an aryl group, a cinnamoyl group, an epoxy group, an oxetanyl group, a hydroxyl group, a fluoroalkyl group, a polyoxyalkyl group, a carboxyl group or an amino group.

The molecular weight of the silicone compound is not particularly limited, but is preferably 100,000 or less, more preferably 50,000 or less, further more preferably from 3,000 to 30,000, and most preferably from 10,000 to 20,000.

The silicon atom content in the silicone compound is not particularly limited, but is preferably 18.0 mass % or more, more preferably from 25.0 to 37.8 mass %, and most preferably from 30.0 to 37.0 mass %.

Examples of the preferable silicone compound include “X-22-174DX”, “X-22-2426”, “X-22-164B”, “X-22-164C”, “X-22-170DX”, “X-22-176D” and “X-22-1821” (trade names, products of Shin-Etsu Chemical Co., Ltd.; “SILAPLANE FM-0725”, “SILAPLANE FM-7725”, “SILAPLANE FM-4421”, “SILAPLANE FM-5521”, “SILAPLANE FM-6621” and “SILAPLANE FM-1121” (trade names, product of Chisso Corporation; and “DMS-U22”, “RMS-033”, “RMS-083”, “UMS-182”, DMS-H21”, “DMS-H31”, HMS-301”, FMS121”, “FMS123”, “FMS131”, “FMS141” and “FMS221” (trade names, products of Gelest Co. However, the invention is not limited to those.

The fluorine compound is preferably a compound having a fluoroalkyl group. The fluoroalkyl group has preferably from 1 to 20, and more preferably from 1 to 20, carbon atoms, and may be a straight chain (for example, —CF₂CF₃, —CH₂(CF₂)₄H, —CH₂(CF₂)₈CF₃ and —CH₂CH₂(CF₂)₄H), a branched structure (for example, CH(CF₃)₂, CH₂CF(CF₃)₂, CH(CH₃)CF₂CF₃ and CH(CH₃)(CF₂)₅CF₂H), or a alicyclic structure (preferably 5-membered or 6-membered ring; for example, a perfluorocyclohexy group, a perfluorocyclopentyl group, and an alkyl group substituted with those). The fluoroalkyl group may contain an ether bond (for example, CH₂OCH₂CF₂CF₃, CH₂CH₂0CH₂C₄F₈H, CH₂CH₂OCH₂CH₂C₈F₁₇ and CH₂CH₂OCF₂CF₂OCF₂CF₂H). Plural fluoroalkyl groups may be contained in one molecule.

The fluorine compound preferably further have a substituent contributing to the formation of bond to the low reflective index layer, or compatibility. The substituent may be the same or different, and the presence of plural substituents is preferable. Examples of the preferable substituent include an acryloyl group, a methacryloyl group, a vinyl group, an aryl group, a cinnamoyl group, an epoxy group, an oxetanyl group, a hydroxyl group, a fluoroalkyl group, a polyoxyalkyl group, a carboxyl group or an amino group.

The fluorine compound may be a copolymer with a compound not containing a fluorine atom, or a cooligomer, and its molecular weight is not particularly limited.

The fluorine atom content in the fluorine compound is not particularly limited, and is preferably 20 mass % or more, more preferably from 30 to 70 mass % and most preferably from 40 to 70 mass %.

Examples of the preferable fluorine compound include “R-2020”, “M-2020”, “R-3833” and “M-3833” (trade names, products of Daikin Industries, Ltd.; and “MEGAFAC F-171”, “MEGAFAC F-172”, “MEGAFAC F-179A” and “DEFENSA MCF-300” (trade names, products of Dainippon Ink and Chemicals, Incorporated). However, the invention is not limited to those.

Conventional dust-proof agents (such as a cationic surfactant or a polyoxyalkylene compound), antistatic agents and the like can appropriately be added for the purpose of imparting dust-proof properties, antistatic properties and the like. Those dust-proof agent and antistatic agent may be contained in the silicone compound or the fluorine compound as that the repeating unit is a part of function.

When those additive are added, those additives are added in an amount of preferably from 0.01 to 20 mass %, more preferably from 0.05 to 10 mass %, and most preferably from 0.1 to 5 mass %, based on the mass of the total solid content of the low reflective index layer. Examples of the preferable compound include “MEGAFAC F-150” (trade name, a product of Dainippon Ink and Chemicals, Incorporated) and “SH-3748” (trade name, a product of Toray Dow Corning Co. However, the invention is not limited to those.

1-10. Surfactant

In the antireflective film of the present invention, a fluorine or silicone surfactant, or both are preferably contained in a coating liquid for the formation of the hard coat layer in order to secure face uniformity such as coating unevenness, drying unevenness or dot defect. In particular, the fluorine surfactant exhibits the effect of improving face troubles such as irregular coating, irregular drying or dot defect in a small amount thereof, and therefore can preferably be used. By holding out high speed coating adaptability while increasing the face uniformity, the productivity can be increased.

The preferable examples of the fluorine surfactant includes a fluoroaliphatic group-containing copolymer (hereinafter referred to as “fluorine polymer surfactant”). An acrylic copolymer containing a repeating unit corresponding to a monomer of the following monomer (i), or a repeating unit corresponding to a monomer of the following monomer (ii), a methacrylic copolymer, and a copolymer of those and a vinyl monomer copolymerizable with those are useful as the fluorine polymer surfactant.
(i) Fluoroaliphatic Group-Containing Monomer Represented by the Following Formula (6)

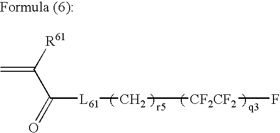

In the formula (6), R⁶¹ represents a hydrogen atom or a methyl group, L₆₁ represents an oxygen atom, a sulfur atom or N(R⁶²), and is preferably an oxygen atom. r5 is an integer of from 1 to 6, and q3 is an integer of from 2 to 4. R⁶² represents a hydrogen atom or an alkyl group having from 1 to 4 carbon atoms, specifically a methyl group, an ethyl group, a propyl group or a butyl group, and a hydrogen atom and a methyl group are preferable.
(ii) Monomer Copolymerizable with the Monomer (i), Represented by the Following Formula (7)

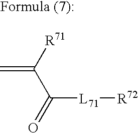

In the formula (7), R⁷¹ represents a hydrogen atom or a methyl group, L₇₁ represents an oxygen atom, a sulfur atom or N(R⁷³). R⁷³ represents a hydrogen atom or an alkyl group having from 1 to 4 carbon atoms, specifically a methyl group, an ethyl group, a propyl group or a butyl group, and a hydrogen atom and a methyl group are preferable. L₇₁ is preferably —N(H)— and N(CH₃)—.

R72 represents a linear, branched or cyclic alkyl group having from 4 to 20 carbon atoms, which may have a substituent. Examples of the substituent in the alkyl group of R⁷² include a hydroxyl group, an alkyl carbonyl group, an aryl carbonyl group, a carboxyl group, an alkyl ether group, an aryl ether group, a halogen atom (such as a fluorine atom, a chlorine atom or a bromine atom), a nitro group, a cyano group and an amino group. However, the substituent is not limited to those. Examples of the linear, branched or cyclic alkyl group having from 4 to 20 carbon atoms that are suitably used include a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group and an eicosanyl group, which may be linear or branched; a monocycloalkyl group (such as a cyclohexyl group or a cycloheptyl group); and a polycyclic alkyl group (such as a bicycloheptyl group, a bicyclodecyl group, a tricycloundecyl group, a tetracyclodedecyl group, an adamantyl group, a norbornene group or a tetracyclodecyl group).

The amount of the fluoroaliphatic group-containing monomer represented by the formula (6) used in the fluorine polymer surfactant used in the present invention is 10 mol % or more, preferably from 15 to 70 mol %, and more preferably from 20 to 60 mol %, per mole of each monomer of the fluorine polymer surfactant.

The fluorine polymer surfactant used in the present invention has a mass average molecular weight of preferably from 3,000 to 100,000, and more preferably from 5,000 to 80,000.

The fluorine polymer surfactant used in the present invention is added in an amount of from 0.001 to 5 mass %, preferably from 0.005 to 3 mass %, and more preferably from 0.01 to 1 mass %, based on the mass of the coating liquid. When the amount of the fluorine polymer surfactant added is 0.001 mass % or more, the effect is sufficiently exhibited, which is preferable, and when the amount is 5 mass % or less, the disadvantages do not occur that drying of the coating film is not sufficiently conducted, or it adversely affects performances as the coating film (such as reflectivity or mar resistance), which is preferable.

1-11. Thickener

The antireflective film of the present invention may use a thickener in order to adjust viscosity of the coating liquid for the formation of the functional layer.

The term “thickener” used here means that viscosity of a liquid increases by adding the same. The degree that viscosity of a liquid increases by the addition of a thickener is preferably from 0.05 to 50 cP, more preferably from 0.10 to 20 cP, and most preferably from 0.10 to 10 cP.

Although not limitative, examples of the thickener include poly-ε-caprolatone, poly-ε-caprolatonediol, poly-ε-caprolatonetriol, polyvinyl acetate, poly(ethylene adipate), poly(1,4-butylene adipate), poly(1,4-butylene glutarate), poly(1,4-butyrene succinate), poly(1,4-butylene terephthalate), poly(ethylene terephthalate), poly(2-methyl-1,3-propylene adipate), poly(2-methyl1,3-propylene glutarate), poly(neopentyl glycol adipate), poly(neopentyl glycol sebacate), poly(1,3-propylene adipate), poly(1,3-propylene glutarate), polyvinyl butyral, polyvinyl formal, polyvinyl acetal, polyvinyl propanal, polyvinyl hexanal, polyvinyl pyrrolidone, poly(meth)acrylic acid ester, cellulose acetate, cellulose propionate and cellulose acetate butyrate.

Other than the above, the conventional viscosity regulators or thixotropy-imparting agents, such as smectite, tetrasilicon fluoride mica, bentonite, silica, montmorillonite and sodium polyacrylate as described in JP-A-8-325491, and ethyl cellulose, polyacrylic acid and organic clay as described in JP-A-10-219136, can be used.

1-12. Coating Solvent

In the present invention, various solvents selected from the standpoints that it can dissolve or disperse each component, a uniform surface is easily obtained in a coating step or a drying step, liquid storage property can be secured, it has an appropriate vapor pressure, and the like, can be used as the solvent used in the coating liquid for forming each layer.

The solvent can be used by mixing two or more thereof. In particular, from the standpoint of drying load, a solvent comprising a solvent having a boiling point at room temperature under ordinary pressure of 100° C. or lower, as the main component, and a small amount of a solvent having a boiling point of 100° C. or higher for adjusting drying speed is preferable.

Examples of the solvent having a boiling point of 100° C. or lower include hydrocarbons such as hexane (boiling point: 68.7° C.), heptane (98.4° C.), cyclohexane (80.7° C.) and benzene (80.1° C.); halogenated hydrocarbons such as dichloromethane (39.8° C.), chloroform (61.2° C.), carbon tetrachloride (76.8° C.), 1,2-dichloroethane (83.5° C.) and trichloroethylene (87.2° C.); ethers such as diethyl ether (34.6° C.), diisopropyl ether (68.5° C.), dipropyl ether (90.5° C.) and tetrahydrofuran (66° C.); esters such as ethyl formate (54.2° C.), methyl acetate (57.8° C.), ethyl acetate (77.1° C.) and isopropyl acetate (89° C.); ketones such as acetone (56.1° C.) and 2-butanone (the same as methyl ethyl ketone, 79.6° C.); alcohols such as methanol (64.5° C.), ethanol (78.3° C.), 2-propanol (82.4° C.) and 1-propanol (97.2° C.); cyano compounds such as acetonitrile (81.6° C.) and propionitrile (97.4° C.); and carbon disulfide (46.2° C.). Of those, ketones and esters are preferable, and ketones are more preferable. Of the ketones, 2-butanone is particularly preferable.

Examples of the solvent having a boiling point of 100° C. or higher include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (the same as methyl isobutyl ketone (MIBK), 115.9° C.), 1-butanol (117.7° C.), N,N-dimethylformamide (153° C.), N,N-dimethylacetamide (166° C.) and dimethylsulfoxide (189° C.). Of those, cyclohexanone and 2-methyl-4-pentanone are preferable.

1-12. Others

Other than the above-described components, a resin, a coupling agent, a coloration inhibitor, a coloring material (a pigment or a dye), a defoaming agent, a leveling agent, a flame retardant, an ultraviolet absorber, an infrared absorber, a tackifier, a polymerization inhibitor, an antioxidant, a surface modifier and the like can be added to the antireflective film of the present invention.

1-13. Support

The support for the antireflective film of the present invention can be a transparent resin film, a transparent resin plate, a transparent resin sheet, a transparent glass and the like, and is not particularly limited. Examples of the transparent resin film that can be used include a cellulose acylate film (for example, a cellulose triacetate film (refractive index: 1.48), a cellulose diacetate film, a cellulose acetate butyrate film and a cellulose acetate propionate film), a polyethylene terephthalate film, polyether sulfone film, polyacrylic resin film, a polyurethane resin film, a polyester film, a polycarbonate film, a polysulfone film, a polyether film, a polymethyl pentene film, a polyther ketone film and a (meth)acrylonitrile film.

(Cellulose Acylate Film)

Of the supports, a cellulose acylate film having high transparency, having less optical birefringence, being easily produced, and being generally used as a protective film of a polarizing plate is preferable, and a cellulose triacetate film is particularly preferable. The transparent support has a thickness of generally from about 25 to 1,000 μm.

(Cellulose Acetate)

In the present invention, cellulose acetate having a degree of acetylation of from 59.0 to 61.5% is preferably used as the cellulose acylate film. The degree of acetylation means the amount of bonded acetic acid per mass of cellulose unit. The degree of acetylation is according to measurement and calculation in ASTM D-817-91 (test method of cellulose acetate or the like).

The cellulose acylate has an average viscometric degree of polymerization (DP) of preferably 250 or more, and more preferably 290 or more. The cellulose acylate used in the present invention is preferably that the value of Mw/Mn (Mw is a mass average molecular weight, and Mn is a number average molecular weight) by gel permeation chromatography (GPC) is close to 1.0, that is, the molecular weight distribution is narrow. The specific Mw/Mn value is preferably from 1.0 to 1.7, more preferably from 1.3 to 1.65, and most preferably from 1.4 to 1.6.

In general, hydroxyl groups at 2, 3 and 6 positions of the cellulose acylate are not evenly distributed with every ⅓ of the whole substitution degree, but have the tendency that the substitution degree of 6-position hydroxyl group becomes small. It is preferable in the present invention that the substitution degree of 6-position hydroxyl group in the cellulose acylate is large as compared with 2 and 3-positions. The 6-position hydroxyl group in the cellulose acylate is substituted with an acyl group in the proportion of preferably 32% or more, more preferably 33% or more, and most preferably 34% or more, to the whole substitution degree. Further, the substitution degree of the 6-position acyl group in the cellulose acylate is preferably 0.88 or more. The 6-position hydroxyl group may be substituted with a propionyl group, a butyroyl group, a valeroyl group, a benzoyl group, an acryloyl group or the like, which is an acyl group having 3 or more carbon atoms, other than an acetyl group. The substitution degree at each position can be measured by NMR.

In the present invention, cellulose acetates obtained by the methods as described in JP-A-11-5851, [Example] [Synthesis Example 1] at paragraphs 0043 to 0044, [Synthesis Example 2] at paragraphs 0048 to 0049, and [Synthesis Example 3] at paragraphs 0051 to 0052 can be used as the cellulose acylate.

(Polyethylene Terephthalate Film)

A polyethylene terephthalate film has excellent transparency, mechanical strength, flatness, chemical resistance and moisture resistance, and is inexpensive, and is therefore preferably used in the present invention.

The transparent plastic film is further preferably subjected to easy-adhesive treatment in order to further improve adhesion strength between the transparent plastic film and the hard coat layer formed thereof. The commercially available an optical PET film with an easy-adhesive layer includes COSMOSHINE, a product of Toyobo Co., Ltd.

2. Layer Constituting Antireflective Film

The antireflective film of the present invention is obtained by mixing a composition containing various compounds described above, and applying the composition to form various functional layers. Each functional layer constituting the antireflective film of the present invention is described below.

2-1. Hard Coat Layer

In the antireflective film of the present invention, a hard coat layer is preferably formed on one side of the transparent support to impart physical strength to the film. Preferably, the lower refractive index layer is formed on the hard coat layer, and more preferably, a medium refractive index layer and a higher refractive index layer are formed between the hard coat layer and the low refractive layer, thereby constituting the antireflective film.

The hard coat layer may be constituted of a layered product of two or more layers.

The hard coat layer has a refractive index in a range of preferably from 1.48 to 2.00, more preferably from 1.52 to 1.90, and most preferably from 1.55 to 1.80, from the standpoint of optical design to obtain an antireflective film. In a preferable embodiment of the present invention, at least one lower refractive index layer is present on the hard coat layer. Therefore, when the refractive index of the hard coat layer is the lower limit or more, the antireflection property is good, and when it is the upper limit or less, the tendency that feeling of color of a reflected light is too strong does not generate.

The hard coat layer has a thickness of generally from about 0.5 to 50 μm, preferably from 1 to 20 μm, more preferably from 2 to 10 μm, and most preferably from 3 to 7 μm, from the standpoint of imparting sufficient durability and impact resistance to the film.

The hard coat layer has hardness of preferably H or more, more preferably 2H or more, and most preferably 3H or more, in terms of a pencil hardness test.

Further, in Taber test according to JIS K-5400, the smaller abrasion amount of a test piece before and after the test is preferable.

The hard coat layer is preferably formed by crosslinking reaction of an ionizing radiation curable compound, or polymerization reaction. For example, the hard coat layer can be formed by applying a coating liquid containing an ionizing radiation curable polyfunctional monomer or polyfunctional oligomer to the transparent support, and subjecting the polyfunctional monomer or polyfunctional oligomer to crosslinking reaction or polymerization reaction.

The functional group of the ionizing radiation curable polyfunctional monomer or polyfunctional oligomer is preferably a light, electron ray or radiation polymerizable functional group, and of those, a photopolymerizable functional group is preferable. Examples of the photopolymerizable functional group include unsaturated polymerizable groups such as a (meth)acryloyl group, a vinyl group, a styryl group and an allyl group. Of those, a (meth)acryloyl group is preferable.

The hard coat layer may contain matte particles having an average particle diameter of from 1.0 to 10.0 μm, and preferably from 1.5 to 7.0 μm, such as particles of an inorganic compound or resin particles, for the purpose of imparting internal scattering properties.

A higher refractive index monomer, inorganic particles, or mixtures thereof can be added to the binder of the hard coat layer for the purpose of controlling the refractive index of the hard coat layer. The inorganic particles have the effect to suppress curing shrinkage due to crosslinking reaction, in addition to the effect of controlling the refractive index. In the present invention, a binder is defined to include a polymer formed by polymerizing the functional monomer and/or higher refractive index monomer, and the inorganic particles dispersed therein.

Haze of the hard coat layer varies depending on the function to be imparted to the antireflective film.

When the antireflective film of the present invention is used in an image display, in the case of maintaining its image sharpness, suppressing surface reflectivity and not imparting a light scattering function to the inside and surface of the hard coat layer, the smaller haze value is preferable, and specifically, the haze value is preferably 10% or lower, more preferably 5% or lower, and most preferably 2% or lower.

On the other hand, in the case of imparting an antiglare function due to surface scatter of the hard coat layer, in addition to the function of suppressing the surface reflectivity, the haze due to the surface scatter (hereinafter referred to as “surface haze”) is preferably from 5 to less than 15%, more preferably from 7 to less than 15%, and most preferably from 7 to less than 10%. When the haze value is within the above range, good antiglare properties and antireflection properties are obtained without involving deterioration of a transfer image, thereby achieving mar resistance in combination. The value of surface haze can be obtained by measuring the total haze value of a film, measuring an internal haze in a state of removing the surface haze, and obtaining a difference between the total haze and the internal haze.

In the case of preventing patterns of a liquid crystal panel due to the internal scatter of the hard coat layer, irregular color, irregular brightness, glare and the like from being viewed, and imparting the function to expand a view angle by scatter, the internal surface haze (haze value obtained by adhering a cellophane tape to the surface of an antireflective film, and measuring in the state of removing the surface haze) is preferably from 10 to 90%, more preferably from 15 to 80%, and most preferably from 20 to 70%.

The antireflective film of the present invention can freely set up the surface haze and the internal haze according to the purpose.

Regarding the surface unevenness shape of the hard coat layer, when the antireflective film obtained is used in an image display, for example, a center line average roughness (Ra) in properties showing surface roughness is preferably 0.10 μm or less, more preferably 0.09 μm or less, and most preferably 0.08 μm or less, in order to obtain a clear surface for the purpose of maintaining definition of its image.

In the antireflective film of the present invention, surface unevenness of the film is predominantly influenced by the surface unevenness of the hard coat layer, and the center line average roughness on the antireflective film surface can be in the above range by controlling the center line average roughness of the hard coat layer.

Further, for the purpose of maintaining definition of an image, it is preferable to adjust the definition of a transmitted image, in addition to adjusting unevenness shape on the surface of the hard coat layer. The definition of a transmitted image in a clear antireflective film is preferably 60% or more. The definition of a transmitted image is generally a measure showing blurring condition of an image reflected by transmitting a film, and the larger the value, the image reflected through a film is clear and good. The definition of a transmitted image is preferably 70% or more, and more preferably 80% or more.

2-2. Antiglare Layer

The antiglare layer is formed for the purpose of imparting an antiglare properties due to the surface scattering, and further preferably hard coat properties for improving mar resistance of the antireflective layer obtained, to the film.

As a method of forming the antiglare layer, a method of forming by laminating a matte molded film having fine unevenness on the surface thereof as described in JP-A-6-16851; a method of forming by curing shrinkage of an ionizing radiation curable resin by difference of an ionizing radiation irradiation dose as described in JP-A-2000-206317; a method of forming unevenness on the surface of a coating film by solidifying light-transmitting fine particles and a light-transmitting resin while gelling by decreasing a mass ratio of a good solvent to the light-transmitting resin by drying as described in JP-A-2000-338310; a method of imparting surface unevenness by an external pressure as described in JP-A-2000-275404; and the like are known, and those conventional methods can be utilized in the present invention.

The antiglare layer that can be used in the present invention preferably contains a binder that can impart hard coat properties, light-transmitting particles for imparting antiglare properties (called matte particles) and a solvent as essential components, and is preferably that the surface unevenness is formed of projections the light-transmitting particles themselves or projections formed of aggregates of plural particles.

The antiglare layer formed by dispersion of the matte particles comprises the binder and light-transmitting particles dispersed therein. The antiglare layer having antiglare properties preferably has antiglare properties and hard coat properties in combination.

The antiglare layer has a thickness in a range of preferably from 1 to 10 μm, and more preferably from 1.2 to 8 μm. When the thickness is the lower limit or more, the hard coat properties do not lack, and when the thickness is the upper limit or less, the problems that processability deteriorates due to generation of curl or decrease of brittleness. Thus, the above thickness range is preferable.

On the other hand, the antiglare layer has the center line average roughness (Ra) in a range of preferably from 0.10 to 0.40 μm. When Ra is 0.40 μm or less, the problems such as surface whitening when glare or outside light reflects do not occur. The value of the definition of a transmitted image is preferably 5 to 60%.

The antiglare layer has a hardness of H or more, preferably 2H or more, and most preferably 3H or more, in terms of a pencil hardness test.

2-3. Higher Refractive Index Layer and Medium Refractive Index Layer

As described before, the higher refractive index layer and the lower refractive index layer are provided in the antireflective film of the present invention, thereby increasing reflection preventing property.

In the present invention, the higher refractive index layer and the medium refractive index layer sometimes collectively mean a “higher refractive index layer”. Further, in the present invention, the terms “high”, “medium” and “low” mean a magnitude correlation of the relative refractive indexes in mutual layers. In the relationship with the transparent support, the refractive index is preferably satisfied with the relationships of transparent support>lower refractive index layer and higher refractive index layer>transparent support.

In the present invention, the higher refractive index layer, the medium refractive index layer and the lower refractive index layer sometimes collectively mean an “antireflective layer”.

To prepare the antireflective film by providing the lower refractive index layer on the higher refractive index layer, the refractive index of the higher refractive index layer is preferably from 1.55 to 2.40, more preferably from 1.60 to 2.20, and most preferably from 1.80 to 2.00.

When the antireflective film is prepared by forming the medium refractive index layer, the higher refractive index layer and the lower refractive index layer in the order from the support, the refractive index of the higher refractive index layer is preferably from 1.65 to 2.40, more preferably from 1.70 to 2.20. The refractive index of the medium refractive index layer is adjusted so as to be a value between the refractive index of the lower refractive index layer and the refractive index of the higher refractive index layer. The refractive index of the medium refractive index layer is preferably from 1.55 to 1.80.

The inorganic particles comprising TiO₂ as the main component used in the higher refractive index layer and the medium refractive index layer are used to form the higher refractive index layer and the medium refractive index layer in the state of the dispersed material.

The inorganic particles are dispersed in a dispersing medium in the presence of a dispersing agent.

The higher refractive index layer and the medium refractive index layer used in the present invention are preferably formed by preparing a coating liquid for the formation of the higher refractive index layer and the medium refractive index layer by preferably adding a binder precursor necessary for forming a matrix (for example, the ionizing radiation curable polyfunctional monomer or polyfunctional oligomer described before), the photopolymerization initiator and the like to a dispersing liquid comprising a dispersing medium having the inorganic particles dispersed therein, applying the coating liquid for the formation of the higher refractive index layer and the medium refractive index layer to the transparent support, and curing the coating film by crosslinking reaction or polymerization reaction of the ionizing radiation curable compound (for example, a polyfunctional monomer or a polyfunctional oligomer).

Further, the binder of the higher refractive index layer and the medium refractive index layer is preferably subjected to crosslinking reaction or polymerization reaction with the dispersing agent simultaneously with or after coating the layer.

The binder of the higher refractive index layer and the medium refractive index layer thus prepared is in a form, for example, that the above preferable dispersing agent and the ionizing radiation curable polyfunctional monomer or polyfunctional oligomer undergo crosslinking or polymerization reaction, and anionic groups of the dispersing agent are taken in the binder. Further, the binder of the higher refractive index layer and the medium refractive index layer has the function that the anionic group maintains a dispersed state of the inorganic particles, and the crosslinking or polymerization structure imparts a film formability to the binder, thereby improving physical strength, chemical resistance and weather resistance of the higher refractive index layer and the medium refractive index layer, containing the inorganic particles.

The binder of the higher refractive index layer is added in an amount of from 5 to 80 mass % based on the mass of the solid content in the coating liquid for the layer.

The content of the inorganic particles in the higher refractive index layer is preferably from 10 to 90 mass %, more preferably from 15 to 80 mass %, and most preferably from 15 to 75 mass %, based on the mass of the higher refractive index layer. Two kinds or more of the inorganic particles may be used in combination in the higher refractive index layer.

Binders obtained by crosslinking or polymerization reaction of an ionizing radiation curable compound containing an aromatic ring, an ionizing radiation curable compound containing a halogen atom other than fluorine (for example, Br, I and Cl), an ionizing radiation curable compound containing an atom such as S, N or P, and the like can also preferably be used in the higher refractive index layer.

The thickness of the higher refractive index can appropriately be designed according to the use purpose. When the higher refractive index layer is used as an optical interference layer described after, the thickness is preferably from 30 to 200 nm, more preferably from 50 to 170 nm, and most preferably from 60 to 150 nm.

Where the higher refractive index layer does not contain particles imparting an antiglare function, the haze of the higher refractive index layer is preferable as low as possible. The haze is preferably 5% or less, more preferably 3% or less, and most preferably 1% or less.

The higher refractive index layer is preferably formed on the transparent support directly or through other layer.

2-4. Lower Refractive Index Layer

The lower refractive index layer can be used to reduce the reflectivity of the antireflective film of the present invention.

The lower refractive index layer has a refractive index of preferably from 1.20 to 1.46, more preferably from 1.25 to 1.46, and most preferably from 1.30 to 1.46.

The lower refractive index layer has a thickness of preferably from 50 to 200 nm, and more preferably from 70 to 100 nm. The lower refractive index layer has a haze of preferably 3% or less, more preferably 2% or less, and most preferably 1% or less. The lower refractive index layer has a hardness of preferably H or more, more preferably 2H or more, and most preferably 3H or more, in terms of a pencil hardness test under a load of 500 g.

To improve an antifouling performance of the antireflective, a contact angle to water on the surface thereof is preferably 90° or more, more preferably 95° or more, and most preferably 100° or more.

The curable composition particularly preferably used for the formation of the lower refractive index layer contains (1) the inorganic particles and (2) a salt comprising: an organic base, the conjugate acid of the organic base having pKa of from 5.0 to 11.0; and an acid, and if necessary, further contains the fluorine-containing polymer, a crosslinking agent, and suitably an organosilane compound.

The lower refractive index layer can use the binder as described in the hard coat layer. Further, the fluorine-containing polymer having a lower refractive index can preferably be used as the binder itself. Additionally, a fluorine-containing sol gel material can be used together. The binder can use the crosslinkable compound preferably used in the present invention, and can use a compound capable of crosslinking by an ionizing radiation in combination. A material having a dynamic friction coefficient on the lower refractive index layer surface of from 0.03 to 0.30 and a contact angle to water of from 85 to 120° is preferable.

2-5. Antistatic Layer and Conductive Layer

It is preferable in the present invention to provide the antistatic layer in the point of static prevention on the antireflective layer surface. Examples of the method of forming the antistatic layer include the conventional methods such as a method of applying a conductive coating liquid containing the conductive fine particles and the reactive cured resin, and a method of forming a conductive thin film by depositing or sputtering a metal or a metal oxide, that forms a transparent film. The conductive layer can be formed on the support directly or through a primer layer that strengthens adhesion to the support. The antistatic layer can be used as a part of the antireflective film. In this case, when used in the layer near the outermost layer, sufficient antistatic properties can be obtained even though the film thickness is small.

The antistatic layer has a thickness of preferably from 0.01 to 10 μm, more preferably from 0.03 to 7 μm, and most preferably from 0.05 to 5 μm. The antistatic layer has a surface resistance of preferably from 10⁵ to 10¹² Ω/□, more preferably from 10⁵ to 10⁹ Ω/□, and most preferably from 10⁵ to 10⁸ Ω/□. The surface resistance of the antistatic layer can be measured by a four point indenter method

It is preferable that the antistatic layer is substantially transparent. Specifically, the antistatic layer has a haze of preferably 10% or less, more preferably 5% or less, further more preferably 3% or less, and most preferably 1% or less. Further, the antistatic layer has a transmission of light having a wavelength of 550 nm of preferably 50% or more, more preferably 60% or more, further more preferably 65% or more, and most preferably 70% or more.

The antistatic layer in the present invention preferably has excellent hardness. Specific hardness of the antistatic layer is preferably H or more, more preferably 2H or more, further more preferably 3H or more, and most preferably 4H or more, in terms of a pencil hardness under a load of 1 kg.

2-6. Antifouling Layer

The antifouling layer can be provided on the outermost surface of the antireflective film of the present invention. The antifouling layer decreases surface energy of the antireflective layer, and makes difficult to adhere hydrophilic or lipophilic stains.

The antifouling layer can be formed using a fluorine-containing polymer or antifouling agent.

The antifouling layer has a thickness of preferably from 2 to 100 nm, and more preferably from 5 to 30 nm.

2-7. Irregular Interference (Irregular Rainbow)-Preventive Layer

Where there is the substantial refractive index difference (refractive index difference is 0.03 or more) between the transparent support and the hard coat layer, or between the transparent support and the antiglare layer, in the antireflective film of the present invention, reflected light generates at the transparent support/hard coat layer interface, or the transparent support/antiglare layer interface. This reflected light interferes with the reflected light on the antireflective layer surface, and may generate irregular interference due to a delicate irregular thickness of the hard coat layer (or the antiglare layer). To prevent such an irregular interference, for example, an irregular interference-preventive layer having a medium refractive index nₚ and that its thickness dₚ is satisfied with the following equation (2) can be provided between the transparent support and the hard coat layer (or the antiglare layer).
dₚ=(2N−1)×λ/(4nₚ) Equation 2:
wherein λ is a wavelength of a visible light, and is a value in a range of from 450 to 650 nm, and N is a natural number.

Where the antireflective film is adhered to, for example, an image display, there is the case that a pressure-sensitive adhesive layer (or an adhesive layer) is stacked on the side of the transparent support on which the antireflective layer is not stacked. In this embodiment, where there is the substantial refractive index difference (0.03 or more) between the transparent support and the pressure-sensitive adhesive layer (or the adhesive layer), reflected light of transparent support/pressure-sensitive adhesive layer (or adhesive layer) generates, and this reflected light interferes with, for example, reflected light on the antireflective layer surface, the irregular interference due to irregular thickness of the support or the hard coat layer may generate similar to the above. The same irregular interference-preventive layer can be provided on the side of the transparent support, on which the antireflective layer is not stacked, for the purpose of preventing such an irregular interference.

JP-A-2004-345333 discloses in details such an irregular interference-preventive layer, which can be used in the present invention.

2-8. Easy-Adhesive Layer

An easy-adhesive layer can be formed on the antireflective film of the present invention. The easy-adhesive layer means a layer that imparts a function for facilitating adhesion between a protective film for a polarizing plate and its adjacent layer, or between the hard coat layer and the support, when the antireflective film of the present invention is used as the protective film.

An easy-adhesion treatment includes a treatment of providing the easy-adhesive layer on a transparent plastic film with an easy adhesive comprising a polyester, a polyurethane, a polyethyleneimine, a silane coupling agent or the like.

The example of the easy adhesive layer preferably used in the present invention includes a layer containing a polymer compound having —COOM (M represents a hydrogen atom or a cation). The preferable embodiment is that a layer containing a polymer compound having —COOM group is provided on the support side of the antireflective film, and adjacent to the layer, a layer containing a hydrophilic polymer compound as a main component is provided at a polarizer side.

Examples of the polymer compound having —COOM include a styrene-maleic acid copolymer having —COOM group, a vinyl acetate-maleic acid copolymer having —COOM group and vinyl acetate-maleic anhydride copolymer having —COOM group. Of those, a vinyl acetate-maleic acid copolymer having —COOM group is particularly preferably used. The polymer compound can be used alone or as mixtures of two or more thereof.

The polymer compound has a mass average molecular weight of preferably from about 500 to 500,000. Particularly preferable examples of the polymer compound having —COOM group are compounds described in, for example, JP-A-6-094616 and JP-A-7-333436.

Examples of the preferable hydrophilic polymer compound include hydrophilic cellulose derivatives (for example, methyl cellulose, carboxylmethyl cellulose and hydroxycellulose), polyvinyl alcohol derivatives (for example, polyvinyl alcohol, vinyl acetate-vinyl alcohol copolymer, polyvinyl acetal, polyvinyl formal and polyvinyl benzal), natural polymer compounds (for example, gelatin, casein and gum arabic), hydrophilic polyester derivatives (for example, patially sulfonated polyethylene terephthalate), and hydrophilic polyvinyl derivatives (for example, poly-N-vinylpyrrolidone, polyacrylamide, polyvinyl indazole and polyvinyl pyrazole). Those compounds are used alone or as mixtures of two or more thereof.

The easy adhesive layer has a thickness of preferably from 0.05 to 1.0 μm. When the thickness is 0.05 μm or more, sufficient adhesion is obtained. Where the thickness is larger than 1.0 μm, the adhesion effect is not improved any more. Therefore, the easy adhesive layer preferably has the thickness in the above range.

2-9. Anti-Curling Layer

The antireflective film of the present invention can be subjected to an anti-curling processing. The anti-curling processing is to impart the function that the anti-curling processing-applied side curls up inside. Where the above described various functional layers are formed on only one side of a transparent resin film as in an antireflective film, there is the tendency that the side having the various functional layer formed thereon curls up inside. The anti-curling layer acts to prevent the occurrence of such a curling.

The anti-curling layer can be provided on the back surface of the antireflective layer, that is, the surface opposite the antiglare layer or the antireflective layer of the support. However, there is the case in the present invention that the easy adhesive layer is formed on the back surface of the antireflective layer, and depending on the situation of curling generation, the present invention includes the embodiment that the anti-curling processing is applied to the reverse side, that is, the side having the antiglare layer of the antireflective layer.

Specific examples of the anti-curling processing include a solvent coating, and an application of a solvent and a transparent resin such as cellulose triacetate, cellulose diacetate or cellulose acetate propionate.

The solvent coating method is specifically conducted by applying a composition containing a solvent that dissolves or swells a cellulose acylate film used as the support of the antireflective film. Therefore, the coating liquid for the layer having the function of preventing curling preferably contains a ketone or ester type organic solvent.

Examples of the preferable ketone type organic solvent include acetone, methyl ethyl ketone, methyl isobutyl ketone, cyclohexanone, acetylacetone, diacetone alcohol, isophorone, ethyl-n-butyl ketone, diisopropyl ketone, diethyl ketone, di-n-propyl ketone, methyl cyclohexanone, methyl-n-butyl ketone, methyl-n-propyl ketone, methyl-n-hexyl ketone and methyl-n-heptyl ketone. Examples of the preferable ester type organic solvent include methyl acetate, ethyl acetate, butyl acetate, methyl lactate and ethyl lactate.

However, there is the case that the solvent used contains a solvent that does not dissolve the film, in addition to the solvent that dissolves and/or swells a cellulose acylate film. Therefore, the solvent coating method is conducted using a composition comprising a mixture of those solvents in an appropriate mixing ratio depending on the degree of curling of the transparent resin film or the kind of the resin used, in an appropriate application amount. Other than the anti-curling processing, a transparent hard processing or an antistatic processing may be applied, thereby the anti-curling function is exhibited.

2-10. Water Absorption Layer

A layer containing a water absorbent can be provided on the antireflective film of the present invention. The water absorbent can be selected from compounds having a water absorption function, centering on alkaline earth metals. Examples of the compound include BaO, SrO, CaO and MgO. The compound can also be selected from metal elements such as Ti, Mg, Ba and Ca. Those absorbent particles have a particle diameter of preferably 100 nm or less, and more preferably 50 nm or less.

The layer containing those water absorbents may be prepared using, for example, a vacuum deposition method similar to the above-described antistatic layer, or may be prepared using nano particles obtained by various methods. The layer has a thickness of preferably from 1 to 100 nm, and more preferably from 1 to 10 nm.

The layer containing the water absorbent may be provided between the support and the layered product (various functional layers including the antireflective layer), on the outermost layer of the layered product, or in the layered product, or may be added to the organic layer or the antistatic layer of the layered product. When added to the antistatic layer, a co-deposition method is preferably used.

2-11. Primer Layer and Inorganic Thin Film Layer

In the antireflective film of the present invention, the conventional primer layer or inorganic thin film layer can be provided between the support and the layered product, thereby increasing a gas barrier property.

For example, an acrylic resin, an epoxy resin, a urethane resin or a silicone resin can be used as the primer layer. It is preferable in the present invention to provide an organic/inorganic hybrid layer comprising a combination of a layer of those resins and an inorganic thin film layer, as the primer layer. The inorganic thin film layer is preferably an inorganic deposition layer or a dense inorganic coating thin film by a sol-gel method. The inorganic deposition layer is preferably a deposition layer of silica, zirconia, alumina or the like. The inorganic deposition layer can be formed by vacuum deposition or sputtering.

3. Layer Structure of Antireflective Film

The antireflective film of the present invention can use the above-described layers, and the conventional layer structure. The representative examples of the layer structure are shown below. The specific salt used in the present invention as described above, the fluorine polymer containing at least one fluorine-containing vinyl monomer polymeric unit and at least one hydroxyl group-containing monomer polymeric unit, and the crosslinking agent are preferably contained in any of the above structural layers, but are most preferably contained in the lower refractive index layer.

b. Support/hard coat layer/lower refractive index layer (FIG. 1)

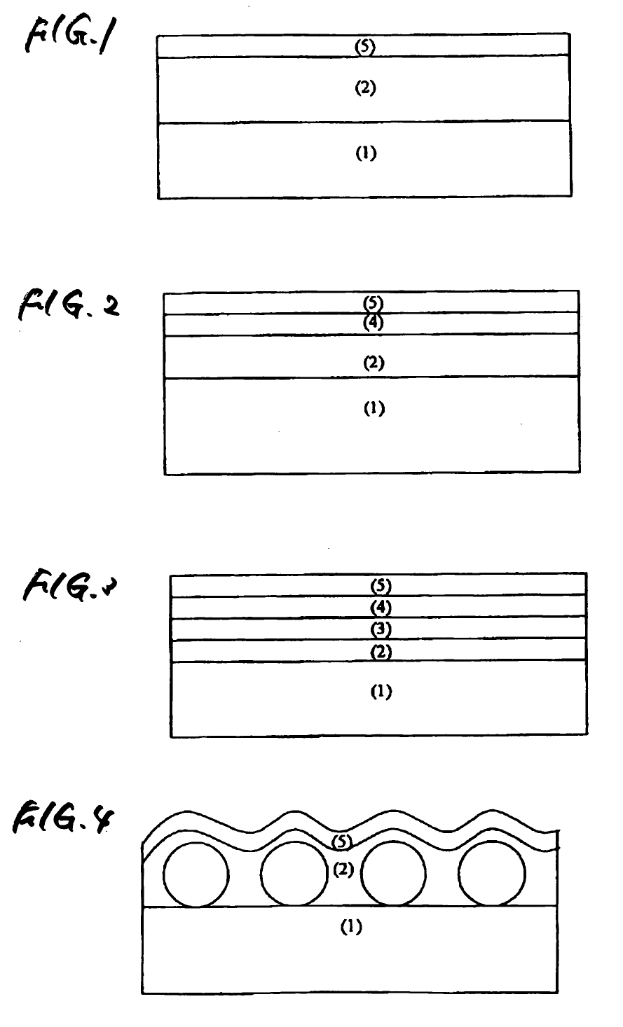

c. Support/hard coat layer/higher refractive index layer/lower refractive index layer (FIG. 2)

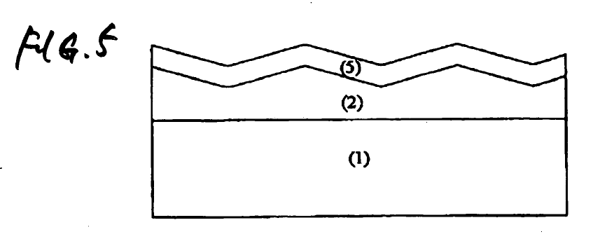

d. Support/hard coat layer/medium refractive index layer/higher refractive index layer/lower refractive index layer (FIG. 3)

When the hard coat layer is applied to the support, and the lower refractive index layer is applied thereon as in b above (FIG. 1), such a layered product can suitably be used as the antireflective film. The lower refractive index layer is formed on the hard coat layer in a thickness about ¼ wavelength of light, the lower refractive index layer can reduce surface reflection by the principle of thin film interference.

Even when the hard coat layer is applied to the support, and the higher refractive index layer and the lower refractive index layer are stacked thereon in this order as in c above (FIG. 2), the resulting layered product can suitably be used as the antireflective film. Further, when the layer structure comprises the support, the hard coat layer, the medium refractive index layer, the higher refractive index layer and the lower refractive index layer in this order as in d above (FIG. 3), the reflectivity can be made 1% or less.

In the above layer structures b to d of the antireflective film, the hard coat layer (2) can be the antiglare layer having antiglare properties. The antiglare properties may be given by dispersion of the matte particles as shown in FIG. 4 or by a surface shaping by a method such as embossing as shown in FIG. 5. The antiglare layer formed by the dispersion of the matte particles comprises the binder and light-transmitting particles dispersed therein. The antiglare layer preferably has the antiglare properties and the hard coat properties in combination, and may be constituted of plural layers such as 2 to 4 layers.

A further layer may be formed between the support and the layer at the surface side thereof, or on the outermost layer. Examples of the further layer include an irregular interference (irregular rainbow) preventive layer, an antistatic layer (in the case of requirement of decreasing a surface resistance value from the display side, or in the case of causing the problems of dusts adhered on a surface or the like), another hard coat layer (in the case that hardness lacks in only one hard coat layer or one antiglare layer), a gas barrier layer, a water absorption layer (moisture-proof layer), an adhesion improving layer and an antifouling layer (antipollution layer).

The refractive index of each layer constituting the antiglare antireflective film having the antireflective layer in the present invention is preferably satisfied with the following relationship.

Refractive index of hard coat layer>refractive index of transparent support>refractive index of lower refractive index layer

4. Production Method of Antireflective Film

The antireflective film of the present invention can be formed by the following method, but the invention is not limited to this method.

4-1. Preparation of Coating Liquid

(Preparation of Coating Liquid for Forming Each Layer)

A coating liquid containing the components for forming each layer is prepared. In this case, increase of water content in the coating liquid can be suppressed by suppressing the evaporation amount of a solvent to the minimum. The water content in the coating liquid is preferably 5 mass % or less, and more preferably 2 mass % or less. The volatilization amount of a solvent can be suppressed by improving sealing properties of a tank during stirring after introducing each material into the tank, minimizing an air contact area of the coating liquid at a liquid transfer operation, or the like. Further, during coating, or before or after coating, means for reducing the water content in the coating liquid may be provided.

(Properties of Coating Liquid)

The coating method in the present invention is greatly influenced by the coatable upper speed limit depending on liquid properties. Therefore, it is necessary to control liquid properties, particularly viscosity and surface tension, in the moment of coating.

The coating liquid has a viscosity of preferably 2.0 mPa·sec or less, more preferably 1.5 mPa·sec or less, and most preferably 1.0 mPa·sec or less. The viscosity varies by shearing speed depending on the coating liquid. Therefore, the above values show the viscosity at the shearing speed at the moment of coating. When a thixotropic agent is added to the coating liquid, the viscosity is low when coating under high shearing, and the viscosity is high at drying, in which the coating liquid does not almost receive the shearing, thereby making difficult to generate unevenness at drying. This is preferable.

The amount of the coating liquid applied to the transparent support, although not liquid properties, also affect the coatable upper speed limit. The amount of the coating liquid applied to the transparent support is preferably in a range of from 2.0 to 5.0 cc/m². When increasing the amount of the coating liquid applied to the transparent support, the coatable upper speed limit increases, which is preferable. However, the amount of the coating liquid applied to the transparent support is increased too much, load applied to drying increases. Therefore, it is preferable to determine the optimum amount of the coating liquid applied to the transparent support depending on the liquid formulation and step conditions.

The coating liquid has a surface tension in a range of preferably from 15 to 36 mN/m. Decreasing the surface tension by, for example, adding a leveling agent is preferable to suppress unevenness at drying. On the other hand, where the surface tension is too low, the coatable upper speed limit lowers. Therefore, the surface tension is in a range of more preferably from 17 to 32 mN/m, and most preferably from 19 to 26 mN/m.

(Filtration)

The coating liquid used for coating is preferably filtered before coating. A filter for filtration is preferably a filter having a pore diameter as small as possible in a range that the components in the coating liquid are not removed. For the filtration, a filter having an absolute filtration precision of from 0.1 to 10 μm is used, and a filter having an absolute filtration precision of from 0.1 to 5 μm is preferably used. The filter has a thickness of preferably from 0.1 to 10 mm, and more preferably from 0.2 to 2 mm. In this case, the filtration is preferably performed under a filtration pressure of 1.5 MPa or less, preferably 1.0 MPa or less, and more preferably 0.2 MPa or less.

The filtration filter member is not particularly limited so long as it does not affect the coating liquid. Specifically, the member is the same filter member as the member for wet dispersion of the inorganic compound as described before.

The coating liquid filtered is preferably subjected to ultrasonic dispersion just before coating to assist defoaming and a dispersed state of the dispersed material.

4-2. Treatment Before Coating

The support used in the present invention is preferably subjected to surface treatment before coating. Examples of the surface treatment include a corona discharge treatment, a glow discharge treatment, a flame treatment, an acid treatment, an alkali treatment and an ultraviolet radiation treatment. Further, it is preferably utilized to provide an undercoat layer as described in JP-A-7-333433.

A dust removal method is used in a dust removal step as a pre-step of coating. Examples of the dust removal method include dry dust removal methods such as a method of pressing a non-woven fabric, a braid or the like to a film surface as described in JP-A-59-150571; a method of separating an adherent from a film surface by blowing air having high cleanliness to the film surface, and sucking with the adjacent suction port as described in JP-A-10-309553; and a method of blowing an ultrasonic oscillating compressed air at high speed to peel an adherent (for example “New Ultracleaner”, a product of Shinko-Sha) as described in JP-A-7-333613.

Further, the following wet dust removal methods can also be used: a method of introducing a film in a cleaning bath and separating an adherent by ultrasonic oscillator; a method of supplying a washing liquid to a film, blowing air at high speed, and sucking as described in JP-B-49-13020; and a method of wetting a web with water, continuously rubbing with a roll, and jetting a liquid to a rubbed face to rinse. Of those dust removal methods, an ultrasonic dust removal method or a wet dust removal method is particularly preferable from the point of dust removal effect.

Before conducting the dust removal step, it is particularly preferable to remove static electricity on the film support in the point of improving dust removal efficiency and suppressing adhesion of dust. The electricity removal method can use a corona discharge type ionizer, a light (such as soft X ray) irradiation type ionizer, and the like. Charged electrostatic potential of the film support before and after dust removal and coating is 1,000 V or less, preferably 300 V or less, and more preferably 100 V or less.

It is preferable in those treatments that temperature of the cellulose acylate film is Tg or lower, specifically 150° C. or lower, form the standpoint of holding flatness of the film.

When the cellulose acylate film is adhered to the polarizer as the case that the antireflective film of the present invention is used as a protective film, it is particularly preferable to conduct an acid treatment or an alkali treatment, that is, a saponification treatment to the cellulose acylate, from the standpoint of adhesion to the polarizer.

From the standpoint of adhesion and the like, surface energy of the cellulose acylate film is preferably 55 mN/m or more, and more preferably from 60 to 75 mN/m. The surface energy can be adjusted by the above surface treatment.

4-3. Coating

Each layer of the antireflective film of the present invention can be formed by the following coating method, but the invention is not limited to this method.

The coating method that can be used in the present invention is the conventional methods such as dip coating, air knife coating, curtain coating, roller coating, wire bar coating, gravure coating and extrusion coating (die coating) (see U.S. Pat. No. 2,681,294), and microgravure coating. Of those, microgravure coating and die coating are preferable.

The microgravure coating used in the present invention is a coating method characterized in that a gravure roll having a diameter of from about 10 to 100 mm, and having gravure patterns stamped around the entire circumference thereof is reversely rotated to the carrier direction of the support under the support, and simultaneously, excessive coating liquid is scraped off from the surface of the gravure roll by a doctor blade, and the quantitative coating liquid is transferred to the lower surface of the support at a position that the upper surface of the support is in a free state, and then coated. The transparent support in a rolled state is continuously unwound, and at least one layer in lower refractive index layers containing at least one of the hard coat layer and the fluorine-containing olefin polymer is applied to one side of the unwound support by microgravure coating.

The coating conditions by the microgravure coating are that the line number of gravure patterns stamped on the gravure roll is preferably from 50 to 800/inch, and more preferably from 100 to 300/inch. The depth of the gravure pattern is preferably from 1 to 600 μm, and more preferably from 5 to 200 μm. The number of revolution of the gravure roll is preferably from 3 to 800 rpm, and more preferably from 5 to 200 rpm. The carrier speed of the support is preferably from 0.5 to 100 m/min, and more preferably from 1 to 50 m/min.

To supply the film of the present invention with high productivity, an extrusion method (die coating) is preferably used. In particular, a die coater that can preferably be used in a region of a small wet coating amount (20 cc/m² or less) as in the hard coat layer or the antireflective layer is described in JP-A-2006-122889.

4-4. Drying

After applying the coating liquid to the support directly or through other layer, the antireflective film of the present invention is preferably conveyed to a heated zone with the web to dry the solvent. The method of drying the solvent can utilize various findings. Examples of the specific finding include the descriptions of JP-A-2001-286817, JP-A-2001-314798, JP-A-2003-126768, JP-A-2003-315505 and JP-A-2004-34002.

Temperature in the drying zone is preferably from 25 to 140° C. Preferably, the early stage of the zone is relatively low temperature, and the late stage thereof is relatively high temperature. However, the temperature is preferably a temperature lower than the temperature that initiates volatilization of components other than the solvent, contained in the coating liquid of each layer. For example, of commercially available photoradical initiators used together with an ultraviolet curable resin, some initiators volatilize its several ten mass % within several minutes in hot air of 120° C., and monofunctional or bifunctional acrylate monomers may proceed volatilization in hot air of 100° C. In such a case, the temperature is preferably lower than the temperature that initiates volatilization of components other than the solvent, contained in the coating liquid of each layer as described above.

Drying air after applying the coating liquid of each layer to the support is preferably that wind speed is in a range of from 0.1 to 2 m/sec when the solid content concentration of the coating liquid is from 1 to 50 mass %, and this is preferable to prevent irregular drying.

When temperature difference between the traveling roll contacting the surface opposite the coated surface of the support and the support in the drying zone is from 0 to 20° C. after applying the coating liquid of each layer to the support, irregular drying due to irregular heat conduction on the traveling roll can preferably be prevented.

4-5. Curing

The antireflective film of the present invention is, after drying the solvent, passed through a zone that cures each coating film by an ionizing radiation and/or heat with the web, thereby curing the coating film.

Ionizing radiation species in the present invention are not particularly limited, and ultraviolet rays, electron beams, near ultraviolet rays, visible lights, near infrared rays, infrared rays, X rays and the like can appropriately be selected according to the kind of the curable composition for forming the coating film. Ultraviolet rays and electron beams are preferable, and ultraviolet rays are more preferable from the points that its handling is easy and high energy is easily obtained.

Light source of ultraviolet rays that polymerize an ultraviolet reactive compound can use any light source so long as it generates ultraviolet rays. Examples of the light source that can be used include a low pressure mercury lamp, a medium pressure mercury lamp, a high pressure mercury lamp, an ultrahigh pressure mercury lamp, a carbon arc lamp, a metal halide lamp and a xenon lamp. ArF excimer laser, KrF excimer laser, excimer lamp and synchrotron radiation light can also be used. Of those, an ultrahigh pressure mercury lamp, a high pressure mercury lamp, a low pressure mercury lamp, a carbon arc lamp, a xenon lamp and a metal halide lamp are preferably used.

Electron beams can also similarly be used. Examples of the electron beams include electron beams having energy of from 50 to 1,000 keV, and preferably from 100 to 300 keV, released from various electron accelerators such as Cockroft-Walton type, Van de graph type, Van der Graaf type, resonance transformer type, insulating core transformer, linear type, dynamitron type and high frequency type.

Irradiation conditions vary depending on the respective lamp, but an irradiating light dose is preferably 10 mJ/cm² or more, more preferably from 50 to 10,000 mJ/cm², and most preferably from 50 to 2,000 mJ/cm². In this case, irradiation dose distribution is a distribution of preferably from 50 to 100%, and more preferably from 80 to 100%, including both edges, to the central maximum irradiation dose.

It is preferable in the present invention to cure by the step that at least one layer stacked on the support is irradiated with ionizing radiation, and the ionizing radiation is irradiated in an atmosphere of an oxygen concentration of 10 vol % or less in the state of heating a film surface to a temperature of 60° C. or higher within 0.5 second or more after initiation of the ionizing radiation irradiation. Further, it is preferable to be heated in an atmosphere of an oxygen concentration of 3 vol % or less simultaneously and/or continuously irradiating the ionizing radiation. It is particularly preferable that the outermost layer which is the lower refractive index having a small thickness is cured by this method. The curing reaction is accelerated by heat, thereby forming a coating film having excellent physical strength and chemical resistance.

Irradiation time of the ionizing radiation is preferably from 0.7 to 60 seconds, and more preferably from 0.7 to 10 seconds. When the irradiation time is 0.7 second or more, the curing reaction can be completed, and sufficient curing can be conducted. Further, when the irradiation time is 60 seconds or less, low oxidation condition is not maintained in so long time, and there are the disadvantages that facilities are large-sized, and a large amount of an inert gas is necessary.

The oxygen concentration is preferably 6 vol % or less, more preferably 4 vol % or less, further more preferably 2 vol % or less, and most preferably 1 vol % or less. If the oxygen concentration is not reduced more than the required concentration, the amount of an inert gas used, such as nitrogen, do not increase so much, and this is preferable from the standpoint of production cost.

A method of reducing the oxygen concentration to 10 vol % or less is preferably substitution of atmospheric air (nitrogen concentration: about 79%, and oxygen concentration: about 21%) with other gas, and more preferably substitution with nitrogen (nitrogen purge).

An inert gas is supplied to an ionization radiation irradiation chamber, and is slightly blown to a web inlet side of the irradiation chamber. By this condition, air accompanying with web traveling is removed, and the oxygen concentration in the reaction chamber is effectively reduced, and at the same time, a substantial oxygen concentration on a polar surface having large curing hindrance due to oxygen can efficiently be reduced. Flow direction of the inert gas at the web inlet side of the irradiation chamber can be controlled by, for example adjusting balance between inspiration and evacuation of the irradiation chamber. Directly blowing an inert gas to the web surface is also preferably used as a method of removing an accompanying air.

Curing can efficiently be proceeded by providing an anterior chamber before the reaction chamber and previously removing oxygen on the web surface. To efficiently use the inert gas, the side face constituting the web inlet side of the ionizing radiation reaction chamber or the anterior chamber has a gap to the web surface of preferably from 0.2 to 15 mm, more preferably from 0.2 to 10 mm, and most preferably from 0.2 to 5 mm.

However, to continuously produce the web, the web is required to bond and connect, and a method of adhering with a bonding tape or the like is widely used for the bonding. For this reason, where a gap between the inlet surface of the ionizing radiation reaction chamber or the anterior chamber and the web is too narrow, there is the problem that a bonding member such as a bonding tape gets lodged. Therefore, when narrowing the gap, it is preferable that at least a part of the inlet surface of the ionizing radiation reaction chamber or the anterior chamber becomes movable, thereby expanding the gap to the portion corresponding to a bonding thickness when the bonding portion is present. To realize this, a method can be taken that the inlet face of the ionizing radiation irradiation reaction chamber or the interior chamber is made to be removable in the traveling direction, and moves backward and forward when the bonding portion passes through, there by expanding the gap, or the inlet face of the ionizing radiation irradiation reaction chamber or the interior chamber is made to be removable in a vertical direction to the web surface, and moves up and down when the bonding portion passes through, there by expanding the gap.

In curing the film surface is preferably heated at a temperature of from 60 to 170° C. When the temperature is 60° C. or higher, curing by heating is sufficiently conducted, and when the temperature is 170° C. or lower, the problem in deformation of a substrate, or the like does not occur. The temperature is more preferably from 60 to 100° C. The film surface temperature means a film surface temperature of a layer to be cured. The time that the film maintains this temperature is preferably from 0.1 to 300 seconds, and more preferably 10 seconds or less, from the initiation of UV irradiation. Unless the time of maintaining the film surface temperature in the above temperature range is too short, reaction of the curable composition for forming a coating film can sufficiently be promoted, and unless too long, the problems on production do not occur that optical performance of the film deteriorates, and facilities are large-sized.

The heating method is not particularly limited. A method of heating a roll and contacting the heated roll with a film, a method of spraying heated nitrogen, irradiation with far infrared rays or infrared rays, and the like are preferable. A method of heating by flowing a medium such as hot water, steam or oil in a rotating metal roll as described in U.S. Pat. No. 2,523,574 can also be used. Dielectric heating roll may be used as the heating means.

The ultraviolet irradiation may be conducted in every one layer formation or after lamination, to the respective plural structural layers. Irradiation may be made by combining those irradiations. Ultraviolet rays are preferably irradiated after laminating plural layers from the point of productivity.

In the present invention, at least one layer stacked on the support can be cured by plural ionizing radiation irradiations. In this case, it is preferable that the ionizing radiation irradiation is conducted at least two times in the continuous reaction chambers not exceeding the oxygen concentration of 3 vol %. Reaction time necessary for curing can effectively secured by conducting plural ionizing radiation irradiations in the reaction chambers having the same low oxygen content. In particular, where production speed is increased to increase productivity, plural ionizing radiation irradiations are required for securing the ionizing radiation energy necessary for the curing reaction.

Where a curing rate (100—residual functional group content) is a certain value less than 100%, when an additional layer is provided on the layer on the support, and the curing rate of the under layer is higher than that before providing the upper layer when curing with the ionizing radiation irradiation and/or heat, adhesion between the under layer and the upper layer is improved, which is preferable.

4-6. Handling

To continuously producing the antireflective film of the present invention, a step of continuously sending a roll-shaped support film, a step of applying and drying a coating liquid, a step of curing the coating film, and a step of winding up the support film having a cured layer are conducted.

The film support is continuously sent from the roll-shaped film support to a clean room, static electricity charged on the film support is removed by a static eliminator in the clean room, and foreign matters adhered on the film support are removed by a dust removal equipment. A coating liquid is applied to the film support in a coating portion arranged in the clean room, and the coated support is sent to a drying chamber, and dried therein.

The film support having a dried coating layer is sent from the drying chamber to a curing chamber, and a monomer contained in the coating layer is polymerized and cured. The film support having the cured layer is sent to a curing portion to complete the curing. The film support having a curing-completed layer is wound to form a roll.

The above step may be conducted in every formation of each layer, or coating portion-drying chamber-curing portion is provided in plural, and formation of each layer can continuously be conducted.

To produce the antireflective film of the present invention, it is preferable that the coating step in the coating portion, and the drying step in the drying chamber are conducted under air atmosphere having high cleanliness, and before conducting the coating, dusts and dirt are sufficiently removed. Air cleanliness in the coating step and drying step is preferably class 10 (particles of 0.5 μm are more are 353/m³ or less) or more, and more preferably class 1 (particles of 0.5 μm are more are 35.5/m³ or less), based on the standard of air cleanliness in FED-STD-209E. It is more preferable that the air cleanliness is high in the sending portion, winding portion and the like other than coating-drying steps.

4-7. Saponification Treatment

When a polarizing plate is prepared using the antireflective film of the present invention as one of two surface protective films for a polarizer, it is preferable that adhesion on the adhering surface is improved by hydrophilicizing the surface of the film to be adhered to the polarizer.

a. Method of Dipping in Alkali Liquid

This is a method of saponification treating portions being reactive to an alkali on the entire surface of the film by dipping a film in an alkali liquid under appropriate conditions. This method does not require special facilities, and is therefore preferable in the standpoint of cost. The alkali liquid is preferably a sodium hydroxide aqueous solution, and the concentration thereof is preferably from 0.5 to 3 mol/liter, and more preferably from 1 to 2 mol/liter. Liquid temperature of the alkali liquid is preferably from 30 to 75° C., and more preferably from 40 to 60° C. Combination of the saponification conditions is preferably a combination of relatively mild conditions with each other, but can be set according to the intended contact angle.

After dipping in the alkali liquid, it is preferable that the film is sufficiently washed with water, or is dipped in a diluted acid to neutralize an alkali component, so that the alkali doe not remain in the film.

The saponification treatment enables both the surface having the coating layer and the opposite surface to hydrophilicize. The protective film for a polarizing plate is used by adhering the hydrophilicized surface of the transparent support to the polarizer.

The hydrophilicized surface is effective to improve the adhesive layer comprising a polyvinyl alcohol as the main component.

From the standpoint of the adhesion to the polarizer, the saponification treatment is preferable as a contact angle of the surface of the transparent support opposite the side having the coating layer is small. On the other hand, the area of from the surface having the coating layer to the inside simultaneously receives the damage by alkali in the dipping method. Therefore, it is important to be the requisite minimum reaction conditions. Where the contact angle of the opposite surface of the transparent support to water is used as the measure of the damage that each layer receives by an alkali, particularly when the transparent support is triacetyl cellulose, the contact angle is preferably from 10 to 50°, more preferably from 30 to 50° C., and most preferably from 40 to 50°. When the contact angle is 50° or less, the problem does not occur on adhesion to the polarizer. On the other hand, when the contact angle is 10° or more, the problem does not occur such that the damage that the film receives is too large, and physical strength deteriorates.

B. Method of Applying Alkali Liquid

As the means to avoid the damage to each layer in the above dipping method, an alkali coating method of applying the alkali liquid to only the surface opposite the side having the coating layer, heating, washing with water and drying, under appropriate conditions is preferably used. The “applying” in this case means to contact an alkali liquid or the like with only the face on which saponification is conducted, and includes to conduct the “applying” by spraying, contacting with, for example, a belt containing a liquid, or the like, other than the coating. Those methods additionally require facilities and step for applying the alkali liquid, and are therefore inferior to the dipping method (a) in the standpoint of cost. However, the alkali liquid contacts with only the surface to be subjected to saponification treatment, and as a result, the opposite surface can have a layer using a material weak to the alkali liquid. For example, a deposition film or a sol/gel film may receive various influences such as corrosion, dissolution, peeling and the like, and therefore, it is not easy to provide those layers in the dipping method. However, in this application method, because of not contacting with the liquid, there is no problem, and those layers can be provided.

Either of the saponification methods (a) and (b) can be conducted after winding off from a rolled support and forming each layer. Therefore, the method may be added after the antireflective film production step to conduct as a series of operations. Further, by continuously conducting in combination with a step of adhering to a polarizer comprising a support wound off, a polarizing plate can be produced further efficiently than conducting the same operations in sheet.

C. Method of Saponifying by Protecting Stacking Film

Similar to the above (b), where the coating layer lacks in durability to the alkali liquid, after forming the final layer, a stacking film (layered film) is adhered to the surface having the final layer formed thereon, and then dipped in the alkali liquid. By this procedure, only the triacetyl cellulose surface opposite the side having the final layer formed thereon can be hydrophilicized. In this case, the stacking film is peeled after the saponification treatment. Even in this method, the necessary phydrophilicization treatment as the protective film for a polarizing plate can be subjected to only the triacetyl cellulose surface opposite the side having the final layer formed thereon. As compared with the above method (b), this method (c) has the advantage that a stacking film generates as a waste, but a specific apparatus for applying the alkali liquid is not required.

D. Method of Dipping in Alkali Liquid after Formation of Mid-Layer

Where the layers up to the under layer are durable to the alkali liquid, but the upper layer is not sufficiently durable to the alkali liquid, after forming up to the lower layer, the resulting layered product can be dipped in the alkali liquid to hydrophilicize both surfaces, and then the upper layer can be formed. Although the production steps are complicated, for example, in the antireflective film comprising the antiglare layer and the lower refractive index layer of a fluorine-containing sol/gel film, where the lower refractive index layer has a hydrophilic group, there is the advantage that interlaminar adhesion between the antiglare layer and the lower refractive index layer is improved.

E. Method of Forming Coating Layer on Triacetyl Cellulose Film Previously Saponified

The triactyl cellulose film may be saponified by, for example, previously dipping in the alkali liquid, and the coating layer may be formed on one surface of the film directly or through other layer. Where the film is saponified by dipping in the alkali liquid, the interlaminar adhesion between the triacetyl cellulose surface hydrophlicized by saponification and the coating layer to be formed may deteriorate. In such a case, after saponification, only the surface forming the coating layer is subjected to a treatment such as corona discharge or glow discharge to remove the hydrophilicized surface, and the coating layer can be formed thereon. Further, where the coating layer has a hydrophilic group, the interlaminar adhesion may be good.

4-8. Production of Polarizing Plate

The antireflective film of the present invention can be used as a protective film provided on one side or both sides of a polarizer, thereby producing a polarizing plate.

In this case, the antireflective film of the present invention can be used as one protective film, and the general cellulose acetate film can be used as other protective film. Further, it is preferable to use the cellulose acetate film produced by the above-described solution film-forming method and stretched in a width direction in a roll film form at a stretching ratio of from 10 to 100%, and the antireflective film of the present invention having formed thereon the coating layer by the die coater or the like to such a roll film-form film.

It is also the preferable embodiment in the polarizing plate of the present invention that one protective is an antireflective film, and other protective film is an optically compensating film having an optically anisotropic layer comprising a liquid crystalline compound.

The polarizer includes an iodine type polarizer, a dye type polarizer using a dichroic dye, and a polyene type polarizer. The iodine type polarizer and the dye type polarizer are generally produced using a polyvinyl alcohol film.

A retardation axis of the transparent support or the cellulose acetate film of the antireflective film and a transmission axis of the polarizer are provided so as to be substantially parallel.

Moisture permeability of the protective film is important for productivity of the polarizing plate. The polarizer and the protective film are adhered with an aqueous adhesive, and a solvent of this adhesive is dried by diffusing in the protective film. With increasing the moisture permeability of the protective film, the drying becomes fast, thereby the productivity is improved. However, where the moisture permeability is too high, moisture may introduce into the polarizer depending on the use environment (under high humidity) of a liquid crystal display, and polarizing ability may deteriorate.

The moisture permeability of the protective film is determined by thickness, free volume, hydrophilicity and the like of a polymer film as the transparent support (and polymerizable liquid crystal compound).

When the antireflective film of the present invention is used as the protective film of a polarizing plate, its moisture permeability is preferably from 100 to 1,000 g/m²·24 hrs, and more preferably from 300 to 700 g/m²·24 hrs.

Thickness of the transparent support can be adjusted lip flow rate and line speed, or stretching and compression, in the case of a film formation. The moisture permeability varies depending on the main material used, and it is therefore possible to adjust to a preferable range by adjusting the thickness.

Free volume of the transparent support can be adjusted by drying temperature and time in the case of film formation. In this case, the moisture permeability varies depending on the main material used, and it is therefore possible to adjust to a preferable range by adjusting the free volume.

Hydrophilicity and hydrophobicity of the transparent support can be adjusted by additives. The moisture permeability can be high by adding a hydrophilic additive in the free volume, and the moisture permeability can be low by adding a hydrophobic additive in the free volume. By controlling the moisture permeability independently, it is possible to produce a polarizing plate having an optically compensating ability inexpensively and with high productivity.

The polarizer used may be the conventional polarizer, or a polarizer cut from a long polarizer in which an absorption axis of the polarizer is not parallel or vertical to a longitudinal direction. The long polarizer in which an absorption axis of the polarizer is not parallel or vertical to a longitudinal direction is prepared by the following method.

Specifically, the long polarizer is a polarizer obtained by stretching a polymer film continuously supplied by giving a tension thereto, while maintaining both edges of the film with holding means, and can be produced by the following stretching method. The film is stretched 1.1 to 20.0 times in at least film width direction. Difference in traveling speed in longitudinal direction of the holding apparatus at both edges is within 3%. The film travels such that an angle of the traveling direction of the film at the outlet of a step of holding both edges of the film to the substantial stretching direction of the film inclines 20 to 70° C., and is bent in a state of holding the both edges of the film. In particular, 45° inclination is preferably used from the standpoint of productivity.

Stretching method of a polymer film is described in detail in JP-A-2002-86554, paragraphs [0020] to [0030].

It is preferable that of two protective films of the polarizer, a film other than the antireflective film is an optically compensating film containing an optically compensating layer having an optical anisotropy. The optically compensating film (retardation film) can improve view angle properties of a liquid crystal display surface. The optically compensating film can use the conventional optically compensating films. From the point of expanding the view angle, the optically compensating film described in JP-A-2001-100042 is preferable.

5. Use Embodiment of Antireflective Film of the Present Invention

The antireflective film of the present invention can be used in image displays such as a liquid crystal display (LCD), a plasma display panel (PDP), an electroluminescence device (ELD) or a cathode ray tube display (CRT). The antireflective filter according to the present invention can be used in conventional displays such as a plasma display panel (PDP) or a cathode ray tube display (CRT).

5-1. Liquid Crystal Display

The antireflective film of the present invention and a polarizing plate using the same can advantageously be used in image displays such as a liquid crystal display, and are preferably used as an outermost layer of the display.

The liquid display comprises a liquid crystal cell, and two polarizing plates provided on both side of the cell, the liquid crystal cell supporting a liquid crystal between two electrode substrates. One optically anisotropic layer may be provided between the liquid crystal cell and one polarizing plate, or two optically anisotropic layers may be provided between the liquid crystal cell and each of two polarizing plates.

The liquid crystal cell is preferably TN mode, VA mode, OCB mode, IPS mode or ECB mode.

(TN Mode)

In the liquid crystal cell of TN mode, rod-shaped liquid crystal molecules are substantially oriented horizontally when not applying voltage, and further are torsionally oriented with 60 to 120°.

The liquid crystal cell of TN mode is most widely utilized as a color TFT liquid crystal display, and is described in many literatures.

(VA Mode)

In the liquid crystal cell of VA mode, rod-shaped liquid crystal molecules are substantially oriented vertically when not applying voltage.

The liquid crystal cell of VA mode includes:

(1) a liquid crystal cell of VA mode in narrow sense that rod-shaped liquid crystal molecules are substantially oriented vertically when not applying voltage, and are substantially oriented horizontally when applying voltage (described in JP-A-2-176625),

(2) a liquid crystal cell (of MVA mode) in which a multidomain mode is formed from VA mode for expanding view angle (“SID97, Digest of tech. Papers” (Extended Abstracts), 28th collection (1997), p845),

(3) a liquid crystal cell of a mode (n-ASM mode) in which rod-shaped liquid crystal molecules are substantially oriented vertically when not applying voltage, and are torsionally multidomain-oriented when applying voltage (Japan Liquid Crystal Meeting, Extended Abstracts 58-59 (1998)), and

(4) a liquid crystal cell of SURVAUVAL mode (published in LCD International 98).

(OBC Mode)

A liquid crystal cell of OBC mode is a liquid crystal cell of a bend-oriented mode in which rod-shaped liquid crystal molecules are oriented in substantially reverse direction (symmetrically) at the upper portion and the lower portion of the liquid crystal cell, and is disclosed in U.S. Pat. Nos. 4,583,825 and 5,410,422. Because rod-shaped liquid crystal molecules are oriented symmetrically at the upper portion and the lower portion of the liquid crystal cell, the liquid crystal cell of a bend-oriented mode has a self-optically compensating function. For this reason, this liquid crystal mode is also called OBC (Optically Compensatory Bend) liquid crystal mode. A liquid crystal display of the bend-oriented mode has the advantage that response speed is fast.

(IPS Mode)

A liquid crystal cell of IPS mode is a system of switching by applying transverse electric field to a nematic liquid crystal, and is described in detail in “Proc. IDRC” (Asia Display '95), p577-580 and p707-710.

(ECB Mode)

A liquid crystal cell of ECB mode is that rod-shaped liquid crystal molecules are substantially oriented horizontally when not applying voltage. The ECB mode is one of liquid crystal display modes having the simplest structure, and is described in detail in, for example, JP-A-5-203946.

5-2. Display Other than Liquid Crystal Display

(PDP)

A plasma display panel (PDP) is generally constituted of a gas, a glass substrate, an electrode, an electrode lead material, a thick film printing material and a fluorescent material. The glass substrate is two plates of a front glass substrate and a rear glass substrate. The electrode and an insulating layer are formed on the two glass substrates. A fluorescent layer is formed on the rear glass substrate. Two glass substrates are fabricated, and a gas is sealed in a space therebetween.

The plasma display panel (PDP) is already commercially available. The plasma display panel is described in JP-A-5-205643 and JP-A-9-306366.

In some cases, a front plate is provided on the front surface of the plasma display panel. The front plate preferably is provided with sufficient strength for protecting the plasma display panel. The front plate can directly be adhered to the plasma display body.

In an image display such as the plasma display panel, the antireflective film of the present invention can directly be adhered to the display surface as an optical filter. Where the front plate is provided on the surface of a display, the antireflective film can also be adhered to the front side (outer side) or the rear side (display side) of the front plate as an optical filter.

(Touch Panel)

The antireflective film of the present invention can be used in a touch panel and the like described in, for example, JP-A-5-127822 and JP-A-2002-48913.

(Organic EL Device)

The antireflective film of the present invention can be used as a substrate (substrate film) or a protective film of an organic EL device or the like.

Where the antireflective film of the present invention is used in an organic EL device or the like, the contents described in, for example, JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617 and JP-A-2002-056976. Further, the contents described in JP-A-2001-148291, JP-A-2001-221916 and JP-A-2001-231443 are preferably used in combination.

6. Various Characteristic Values

Various measurement methods relating to the antireflective film of the present invention, and preferable characteristic values are described below.

6-1. Reflectivity

Mirror reflectivity and feeling of color can be measured as follows. An adapter “ARV-474” is amounted on a spectrophotometer “V-550” (a product of JASCO Corporation), a mirror reflectivity at incident angle of 5° and output angle of −5° is measured in a wavelength region of from 380 to 780 nm, an average reflectivity at 450 to 650 nm is calculated, and antireflection properties are evaluated.

6-2. Feeling of Color

A polarizing plate using the antireflective film of the present invention as its protective film can evaluate feeling of color by obtaining feeling of color of regular reflecting light to an incident light of an incident angle 5° in a region of a wavelength of from 380 to 780 nm of CIE standard light source D₆₅, that is, L*, a* and b* values in CIE 1976 L*a*b* color space.

L*, a* and b* values are preferably in ranges of 3≦L*≦20, −7≦a*≦7 and −10≦b*≦10, respectively. The feeling of color of reddish violet to bluish violet reflecting light that was the problem in the conventional polarizing plate can be reduced by those ranges. Further, the feeling of color is greatly reduced by the ranges of 3≦L*≦10, 0≦a*≦5 and −7≦b*≦0, and when such a film is used in a liquid crystal display, the feeling of color when outside light having high brightness, such as a fluorescent lamp in a room, is slightly reflected is neutral, and one is not nervous about the feeling of color. In detail, when a*≦7, reddish color is not too strong, and when a*≧−7, cyan color is not too strong. Further, when b*≧−7, bluish color is not too strong, and when b*≦0, yellowish color is not too strong.

Homogeneity of color feeling of the reflecting light can be obtained as a rate of color feeling change from a*b* on L*a*b* chromaticity diagram obtained from reflection spectrum at 380 to 680 nm of the reflecting light, according to the following equation (3).

$$\begin{matrix}Equation ( 3 ) \text{:} & \\ Rate of color feeling change ( {a}^{*} ) = \frac{{a}_{max}^{*} - {a}_{min}^{*}}{{a}_{av}^{*}} 100 \\ Rate of color feeling change ( {b}^{*} ) = \frac{{b}_{max}^{*} - {b}_{min}^{*}}{{b}_{av}^{*}} \times 100 & \end{matrix}$$

In the above equations, a*ₘₐₓ and a*ₘᵢₙ are the maximum value and the minimum value of the a* value, respectively; b*ₘₐₓ and b*ₘᵢₙ are the maximum value and the minimum value of the b* value, respectively; and a*ₐᵥ and b*ₐᵥ are the average value of the a* value and b* value, respectively. The rate of color feeling change is preferably 30% or less, more preferably 20% or less, and most preferably 8% or less.

The antireflective film of the present invention has ΔE_{W} which the color feeling change before and after a weather resistance test of preferably 15 or less, more preferably 10 or less, and most preferably 5 or less. In this range, low reflection and reduction in color feeling of reflecting light can be achieved in combination. Therefore, for example, when the antireflective film is applied to the outermost layer, the color feeling when outside light having high brightness, such as a fluorescent lamp in a room, is slightly reflected is neutral, and display image quality is good, which is preferable.

The above color feeling change ΔE_{W} can be obtained by the following equation (4).
ΔE_{w}=[ΔL_{w}]²+(Δa_{w})²+(Δb_{w})²]^{1/2} Equation 4:
wherein ΔL_{W}, Δa_{W} and Δb_{W} are the amount of change of the L* value, a* value and b* value before and after a weather resistance test, respectively.
6-3. Transfer Imaging Definition

The transfer imaging definition can be measured using an optical comb having a slit with of 0.5 nm by a mapping instrument “ICM-2D Model”, a product of Suga Test Instruments Co., Ltd.

The antireflective film of the present invention has a transfer imaging definition of preferably 60% or more. The transfer imaging definition is generally a measure of degree of diffusion of an image reflected by transmitting a film, and the image viewed through a film is definite and good as the value increases. The transfer imaging definition is preferably 70% or more, and more preferably 80% or more.

6-4. Surface Roughness

A center ling average roughness (Ra) in the antireflective film of the present invention can be measured according to JIS B-0601.

6-5. Haze

Haze of the antireflective film of the present invention means a haze value defined in JIS K-7136, and uses a value automatically measured as haze=(diffused light/total transmitted light)×100 (%) measured using a turbimeter “NDH-1001DP”, a product of Nippon Denshoku Industries Co., Ltd.

The antireflective film of the present invention has a surface haze value due to surface scattering of preferably from 5 to less than 15%, more preferably from 7 to less than 15%, and most preferably from 7 to less than 10%. When the haze value is within the above range, good antiglare properties and antireflective properties are obtained without deterioration of the transfer imaging, thereby achieving those properties in combination with mar resistance. The surface haze value can be obtained, for example, as follows. Total haze value of the antireflective film is measured according to the above. A cellophane tape is adhered to the surface at the lower refractive index layer side of the antireflective film to remove a surface haze. In this state, an internal haze is measured, and difference between the total haze and the internal haze is obtained.

6-6. Goniophotometer Scattering Intensity Ratio

The antireflective film is arranged vertically to an incident light, and a scattered light profile is measured over all direction using GoniophotoMeter “GP-5”, a product of Murakami Color Research Laboratory. The intensity ratio is obtained from a scattered light intensity at an output angle 30° to a light intensity at an output angle 0°.

6-7. Mar Resistance

(Evaluation in Scratch Resistance to Steel Wool Rubbing)

For a measure of the scratch resistance, a rubbing test is conducted using a rubbing tester under the following conditions.

Evaluation environmental conditions: 25° C., 60% RH

Rubbing material: Steel wool (a product of Nippon Steel Wool Co., Ltd., Grade No. 0000) is wound around a rubbing tip portion (1 cm×1 cm) of a tester, contacted with a sample, and fixed with a band.

Moving distance (one way): 13 cm

Rubbing speed: 13 cm/sec

Load: 500 g/cm², and 200 g/cm²

Tip portion contact area: 1 cm×1 cm

Number of rubbing: 10 reciprocations

An oily black ink is applied to the back surface of a sample after rubbing, scratches on the rubbed part is visually observed with a reflected light, and difference in reflected light amount between the rubbed part and other part is visually measured for evaluation.

(Evaluation in Scratch Resistance to Eraser Rubbing)

For a measure of the scratch resistance, a rubbing test is conducted using a rubbing tester under the following conditions.

Evaluation environmental conditions: 25° C., 60% RH

Rubbing material: An eraser (“MONO”, a product of Tombow Pencil Co., Ltd.) is fixed to a rubbing tip portion (1 cm×1 cm) of a tester, contacted with a sample.

Moving distance (one way): 4 cm

Rubbing speed: 2 cm/sec

Load: 500 g/cm²

Tip portion contact area: 1 cm×1 cm

Number of rubbing: 100 and 300 reciprocations

An oily black ink is applied to the back surface of a sample after rubbing, scratches on the rubbed part is visually observed with a reflected light, and difference in reflected light amount between the rubbed part and other part is visually measured for evaluation.

(Taber Test)

Scratch resistance can be evaluated from abrasion amount of a test piece before and after a test with a Taber test according to JIS K-5400. The smaller the abrasion amount, the better.

6-8. Hardness

(Pencil Hardness)

Hardness of the antireflective film of the present invention can be evaluated by a pencil hardness test according to JIS K-5400. The pencil hardness is preferably H or more, more preferably 2H or more, and most preferably 3H or more.

(Surface Elastic Modulus)

Surface elastic modulus in the antireflective film of the present invention is a value obtained using a microsurface hardness tester (“Fischer Scope H100VP-HCU”, a product of Fischer Instruments K.K.). Specifically, a diamond square pyramid indenter (tip face-to-face angle: 136°) is used. The indenter is pressed under an appropriate test load in a range that a pressed depth does not exceed 1 μm to measure the pressed depth. The surface elastic modulus is an elastic modulus obtained from a load at removing load and change in displacement.

(Universal Hardness)

The surface hardness can be measured as a universal hardness using the above microsurface hardness meter. The universal hardness is a value obtained by measuring a pressed depth of a square pyramid indenter under a test load, and dividing the test load by a surface area of pressed mark calculated from a geometric shape of the pressed mark generated by the test load. It is known that there is a positive correlation between the surface elastic modulus and the universal hardness.

The universal hardness of a crosslinkable polymer defined in the present invention is represented by a universal hardness (N/mm²) by using the crosslinkable polymer film having about 20 to 30 μm thickness cured and formed on a glass plate, and measuring with a microhardness meter “H100”, a product of Fischer Instruments K.K. by the following measurement procedures.

A coating liquid having a solid content concentration of about 25 mass % containing the crosslinkable polymer and necessary catalyst, crosslinking agent, polymerization initiator and the like is applied to a polished slide glass plate (26 mm×76 mm×1.2 mm), a product of Toshinriko Co., Ltd. By selecting an appropriate bar coater at a cured thickness of from about 20 to 30 μm. Where the crosslinkable polymer is thermosetting, heat curing conditions that a film is sufficiently cured are previously determined (for example, 125° C. and 10 minutes), and where the crosslinkable polymer is ionizing radiation curable, heat curing conditions that a film is sufficiently cured are previously determined (for example, oxygen concentration: 12 ppm, Us irradiation dose: 750 mJ/cm²). To the respective film, a load is continuously increased from 0 to 4 mN, and using 1/10 film thickness that does not affect hardness of a glass plate (substrate) as the maximum, the universal hardness is calculated from the average measurement of N=6 measurement obtained from a depressed area A (mm²) to each load F when pressing a square pyramid indenter.

(Surface Hardness by Nanoindentation)

The surface hardness can also be obtained by the nanoindentation described in JP-A-2004-354828. In this case, it is preferable that the hardness is from 2 to 4 GPa, and nanoindentation elastic modulus is from 10 to 30 GPa.

6-8. Antifouling Test

(Magic Ink Wiping Properties)

The antireflective film is fixed to a glass surface with a pressure-sensitive adhesive. Three circles having a diameter of 5 mm are drawn on the film with a pen tip (fine) of a black “Magic Ink” (Mckee ultrafine) (trade name, a product of Zebra Co., Ltd.) under the conditions of 25° C. and 60 RH %. After 5 seconds, the ink is wiped off by reciprocating twenty times ten-folded “BEMCOT” (trade name, a product of Asahi Kasei Corporation) under a load to an extent that “BEMCOT” dents. The writing and wiping are repeated under the same conditions until disappearing the “Magic Ink” trace by wiping. The antifouling properties can be evaluated by the number of operation that the trace was wiped off.

The number until disappearing is preferably 5 times or more, and more preferably 10 times or more.

Regarding the black “Magic Ink”, “Magic Ink No. 700 (M700-T1 Black) ultrafine” is used, and a circle having a diameter of 1 cm is drawn on a sample using the ink, and the inside of the circle is marked out. After allowing to stand 24 hours, the sample is rubbed with “BEMCOT” to evaluate whether or not “Magic Link” is wiped out.

6-10. Surface Tension

In the present invention, the surface tension of the coating liquid forming the functional layer can be measured using a surface tensiometer “KYOWA CBVP SURFACE TENSIOMETER A3”, a product of Kyowa Interface Science Co., Ltd., under an environment of a temperature of 25° C.

6-11. Contact Angle

Using a contact angle meter (“CA-X” contact angle meter, a product of Kyowa Interface Science Co., Ltd., a liquid droplet having a diameter of 1.0 mm is formed at a needle tip using a pure water as a liquid under dry condition (20° C., 65% RH), and this droplet is contacted with a surface of a film to form a liquid droplet on the film. An angle between a tangent line to a liquid surface and the film surface in a point that the film and the liquid contact, the angle being at the side containing the liquid, is defined as a contact angle.

6-12. Surface Free Energy

The surface free energy can be obtained by a contact angle method, a wet heat method and an adsorption method as described in “Basis and Application of Wetting”, Realize Publishing Co., Dec. 12, 1989. In the case of the film of the present invention, a contact angle method is preferably used. Specifically, two kinds of solutions each having known surface energy were added dropwise to a cellulose acylate film. An angle between a tangent line to a liquid surface and the film surface at the intersection of the surface of the liquid droplet and the film surface, the angle being at the side containing the liquid, is defined as a contact angle, and the surface energy of the film can be calculated by calculation.

The surface free energy (γs^{v}, unit: mN/m) of the antireflective film of the present invention means a surface tension of the antireflective film defined by the value γs^{v}(=γs^{d}+γs^{h}) represented as the sum of the values γs^{d} and γs^{h}, obtained by the following simultaneous equations (equation (5)) from the contact angles θ_{H20} and θ_{CH2I2} of pure H₂O and methylene iodide CH₂I₂, respectively, experimentally obtained on the antireflective film, by referring to D. K. Owens “J. Appl. Polym. Sci.”, Vol. 13, p. 1741 (1969). When this γs^{v} is small and the surface free energy is low, surface repellent properties are high, and the antifouling properties are generally excellent.
a.1+cos θ_{H20}=2(γS^{d})^{1/2}(γ_{H20}^{d}/γ_{H20}^{v})^{1/2}+(2(γS^{h})^{1/2}(γ_{H20}^{h}/γ_{H20}^{v})^{1/2}
b.1+cos θ_{CH2I2}=2(γS^{d})^{1/2}(γ_{CH2I2}^{d}/γ_{CH2I2}^{v})^{1/2}+2(γS^{h})^{1/2}(γ_{CH2I2}^{h}/γ_{CH2I2}^{v)}^{1/2}
γ_{H20}^{d}=21.8,γ_{H20}^{h}=51.0,γ_{H20}^{v}=72.8
γ_{CH2I2}^{d}=49.5,γ_{CH2I2}^{h}=1.3,γ_{CH2I2}^{v}=50.8 Equation (5):

The contact angle is measured as follows. The antireflective film is humidity-conditioned under the conditions of 25° C. and 60% RH for 1 hour or more. 2 μL of a liquid droplet is added dropwise to the film, and after 30 seconds, a contact angle is measured using an automatic contact angle meter “CA-V150”, a product of Kyowa Interface Science Co., Ltd.

The antireflective film of the present invention has the surface free energy of preferably 25 mN/m or less, and more preferably 20 mN/m or less.

6-13. Curling

Curling is measured using a template for curling measurement of Method A in “Measurement Method of Curling of Photographic Film” defined in JIS K-7619-1988.

The measurement conditions are 25° C., 60% RH and humidity conditioning time 10 hours.

The antireflective film of the present invention has a value when curling is represented by the following equation (6) in a range of preferably from −15 to +15, more preferably from −12 to +12, and most preferably from −10 to +10. Measurement direction of curling in a sample in this case is in a traveling direction of a substrate in the case of coating in a web form.
Curling=1/R Equation (6):

R is a curvature radius (m)

This is an important property for that crack and film peeling do not occur in processing or handling in market. The curling value is preferably small as being fallen within the above range. The expression “+” in the above means a curling in which a film-applied side is inside, and the expression “−” means a curling in which a film-applied side is outside.

In the antireflective film of the present invention, the absolute value in difference of each curling value when only relative humidity is changed 80% and 10% based on the above curling measurement method is preferably from 24 to 0, more preferably from 15 to 0, and most preferably from 8 to 0. This is the property related to handling property, peeling and crack when a film is adhered under various humidity conditions.

6-14. Adhesion Evaluation

Adhesion between layers of the antireflective film, or between the support and the coating layer can be evaluated by the following method.

Eleven vertical cut lines and eleven horizontal cut lines are formed on the surface at the side having the coating layer at a distance of 1 mm in a form of a cross-cut with a cutter knife to form 100 square measures. A polyester pressure-sensitive adhesive tape “No. 31B”, a product of Nitto Denko Corporation, is press-adhered to the surface, and after allowing to stand for 24 hours, the tape is peeled. This test is repeated three times on the same portion, and the presence or absence of peeling is visually observed. In 100 square measures, peeled measures is preferably 10 or less, and more preferably 2 or less.

6-15. Brittleness Test (Crack Resistance)

The crack resistance is an important property for that crack defects do not cause in handlings such as application of the antireflective film, processing, cutting, application of a pressure-sensitive adhesive, and adhering to various substances.

The antireflective film sample is cut into a size of 35 mm×140 mm, and the cut piece is allowed to stand under the conditions of 25° C. and 60% RH for 2 hours. A curvature diameter at which crack begins to generate when rolled in a cylinder form is measured to evaluate surface crack.

The crack resistance of the film of the present invention is that a curvature diameter when crack generates when rolled with the coating layer side being outwardly is preferably 50 mm or less, more preferably 40 mm or less, and most preferably 30 mm or less. Regarding crack at the edge portion, it is preferable that crack does not generate, or crack length is less than 1 mm on the average.

6-16. Surface Resistance

The film surface resistance of the present invention is measured using an Ultra-High Resistance/Micro Current Meters “TR8601”, a product of Advantest Corporation, under the conditions of 25° C. and 60% RH. From the common logarithm of the surface resistance (Ω/□), the value of log SR is calculated.

6-17. Dust Removal Property

The antireflective film of the present invention is stuck on a monitor, dusts (fiber wastes of beddings and cloths) are sprayed on the monitor surface, and dusts are wiped off with a cleaning cloth. Thus, the dust removal property can be evaluated.

It is preferable that dusts are completely wiped off by wiping 6 times, and it is more preferable that dusts are completely wiped off by wiping 3 times or less.

6-18. Performance of Liquid Crystal Display

Evaluation method of characteristics when the antireflective film of the present invention is used on a display, and the preferable circumstances are described below.

A polarizing plate at the visible side provided in a liquid crystal display “TH-15TA2”, a product of Matsushita Electric Industrial Co., Ltd., using TN liquid crystal cell is peeled, and in place of the plate, the antireflective film or the polarizing plate of the present invention is adhered to the device through a pressure-sensitive adhesive such that the coated surface is at the visible side, and the transmission axis of the polarizing plate coincides that of the polarizing plate previously adhered. In a light room, the liquid crystal display is displayed black, and the following various characteristics can visually be evaluated from various viewing angles.

(Evaluation of Irregular Image and Color Feeling)

Using the liquid crystal display prepared above, irregularity and color feeling change when displaying black (L1) are visually evaluated by plural observers.

When ten persons evaluate, it is preferable that three persons or less can recognize irregularity, left and right color feeling change, color feeling change by temperature and humidity, and white blur, and it is more preferable that no person can recognize those.

Further, reflection of outside light is conducted using a fluorescent lamp, and change of reflection can visually be relatively evaluated.

(Light Leakage of Black Display)

Light leakage rate of black display at azimuth direction of 45° and a polar angle of 70° from the front side of the liquid crystal display is measured. The light leakage rate is preferably 0.4% or less, and more preferably 0.1% or less.

(Contrast and Viewing Angle)

Regarding the contrast and viewing angle, contrast ratio and viewing angle (angle range that the contrast ratio is 10 or more) in left and right directions (direction vertical to rubbing direction of cell) can be examined using a measuring equipment “EZ-Contrast 160D”, a product of ELDIM Co.

### EXAMPLES

The present invention is described in more detail based on the following Examples, but the invention is not limited to those. In the following Examples and Synthesis Examples, unless otherwise indicated, “%” means “mass %”.

(Preparation of Antireflective Film)

(Synthesis of Fluorine-Containing Polymer)

### Synthesis Example 1

### Synthesis of Fluorine-Containing Polymer (P2)

18.5 of ethyl acetate, 8.8 g of hydroxyethyl vinyl ether (HEVE), 1.2 g of “SILAPLANE FM-0725”, a product of Chisso Corporation, and 0.40 g of “V-65” (heat radical initiator, a product of Wako Pure Chemical Industries, Ltd.) were placed in a stainless steel-made autoclave equipped with a stirrer, having an inner volume of 100 ml, and the inside atmosphere of the system was deaerated, and replaced with a nitrogen gas. 15 g of hexafluoropropylene (HFP) was introduced into the autoclave, and the temperature in the autoclave was elevated to 62° C. Pressure when the temperature in the autoclave reached 62° C. was 8.9 kg/cm². Reaction was continued for 9 hours while maintaining the temperature in the autoclave at 62° C., and when the pressure reached 6.2 kg/cm², heating was stopped, and the autoclave was allowed to stand to cool.

When the inner temperature of the autoclave lowered to room temperature, unreacted monomer was purged, the autoclave was opened, and the reaction liquid was taken out of the autoclave. The reaction liquid obtained was introduced into a mixture of a large excess of hexane and 2-propanol, the solvent was removed by decantation, and the polymer precipitated was taken out. The polymer was dissolved in a small amount of ethyl acetate, and residual monomers were completely removed from the mixture of hexane and 2-propanol by conducting precipitation two times. The polymer was dried under reduced pressure to obtain 8.3 g of a fluorine-containing polymer (P2). The polymer obtained had a number average molecular weight of 17,000.

### Synthesis Example 2

### Synthesis of Fluorine-Containing Polymer (P3)

30 of ethyl acetate, 8.8 g of hydroxyethyl vinyl ether (HEVE), 0.82 g of “VPS-1001” (microazo initiator, a product of Wako Pure Chemical Industries, Ltd.) and 0.29 g of lauroyl peroxide were placed in a stainless steel-made autoclave equipped with a stirrer, having an inner volume of 100 ml, and the inside atmosphere of the system was deaerated, and replaced with a nitrogen gas. 15 g of hexafluoropropylene (HFP) was introduced into the autoclave, and the temperature in the autoclave was elevated to 70° C. Pressure when the temperature in the autoclave reached 70° C. was 9.0 kg/cm². Reaction was continued for 9 hours while maintaining the temperature in the autoclave at 70° C., and when the pressure reached 6.0 kg/cm², heating was stopped, and the autoclave was allowed to stand to cool.

When the inner temperature of the autoclave lowered to room temperature, unreacted monomer was purged, the autoclave was opened, and the reaction liquid was taken out of the autoclave. The reaction liquid obtained was introduced into a mixture of a large excess of hexane and 2-propanol, the solvent was removed by decantation, and the polymer precipitated was taken out. The polymer was dissolved in a small amount of ethyl acetate, and residual monomers were completely removed from the mixture of hexane and 2-propanol by conducting precipitation two times. The polymer was dried under reduced pressure to obtain 19.3 g of a fluorine-containing polymer (P3). The polymer obtained had a number average molecular weight of 21,000.

### Synthesis Examples 3 to 8

### Synthesis of Fluorine-Containing Polymers (P1), (P4), (P12), (P15), (P15), (P20) and (P23)

Fluorine-containing polymers (P1), (P4), (P12), (P15), (P15), (P20) and (P23) were synthesized in substantially the same manner as in Synthesis Example 1 above. Each of the fluorine-containing polymers obtained had a number average molecular weight as shown in Tables 1 and 2 before.

(Synthesis of Curing Catalyst (Salt))

### Synthesis Example 9

### Synthesis of 4-Methylmorphorine Salt of p-Toluenesulfonic Acid

3 g of 4-methylmorphorine was dissolved in 30 ml of 2-butanone, and 5.7 g of p-toluenesulfonic acid-hydrate was added the resulting mixture with small portion while stirring. After stirring the mixture for 1 hour, the solvent was distilled off under reduced pressure, and a solid obtained was recrystallized from acetone to obtain 6.1 g of 4-methylmorphorine salt of p-toluenesulfonic acid.

In the present invention, a solid salt as obtained in Synthesis Example 9 may be used, and a solution obtained by mixing an organic base and an acid, such as a solution before distilling off the solvent under reduced pressure in Synthesis Example 9 may directly be used. Salts comprising an acid and an organic base, shown in Table 4 after were prepared in the same manner as above.

(Preparation of Antireflective Film)

### Examples 1-1 to 1 to 42 and Comparative Examples 1-1 to 1-5

120 parts of methyl ethyl ketone, 100 parts of acryloyloxypropyltrimethoxysilane “KBM5103” (a product of Shin-Etsu Chemical Co., Ltd.) and 3 parts of diisopropoxyaluminum ethyl acetate were placed in a reactor equipped with a stirrer and a reflux condenser, followed by mixing. 30 parts of ion-exchanged water was added to the reactor, and reaction was conducted at 60° C. for 4 hours. The reactor was cooled to room temperature. A sol liquid obtained had a mass average molecular weight of 1,600, and of the components of an oligomer component or more, a component having the molecular weight of from 1,000 to 20,000 was 100%. From a gas chromatography analysis, the acryloyloxypropyltrimethoxysilane as the raw material was not present al all. The sol liquid was adjusted with methyl ethyl ketone such that concentration of the solid content is 29% to obtain a sol liquid a.

(Preparation of Hollow Silica Dispersion)

30.5 parts of acryloyloxypropyltrimethoxysilane and 1.51 parts of diisopropoxyaluminum ethyl acetate were added to 500 parts of a hollow silica fine particle sol “CS60-IPA” (isopropyl alcohol silica sol, a product of Catalysts & Chemicals Ind. Co., Ltd., average particle diameter: 60 nm, shell thickness: 10 nm, silica concentration: 20%, refractive index of silica particle: 1.31), followed by mixing, and 9 parts of ion-exchanged water was added thereto. Reaction was conducted at 60° C. for 8 hours, and the reaction mixture was cooled to room temperature. 1.8 parts of acetyl acetone was added to the reaction mixture to obtain a dispersion. Solvent substitution by vacuum distillation under a pressure of 30 Torr was conducted while adding cyclohexanone such that the silica content is almost constant, and a dispersion having a solid content concentration of 18.2% was obtained by the final concentration adjustment. As a result of analyzing IPA residual amount in the dispersion obtained, it was found to be 0.5% or less.

(Preparation of Coating Liquid for Lower Refractive Index Layer (LL-1 to LL-39))

Each component as shown in Table 4 below was mixed, and dissolved in 2-butanone to prepare a coating liquid for a lower refractive index layer having a solid content of 6%.

TABLE 4

| | | Coating liquid for lower refractive index layer | | | | | | | | | | | |
|---|---|---|---|---|---|---|---|---|---|---|---|---|---|
| | | Fluorine- | | | | | | | | | | | |
| | | containing | | | | Curing catalyst | | | | Organosilane | | | |
| | | polymer | | Curing agent | | | | Addition | | compound | | Inorganic particle | |
| | No. | Kind | Amount | Kind | Amount | Acid | Base | method | Amount | Kind | Amount | Kind | Amount |
| Invention | LL-1 | P1 | 72 | H-1a | 18 | PTS | b-19 | Solid | 1.0 | — | — | ST | 10 |
| Invention | LL-2 | P1 | 64 | H-2a | 16 | PTS | b-14 | Solution | 1.5 | — | — | ST-L | 20 |
| Invention | LL-3 | P1 | 64 | H-1a | 16 | PTS | b-14 | Solution | “” | — | — | (ST/ST-L) | 10/10 |
| Invention | LL-4 | P2 | 72 | H-1a | 18 | PTS | b-14 | Solution | 1.0 | — | — | ST | 10 |
| Invention | LL-5 | P2 | 63 | CY303 | 16 | PTS | b-14 | Solution | 1.5 | — | — | Hollow | 20 |
| | | | | | | | | | | | | Silica | |
| Invention | LL-6 | P3 | 72 | H-2a | 18 | PTS | b-19 | Solution | 1.0 | — | — | ST | 10 |
| Invention | LL-7 | P3 | 64 | CY303 | 26 | PTS | b-18 | Solution | 1.5 | — | — | ST-L | 20 |
| Invention | LL-8 | P4 | 72 | H-1a | 18 | PTS | b-18 | Solid | 1.0 | Sol a | 10.0 | (ST/ST-L) | 5/5 |
| Invention | LL-9 | P4 | 72 | H-2a | 8 | PTS | b-18 | Solution | 1.0 | — | — | (ST/ST-L) | 10/10 |
| Comparison | LL-10 | P12 | 85 | H-1a | 15 | PTS | — | Solution | 1.0 | — | — | — | — |
| Comparison | LL-11 | P12 | 85 | H-1a | 15 | PTS | b-14 | Solution | 1.0 | — | — | — | — |
| Comparison | LL-12 | P12 | 76 | H-1a | 14 | PTS | — | Solution | 1.0 | — | — | ST | 10 |
| Comparison | LL-13 | P12 | 76 | H-1a | 14 | — | — | — | — | — | — | ST | 10 |
| Comparison | LL-14 | P12 | 76 | H-1a | 14 | PTS | b-20 | Solution | 1.0 | — | — | ST | 10 |
| Invention | LL-15 | P12 | 76 | H-1a | 14 | PTS | b-14 | ” | 1.0 | — | — | ST | 10 |
| Invention | LL-16 | P12 | 86 | H-1a | 12 | PTS | b-14 | Solid | 1.0 | — | — | Hollow | 20 |
| | | | | | | | | | | | | Silica | |
| Invention | LL-17 | P12 | 76 | H-1a | 14 | PTS | b-18 | Solution | 1.0 | — | — | ST-L | 10 |
| Invention | LL-18 | P12 | 68 | H-1a | 12 | PTS | b-18 | Solid | 1.0 | — | — | ST-L | 20 |
| Invention | LL-19 | P12 | 64 | H-1a | 16 | PTS | b-18 | Solution | 1.5 | — | — | (ST/ST-L) | 10/10 |
| Invention | LL-20 | P12 | 76 | H-1a | 14 | PTS | b-18 | Solution | 1.0 | Sol a | 10.5 | ST | 10 |
| Invention | LL-21 | P12 | 76 | H-1a | 14 | PTS | b-14 | Solution | 1.0 | Sol a | 5.0 | ST-L | 10 |
| Invention | LL-22 | P12 | 64 | H-1a | 16 | PTS | b-14 | Solution | 1.0 | Sol a | 10.0 | Hollow | 20 |
| | | | | | | | | | | | | silica | |
| Invention | LL-23 | P12 | 64 | H-2a | 16 | PTS | b-18 | Solution | 2.0 | — | — | (ST/ST-L) | 10/10 |
| Invention | LL-24 | P12 | 81 | H-2a | 9 | PTS | b-3 | Solution | 1.0 | — | — | ST | 10 |
| Invention | LL-25 | P12 | 76 | H-2a | 14 | PTS | b-7 | Solution | 1.0 | — | — | ST-L | 10 |
| Invention | LL-26 | P12 | 64 | H-2a | 16 | PTS | b-19 | Solution | 1.5 | — | — | (ST/ST-L) | 10/10 |
| Invention | LL-27 | P12 | 64 | CY303 | 16 | DBP | b-18 | Solution | 2.0 | — | — | Hollow | 20 |
| | | | | | | | | | | | | Silica | |
| Invention | LL-28 | P12 | 76 | CY303 | 14 | PST | b-3 | Solution | 1.0 | — | — | ST | 10 |
| Invention | LL-29 | P12 | 76 | CY303 | 14 | PTS | b-7 | Solution | 1.0 | — | — | ST-L | 10 |
| Invention | LL-30 | P12 | 72 | MX-270 | 8 | PTS | b-18 | Solution | 2.0 | — | — | (ST/ST-L) | 10/10 |
| Invention | LL-31 | P12 | 76 | H-1a | 14 | DBS | b-14 | Solution | 1.0 | — | — | ST | 10 |
| Invention | LL-32 | P12 | 76 | H-2a | 14 | PTS | b-18 | Solution | 1.0 | — | — | Hollow | 10 |
| | | | | | | | | | | | | Silica | |
| Invention | LL-33 | P12 | 72 | CY303 | 8 | MsOH | b-18 | Solution | 2.0 | — | — | (ST/ST-L) | 10/10 |
| Invention | LL-34 | P15 | 81 | H-2a | 9 | MsOH | b-14 | Solution | 1.0 | — | — | ST | 10 |
| Invention | LL-35 | P15 | 76 | H-1a | 14 | PTS | b-14 | Solution | 1.0 | — | — | ST-L | 10 |
| Invention | LL-36 | P20 | 76 | H-1a | 14 | PTS | b-18 | Solution | 1.0 | — | — | (ST/ST-L) | 5/5 |
| Invention | LL-37 | P20 | 64 | CY303 | 16 | DBS | b-14 | Solution | 1.0 | — | — | (ST/ST-L) | 10/10 |
| Invention | LL-38 | P23 | 76 | H-2a | 14 | PTS | b-14 | Solution | 1.0 | — | — | Hollow | 10 |
| | | | | | | | | | | | | Silica | |
| Invention | LL-39 | P23 | 81 | CY303 | 9 | MsOH | b-18 | Solution | 1.0 | — | — | ST-L | 10 |

Numerical values of the amount used in Table 4 means mass % of a solid content (or effective component) in each component occupied in the solid content of the coating liquid for a lower refractive index layer.

The abbreviations in Table 4 are as follows.

CY303: “CYMEL 303”, a product of Nippon Scitec Industries, Ltd., methylolated melamine

MX-270: “NIKALAC MX-270”, a product of Sanwa Chemical Co., Ltd., tetramethoxymethyl glycoluryl

ST, ST-L: “MEK-ST”, “MEK-ST-L”, products of Nissan Chemical Industries, Ltd., colloidal silica (silica particles)

Hollow silica: Hollow silica, a product of Catalysts and Chemicals Ind. Co., Ltd. (The above-described hollow silica dispersion was used in the coating liquid.)

H-1a and H-2a are compounds having the following structures, respectively.

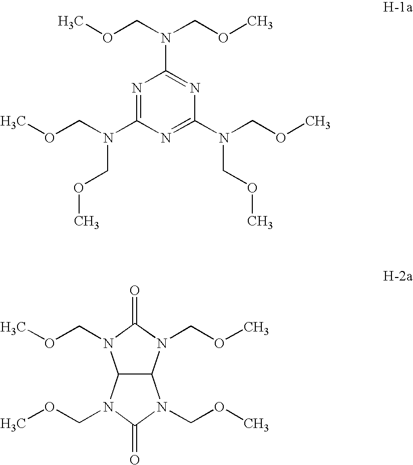

The name of an acid for the curing catalyst is shown by the abbreviation described in the description. The column of addition method shows how a salt is prepared and used. The “Solid” is the case that an acid and an organic base were isolated and used, and the “Solution” shows the case that a solution containing equimolar amounts of an acid and an organic base was prepared and used.

(Preparation of coating liquid for hard coat layer (HCL-1)

| | |
|---|---|
| PET-30 | 50.0 g |
| Irgacure 184 | 1.0 g |
| Irgacure 907 | 1.0 g |
| SX-350 (30%) | 2.0 g |
| Crosslinked acryl-styrene particle | 14.0 g |
| KBM-5103 | 10.0 g |
| Toluene | 38.5 g |

The above mixed liquid was filtered with a propylene filter having a pore size of 30 μm to prepare a coating liquid for a hard coat layer (HCL-1).

The respective compounds used are shown below.

PET-30: A mixture of pentaerythritol triacrylate and pentaerithritol tetraacrylate (a product of Nippon Kayaku Co., Ltd.)

Irgacure 184, Irgacure 907: Polymerization initiator, products of Ciba Specialty Chemicals K.K.

SX-350: Crosslinked polystyrene particles having an average particle diameter of 3.5 μm (refractive index: 1.60, a product of Soken Chemicals & Engineering Co., Ltd., 30% toluene dispersion. Used after dispersing with Polytron disperser at 10,000 rpm for 20 minutes.)

Crosslinked acryl-styrene particle: Average particle diameter: 3.5 μm (refractive index: 1.55, a product of Soken Chemicals & Engineering Co., Ltd., 30% toluene dispersion. Used after dispersing with Polytron disperser at 10,000 rpm for 20 minutes.)

KBM-5103: Acryloyloxypropyltrimethoxysilane (a product of Shin-Etsu Chemical Co., Ltd.)

(Preparation of Coating Liquid for Hard Coat Layer (HCL-2 to HCL-6))

To prepare films having hazes by various internal scatterings and surface scatterings, the addition amount of light-transmitting particles contained in the above HCL-1 and the ratio of two kinds of particles were changed to prepare HCL-2 to HCL-6. The kind and amount of each component used are shown in Table 5 below. The numerical values in the amount means mass % of a solid content (or an effective component) in each component occupied in the solid content of the coating liquid for a hard coat layer.

TABLE 5

| | Coating liquid for hard coat layer | | | | | | | | |
|---|---|---|---|---|---|---|---|---|---|
| | | Photopolymerizable | | Reactive | | | | Light- | |
| | | polyfunctional | | organosilicon | | Photopolymerization | | transmitting | |
| | | monomer | | compound | | initiator | | particle | |
| | No. | Kind | Amount | Kind | Amount | Kind | Amount | Kind | Amount |
| Invention | HCL-1 | PET-30 | 74.85 | KBM | 14.97 | I-184 | 1.50 | SX-350 | 0.90 |
| | | | | | | I-904 | 1.50 | Ac-St | 6.29 |
| Invention | HCL-2 | PET-30 | 73.42 | KBM | 14.68 | I-184 | 1.55 | SX-350 | 0.90 |
| | | | | | | I-904 | 1.55 | Ac-St | 7.90 |
| Invention | HCL-3 | PET-30 | 70.97 | KBM | 14.19 | I-184 | 1.60 | SX-350 | 0.90 |
| | | | | | | I-904 | 1.60 | Ac-St | 10.75 |
| Invention | HCL-4 | PET-30 | 74.23 | KBM | 14.85 | I-184 | 1.53 | SX-350 | 0.90 |
| | | | | | | I-904 | 1.53 | Ac-St | 6.95 |
| Invention | HCL-5 | PET-30 | 72.08 | KBM | 14.42 | I-184 | 1.58 | SX-350 | 0.90 |
| | | | | | | I-904 | 1.58 | Ac-St | 9.45 |
| Invention | HCL-6 | PET-30 | 71.26 | KBM | 14.25 | I-184 | 1.60 | SX-350 | 0.55 |
| | | | | | | I-904 | 1.60 | Ac-St | 10.75 |

(Preparation of Antireflective Film (101))

A triacetyl cellulose film “TAC-TD80U” having a thickness of 80 μm (a product of Fuji Photo Film Co., Ltd.) was wound off in a roll form. The above coating liquid for a hard coat layer (HCL-1) was directly applied to the film using a microgravure roll having a line number of 180/inch and a depth of 40 μm, and a doctor blade under the conditions of a number of revolution of the gravure roll of 30 rpm and a traveling speed of 30 m/min. After drying at 60° C. for 150 seconds, the coating layer was cured by irradiating with ultraviolet rays having an illuminance of 400 mW/cm² and a dose of 110 mJ/cm² using an “air-cooling metal halide lamp” (a product of Eyegraphics Co., Ltd.) of 160 W/cm at oxygen concentration of 0.1 vol % under nitrogen purging, and a layer having a thickness of 6 μm was formed and wound up. The hard coat layer thus prepared had a surface roughness of Ra=0.18 μm and Rz=1.40 μm, and a haze of 35%.

The coating liquid for a lower refractive index layer (LL-1) was applied to the hard coat layer obtained above such that the lower refractive index layer has a thickness of 95 nm. Thus, an antireflective film sample (101) was prepared. Drying conditions of the lower refractive index layer were 100° C. and 10 minutes, ultraviolet curing conditions were that while purging with nitrogen so as to be an atmosphere that oxygen concentration is 0.01 vol % or less, an “air-cooling metal halide lamp” (a product of Eyegraphics Co., Ltd.) of 240 W/cm was used, and ultraviolet rays having an illuminance of 120 mW/cm² and a dose of 240 mJ/cm² were irradiated.

(Preparation of Antireflective Films (102) to (147))

Antireflective films (102) to (147) were prepared in the same manner as in the preparation of the antireflective film (101), except for using the coating liquid for a hard coat layer and the coating liquid for a lower refractive index layer in the combination shown in Table 6 below.

(Saponification Treatment of Antireflective Film)

The antireflective film obtained was treated and dried under the following saponification standard conditions.

Alkali bath: 1.5 mol/dm³ sodium hydroxide aqueous solution, 55° C., 120 seconds

First water washing bath: city water, 60 seconds

Neutralizing bath: 0.05 mol/dm³ sulfuric acid, 30° C., 20 seconds

Second water washing bath: city water, 60 seconds

Drying: 120° C., 60 seconds

(Evaluation of Antireflective Film)

The following evaluations were made using the saponified antireflective film obtained above.

(Evaluation 1) Measurement of Average Reflectivity

Using a spectrophotometer “V-550”, a product of JASCO Corporation, spectral reflectivity at an incident angle of 5° was measured at a wavelength region of from 380 to 780 nm using an integrating sphere.

After subjecting the back surface of the antireflective film to roughening treatment, light absorption treatment with black ink (transmission at 380 to 780 nm is less than 10%) was conducted, and measurement was made on a black table.

In the case of a display which is processed in a form of a polarizing plate as described after, the polarizing plate itself was used for the measurement. In the case of a display which does not use a polarizing plate, the back surface of the antireflective film was roughened, light absorption treatment with black ink (transmission at 380 to 780 nm is less than 10%) was conducted, and measurement was made on a black table.

(Evaluation 2) Surface Haze

Surface haze (Hs) of the film obtained was measured by the following procedures.

(i) Total haze value (H) of the antireflective film obtained is measured according to JIS K-7136.

(ii) Cellotape (a product of Nichiban Co., Ltd.) is adhered to the surface at the low reflective index layer side of the antireflective film obtained, and a haze is measured in the state of eliminating the surface haze. A value obtained by taking a value of Cellotape separately measured from the value measured above is calculated as an internal haze (Hi).

(iii) A value obtained by taking the internal haze (Hi) calculated in (ii) above from the total haze (H) measured in (i) above was calculated as the surface haze (Hs) of the film.

(Evaluation 3) Evaluation in Mar Resistance to Steel Wool Rubbing

After conducting the rubbing test under a load of 500 g/cm² according to the method of “Evaluation in mar resistance to steel wool rubbing” in the above item of “6-7. Mar resistance”, an oily black ink was applied to the back side of the sample rubbed. The ink-coated surface was visually observed with reflected light, and scratches on the rubbed portion were evaluated by the following criteria.

A: Scratches are not observed at all even through very carefully examined.

B: Weak scratches are slightly observed when very carefully examined.

C: Weak scratches are observed.

D: Medium scratches are observed.

E: Scratches are recognized at a glance.

F: Film is scratched over the entire surface.

(Evaluation 4) Evaluation in Mar Resistance to Eraser Rubbing

After conducting the rubbing test with the rubbing number of 300 reciprocations according to the method of “Evaluation in mar resistance to eraser rubbing” in the above item of “6-7. Mar resistance”, an oily black ink was applied to the back side of the sample rubbed. The ink-coated surface was visually observed with reflected light, and scratches on the rubbed portion were evaluated by the following criteria.

A: Scratches are not observed at all even through very carefully examined.

B: Weak scratches are slightly observed when very carefully examined.

C: Weak scratches are observed.

D: Medium scratches are observed.

E: Scratches are recognized at a glance.

F: Film is scratched over the entire surface.

(Evaluation 5) Coating Liquid Stability Evaluation

The coating liquid prepared in Example 1 was stored in a sealed state at 30° C. under 60% for 1 month, and thereafter, an antireflective film was prepared in the same manner as in Example 1. An oily black ink was applied to the back side of the sample. The ink-coated surface was visually observed with reflected light, and the surface state was evaluated by the following criteria.

A: Irregularity is not observed at all even through very carefully examined.

B: Weak irregularity is slightly observed when very carefully examined.

C: Weak irregularity is observed.

D: Medium irregularity is observed.

E: Irregularity is recognized at a glance.

Evaluation results are shown in Table 6 below together with the structure of the antireflective film obtained. The sample prepared in the evaluation 4 differ the samples used in the evaluations 1 to 3, but the coating liquid having the same components was used. Therefore, this evaluation result is also shown in Table 6.

TABLE 6

| | Antireflective film | | | | | | | |
|---|---|---|---|---|---|---|---|---|
| | | Coating | Coating | | | | | |
| | | liquid | liquid | Evaluation result | | | | |
| | | For hard | For low | | | Mar | | |
| | | coat | refractive | Average | Surface | resistance | | Coating |
| | Sample | layer | Index layer | reflectivity | Haze | Steel | | Liquid |
| | No. | No. | No. | (%) | (%) | wool | Eraser | stability |
| Example | 101 | HCL-1 | LL-1 | 1.90 | 6.0 | C | C | A |
| 1-1 | | | | | | | | |
| Example | 102 | HCL-2 | LL-1 | 1.89 | 9.0 | B | B | A |
| 1-2 | | | | | | | | |
| Example | 103 | HCL-3 | LL-1 | 1.88 | 16.0 | C | C | A |
| 1-3 | | | | | | | | |
| Example | 104 | HCL-1 | LL-5 | 1.91 | 6.0 | C | C | A |
| 1-4 | | | | | | | | |
| Example | 105 | HCL-4 | LL-5 | 1.33 | 7.5 | B | A | A |
| 1-5 | | | | | | | | |
| Example | 106 | HCL-2 | LL-5 | 1.32 | 9.0 | B | A | A |
| 1-6 | | | | | | | | |
| Example | 107 | HCL-5 | LL-5 | 1.32 | 13.0 | B | A | A |
| 1-7 | | | | | | | | |
| Example | 108 | HCL-6 | LL-5 | 1.31 | 16.0 | C | C | A |
| 1-8 | | | | | | | | |
| Example | 109 | HCL-2 | LL-1 | 1.90 | 9.0 | B | B | A |
| 1-9 | | | | | | | | |
| Example | 110 | HCL-2 | LL-2 | 1.89 | 9.0 | B | B | A |
| 1-10 | | | | | | | | |
| Example | 111 | HCL-2 | LL-3 | 1.88 | 9.0 | B | B | A |
| 1-11 | | | | | | | | |
| Example | 112 | HCL-2 | LL-4 | 1.91 | 9.0 | B | B | A |
| 1-12 | | | | | | | | |
| Example | 113 | HCL-2 | LL-5 | 1.31 | 9.0 | B | A | A |
| 1-13 | | | | | | | | |
| Example | 114 | HCL-2 | LL-6 | 1.88 | 9.0 | B | B | A |
| 1-14 | | | | | | | | |
| Example | 115 | HCL-2 | LL-7 | 1.89 | 9.0 | B | B | A |
| 1-15 | | | | | | | | |
| Example | 116 | HCL-2 | LL-8 | 1.90 | 9.0 | A | B | A |
| 1-16 | | | | | | | | |
| Example | 117 | HCL-2 | LL-9 | 1.90 | 9.0 | B | B | A |
| 1-17 | | | | | | | | |
| Comparative | 118 | HCL-2 | LL-10 | 1.88 | 9.0 | B | B | E |
| Example 1-1 | | | | | | | | |
| Comparative | 119 | HCL-2 | LL-11 | 1.88 | 9.0 | B | E | A |
| Example 1-2 | | | | | | | | |
| Comparative | 120 | HCL-2 | LL-12 | 1.89 | 9.0 | B | B | E |
| Example 1-3 | | | | | | | | |
| Comparative | 121 | HCL-2 | LL-13 | 1.89 | 9.0 | E | E | A |
| Example 1-4 | | | | | | | | |
| Comparative | 122 | HCL-2 | LL-14 | 1.88 | 9.0 | E | E | A |
| Example 1-5 | | | | | | | | |
| Example | 123 | HCL-2 | LL-15 | 1.88 | 9.0 | B | B | A |
| 1-18 | | | | | | | | |
| Example | 124 | HCL-2 | LL-16 | 1.30 | 9.0 | B | A | A |
| 1-19 | | | | | | | | |
| Example | 125 | HCL-2 | LL-17 | 1.90 | 9.0 | B | B | A |
| 1-20 | | | | | | | | |
| Example | 126 | HCL-2 | LL-18 | 1.91 | 9.0 | B | B | A |
| 1-21 | | | | | | | | |
| Example | 127 | HCL-2 | LL-19 | 1.91 | 9.0 | B | B | A |
| 1-22 | | | | | | | | |
| Example | 128 | HCL-2 | LL-20 | 1.88 | 9.0 | A | B | A |
| 1-23 | | | | | | | | |
| Example | 129 | HCL-2 | LL-21 | 1.88 | 9.0 | A | B | A |
| 1-24 | | | | | | | | |
| Example | 130 | HCL-2 | LL-22 | 1.32 | 9.0 | A | A | A |
| 1-25 | | | | | | | | |
| Example | 131 | HCL-2 | LL-23 | 1.89 | 9.0 | B | B | A |
| 1-26 | | | | | | | | |
| Example | 132 | HCL-2 | LL-24 | 1.89 | 9.0 | B | B | B |
| 1-27 | | | | | | | | |
| Example | 133 | HCL-2 | LL-25 | 1.89 | 9.0 | B | B | A |
| 1-28 | | | | | | | | |
| Example | 134 | HCL-2 | LL-26 | 1.88 | 9.0 | B | B | A |
| 1-29 | | | | | | | | |
| Example | 135 | HCL-2 | LL-27 | 1.89 | 9.0 | B | B | A |
| 1-30 | | | | | | | | |
| Example | 136 | HCL-2 | LL-28 | 1.90 | 9.0 | B | B | B |
| 1-31 | | | | | | | | |
| Example | 137 | HCL-2 | LL-29 | 1.90 | 9.0 | B | B | A |
| 1-32 | | | | | | | | |
| Example | 138 | HCL-2 | LL-30 | 1.88 | 9.0 | B | B | A |
| 1-33 | | | | | | | | |
| Example | 139 | HCL-2 | LL-31 | 1.89 | 9.0 | B | B | A |
| 1-34 | | | | | | | | |
| Example | 140 | HCL-2 | LL-32 | 1.33 | 9.0 | B | A | A |
| 1-35 | | | | | | | | |
| Example | 141 | HCL-2 | LL-33 | 1.89 | 9.0 | B | B | A |
| 1-36 | | | | | | | | |
| Example | 142 | HCL-2 | LL-34 | 1.89 | 9.0 | B | B | A |
| 1-37 | | | | | | | | |
| Example | 143 | HCL-2 | LL-35 | 1.90 | 9.0 | B | B | A |
| 1-38 | | | | | | | | |
| Example | 144 | HCL-2 | LL-36 | 1.88 | 9.0 | B | B | A |
| 1-39 | | | | | | | | |
| Example | 145 | HCL-2 | LL-37 | 1.90 | 9.0 | B | B | A |
| 1-40 | | | | | | | | |
| Example | 146 | HCL-2 | LL-38 | 1.32 | 9.0 | B | A | A |
| 1-41 | | | | | | | | |
| Example | 147 | HCL-2 | LL-39 | 1.91 | 9.0 | B | B | A |
| 1-42 | | | | | | | | |

As is apparent from the Examples, the antireflective film of the present invention is excellent in mar resistance and storage stability of the coating liquid.

### Examples 2-1 to 2-34 and Comparative Examples 2-1 to 2-5

(Preparation of Coating Liquid for Hard Coat Layer (HCL-7))

100 parts by mass of “DESOLITE Z7404” (zirconia fine particle-containing hard coat composition liquid, a product of JSR Corporation), 31 parts by mass of “DPHA” (UV curable resin, a product of Nippon Kayaku Co., Ltd.), 10 parts by mass of “KBM-5103” (silane coupling agent, a product of Shin-Etsu Chemical Co., Ltd.), 29 parts by mass of methyl ethyl ketone (MEK) and 13 parts by mass of methyl isobutyl ketone (MIBK) were introduced into a mixing tank and stirred to obtain a coating liquid for a hard coat layer (HCL-7).

(Preparation of Antireflective Film (201))

A triacetyl cellulose film “TD80U” (a product of Fuji Photo Film Co., Ltd.) was wound off as a support in a roll form. The above coating liquid for a hard coat layer (HCL-2) was applied to the film using a microgravure roll having a line number of 135/inch and a depth of 60 μm, and a doctor blade under the condition of a traveling speed of 10 m/min. After drying at 60° C. for 150 seconds, the coating layer was cured by irradiating with ultraviolet rays having an illuminance of 400 mW/cm² and a dose of 100 mJ/cm² using an “air-cooling metal halide lamp” (a product of Eyegraphics Co., Ltd.) of 160 W/cm under nitrogen purging. Thus, a hard coat layer was formed and wound up. The hard coat layer was prepared by adjusting the number of revolution of the gravure roll such that the thickness after curing of the hard coat layer is 4.0 μm.

The coating liquid for a lower refractive index layer (LL-1) was applied to the hard coat layer obtained above such that the lower refractive index layer has a thickness of 95 nm. Thus, an antireflective film sample (201) was prepared. Drying conditions of the lower refractive index layer were 110° C. and 10 minutes, ultraviolet curing conditions were that while purging with nitrogen so as to be an atmosphere that oxygen concentration is 0.01 vol % or less, an “air-cooling metal halide lamp” (a product of Eyegraphics Co., Ltd.) of 240 W/cm was used, and ultraviolet rays having an illuminance of 120 mW/cm² and a dose of 240 mJ/cm² were irradiated.

Antireflective films (202) to (239) were prepared in the same manner as in the preparation of the antireflective film (201), except for using each of (LL-2) to (LL-39) in place of the coating liquid for a lower refractive index layer (LLL-1).

The layer structure of each of the antireflective films (202) to (239) obtained is shown in Table 7 below.

TABLE 7

| | Antireflective film | | |
|---|---|---|---|
| | | | Coating liquid for |
| | | Coating liquid | Low refractive |
| | Sample No. | for hard coat layer No. | index layer No. |
| Example 2-1 | 201 | HCL-7 | LL-1 |
| Example 2-2 | 202 | HCL-7 | LL-2 |
| Example 2-3 | 203 | HCL-7 | LL-3 |
| Example 2-4 | 204 | HCL-7 | LL-4 |
| Example 2-5 | 205 | HCL-7 | LL-5 |
| Example 2-6 | 206 | HCL-7 | LL-6 |
| Example 2-7 | 207 | HCL-7 | LL-7 |
| Example 2-8 | 208 | HCL-7 | LL-8 |
| Example 2-9 | 209 | HCL-7 | LL-9 |
| Comparative | 210 | HCL-7 | LL-10 |
| Example 2-1 | | | |
| Comparative | 211 | HCL-7 | LL-11 |
| Example 2-2 | | | |
| Comparative | 212 | HCL-7 | LL-12 |
| Example 2-3 | | | |
| Comparative | 213 | HCL-7 | LL-13 |
| Example 2-4 | | | |
| Comparative | 214 | HCL-7 | LL-14 |
| Example 2-5 | | | |
| Example 2-10 | 215 | HCL-7 | LL-15 |
| Example 2-11 | 216 | HCL-7 | LL-16 |
| Example 2-12 | 217 | HCL-7 | LL-17 |
| Example 2-13 | 218 | HCL-7 | LL-18 |
| Example 2-14 | 219 | HCL-7 | LL-19 |
| Example 2-15 | 220 | HCL-7 | LL-20 |
| Example 2-16 | 221 | HCL-7 | LL-21 |
| Example 2-17 | 222 | HCL-7 | LL-22 |
| Example 2-18 | 223 | HCL-7 | LL-23 |
| Example 2-19 | 224 | HCL-7 | LL-24 |
| Example 2-20 | 225 | HCL-7 | LL-25 |
| Example 2-21 | 226 | HCL-7 | LL-26 |
| Example 2-22 | 227 | HCL-7 | LL-27 |
| Example 2-23 | 228 | HCL-7 | LL-28 |
| Example 2-24 | 229 | HCL-7 | LL-29 |
| Example 2-25 | 230 | HCL-7 | LL-30 |
| Example 2-26 | 231 | HCL-7 | LL-31 |
| Example 2-27 | 232 | HCL-7 | LL-32 |
| Example 2-28 | 233 | HCL-7 | LL-33 |
| Example 2-29 | 234 | HCL-7 | LL-34 |
| Example 2-30 | 235 | HCL-7 | LL-35 |
| Example 2-31 | 236 | HCL-7 | LL-36 |
| Example 2-32 | 237 | HCL-7 | LL-37 |
| Example 2-33 | 238 | HCL-7 | LL-38 |
| Example 2-34 | 239 | HCL-7 | LL-39 |

As a result of evaluation of the antireflective films (201) to (239) according to Example 1, the antireflective films of the present invention using the coating liquids for a lower refractive index layer (LL-1) to (LL-9) and (LL-15) to (LL-39) obtained the same effect as in the antireflective film of Example 1.

(Preparation of Antireflective Film-Provided Polarizing Plate)

### Example 3

Iodine was adsorbed on a stretched polyvinyl alcohol film to prepare a polarizer. The saponified antireflective film in Example 1 was adhered to one side of the polarizer using a polyvinyl alcohol adhesive such that the support (triacetyl cellulose) of the antireflective film faces the polarizer side. A view angle-expanded film (Wide View Film SA12B, a product of Fuji Photo Film Co.) having an optical compensation layer was saponified, and adhered to other side of the polarizer using a polyvinyl alcohol adhesive. Thus, a polarizing plate was prepared. As a result of evaluation in the state of the polarizing plate according to Example 1, the polarizing plate of the present invention using the antireflective film of the present invention had the same effect as in Example 1.

(Preparation of Image Display)

### Example 4

The antireflective film samples prepared in Examples 1 and 2, and the polarizing plate of Example 3 were adhered to a glass plate on the surface of an organic EL display, respectively. As a result, in each case, reflection on the glass surface was suppressed, and a display having high visibility was obtained.

### Example 5

Hard coat layer/lower refractive index layer were formed on a under coat surface of a polyethylene terephthalate film “COSMOSHINE” (a product of Teijin Corporation, refractive index: 1.65) having the under coat layer at one side thereof and having a thickness of 188 μm in the same manner as in the antireflective film (101) of Example 1, and evaluation was made in the same manner as in Example 1. Reflected light was considerably suppressed, and mar resistance was high. When the antireflective film was adhered on the outermost surface of a flat CRT and PDP, displays simultaneously satisfied with low reflection and high film hardness were obtained.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application Nos. JP2005-244065 filed August 25 of 2005, the contents of which are incorporated herein by reference.

What is claimed is:

1. An antireflective film comprising: a support; and a layer formed from a composition comprising inorganic particles and at least one salt, the at least one salt comprising an acid and an organic base, the conjugate acid of the organic base having pKa of 5.0 to 11.0.

2. The antireflective film according to claim 1, wherein the inorganic particles are silica fine particles.

3. The antireflective film according to claim 1, wherein the inorganic particles have a hollow structure and have a refractive index of 1.15 to 1.40.

4. The antireflective film according to claim 1, which has a haze value attributable to surface scattering of 5 to less than 15%.

5. The antireflective film according to claim 1, wherein at least one layer constituting the antireflective film contains an organosilane compound.

6. The antireflective film according to claim 1, wherein
the composition comprises:
a fluorine-containing polymer comprising (a) a fluorine-containing vinyl monomer polymeric unit and (b) a hydroxyl group-containing vinyl monomer polymeric unit; and
a crosslinking agent capable of reacting with a hydroxyl group, and the layer formed from the composition is a lower refractive index layer.

7. The antireflective film according to claim 6, wherein the fluorine-containing polymer further comprises (c) a polymeric unit having a graft site containing a polysiloxane repeating unit represented by formula (1) on a side chain of the fluorine-containing polymer, the main chain of the fluorine-containing polymer consisting of a carbon atom. 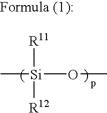
wherein R¹¹ and R¹², which are the same or different, each independently represents an alkyl group or an aryl group, and p is an integer of 2 to 500.

8. The antireflective film according to claim 6, wherein the fluorine-containing polymer further comprises (d) a polysiloxane repeating unit represented by formula (1), on the main chain of the fluorine-containing polymer. 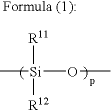
wherein R¹¹ and R¹², which are the same or different, each independently represents an alkyl group or an aryl group, and p is an integer of 2 to 500.

9. The antireflective film according to claim 6, wherein the crosslinking agent is a compound containing a nitrogen atom and at least two carbon atoms adjacent to the nitrogen atom, each of the at least two carbon atoms being substituted with an alkoxy group.

10. A polarizing plate comprising: a polarizer; and two protective films, at least one of the two protective films comprising an antireflective film according to claim 1.

11. An image display comprising an antireflective film according to claim 1 on an outermost surface of the image display.
